(19) United States
(12) Patent Application Publication
(10) Pub. No.: US 2026/0230981 A1
(43) Pub. Date: Aug. 6, 2026

(54) Cell Reselection Requirements in Non-Terrestrial Networks

(71) Applicant: Ofinno, LLC, Reston, VA (US)

(72) Inventors: Oanyong Lee, Reston, VA (US); Taehun Kim, Fairfax, VA (US); Esmael Hejazi Dinan, McLean, VA (US); Hua Zhou, Vienna, VA (US); Hyoungsuk Jeon, Centreville, VA (US); Gautham Prasad, Herndon, VA (US); Mohammad Ghadir Khoshkholgh Dashtaki, Reston, VA (US)

(73) Assignee: Ofinno, LLC, Reston, VA (US)

(21) Appl. No.: 19/630,782

(22) Filed: Mar. 27, 2026

Related U.S. Application Data
(63) Continuation of application No. PCT/US2024/048521, filed on Sep. 26, 2024.
(60) Provisional application No. 63/541,171, filed on Sep. 28, 2023.
(60) Provisional application No. 63/541,211, filed on Sep. 28, 2023.

(51) Int. Cl. H04W 36/30; H04W 36/08

(52) U.S. Cl. CPC H04W 36/304; H04W 36/08

(57) ABSTRACT

A wireless device determines whether to apply a first measurement requirement, for a measurement for one or more non-terrestrial network (NTN) cells, based on the wireless device being in a terrestrial network (TN) coverage area. The wireless device transmits an uplink packet based on one or more measurements of a first cell, wherein the one or more measurements are based on the first measurement requirement and the wireless device being in the TN coverage area.

### CROSS-REFERENCE TO RELATED APPLICATIONS

This application is a continuation of International Application No. PCT/US2024/048521, filed Sep. 26, 2024, which claims the benefit of U.S. Provisional Application No. 63/541,171, filed Sep. 28, 2023, and U.S. Provisional Application No. 63/541,211, filed Sep. 28, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17A and FIG. 17B illustrate an example of NTN architectures in which a satellite is used as part of a network as per embodiments of the present disclosure.

FIG. 18 illustrates examples of deployments of various platform types.

FIG. 19 illustrates examples of propagation delay corresponding to satellites' types of different altitudes and different elevation angle (degrees).

FIG. 20A and FIG. 20B illustrate examples of service links with maximum propagation delay of the cell/beam.

FIG. 21A and FIG. 21B illustrate examples of received signal strength when UE is in a terrestrial network and an NTN.

FIG. 22 illustrates an example of an NTN.

FIG. 23 illustrates an example embodiment of a reference location comprising an ellipsoid point.

FIG. 24 illustrates an example embodiment of a reference location comprising an ellipsoid point with an uncertainty circle.

FIG. 25 illustrates an example embodiment of a reference location comprising a sub-satellite point.

FIG. 26 illustrates an example embodiment of a reference location comprising a sub-satellite point, a relative location, and a distance threshold.

FIG. 27 illustrates an example embodiment of a reference location comprising a sub-satellite point, an antenna angle, and a relative location.

FIG. 28 illustrates an example embodiment of a description of an ephemeris data based on a satellite orbit and Keplerian elements.

FIG. 29 illustrates an example of a wireless device performing neighbor cell measurements while camping on a non-terrestrial (NTN) cell.

FIG. 30 illustrates an example of a wireless device performing an enhanced measurement for non-terrestrial network (NTN) low earth orbit (LEO).

FIG. 31 illustrates an example of a first wireless device performing normal measurements (or relaxed measurements) and a second wireless device performing enhanced measurements (or normal measurements).

FIG. 32 illustrates an example of a wireless device performing enhanced measurements of a LEO cell.

FIG. 33 illustrates an example of a wireless device performing neighbor cell measurements while entering a TN coverage area.

FIG. 34 illustrates an example embodiment of a wireless device determining whether to apply enhanced/relaxed measurement requirements based on one or more conditions and/or a second condition.

FIG. 35 illustrates an example embodiment of a wireless device determining whether to apply enhanced/relaxed measurement requirements based on whether the wireless device is in a TN coverage area.

FIG. 36 illustrates an example embodiment of a wireless device determining whether to apply enhanced/relaxed measurement requirements based on whether the wireless device is in a TN coverage area of a list of TN coverage areas.

FIG. 37 illustrates an example embodiment of a wireless device determining whether to apply enhanced/relaxed measurement requirements based on a serving cell of the wireless device.

FIG. 38 illustrates an example embodiment of a wireless device determining whether to apply an enhanced/relaxed measurement requirement, for a measurement, for one or more LEO/TN cells based on a signal strength, measured by the wireless device, of the cell.

FIG. 39 illustrates an example embodiment of a wireless device determining whether to apply enhanced/relaxed measurement requirement for a measurement based on a condition and/or a second condition.

FIG. 40 illustrates an example embodiment of a wireless device determining whether to apply an enhanced/relaxed measurement requirement, for a measurement, for one or more LEO/TN cells based on the wireless device being in a TN coverage area.

FIG. 41 illustrates an example flow chart of performing a procedure as per an aspect of an embodiment of the present disclosure.

FIG. 42 illustrates an example flow chart of performing a procedure as per an aspect of an embodiment of the present disclosure.

FIG. 43 illustrates an example flow chart of performing a procedure as per an aspect of an embodiment of the present disclosure.

FIG. 44 illustrates an example of a wireless device performing a relaxed measurement based on a first condition.

FIG. 45 illustrates an example of a wireless device performing relaxed measurements of a terrestrial network (TN) cell.

FIG. 46 illustrates an example of a wireless device performing relaxed measurements for one or more neighbor cells while entering a TN coverage area.

FIG. 47 illustrates an example embodiment of a wireless device determining whether to perform a relaxed measurements based on a second condition.

FIG. 48 illustrates an example flow chart of performing a procedure as per an aspect of an embodiment of the present disclosure.

FIG. 49 illustrates an example flow chart of performing a procedure as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

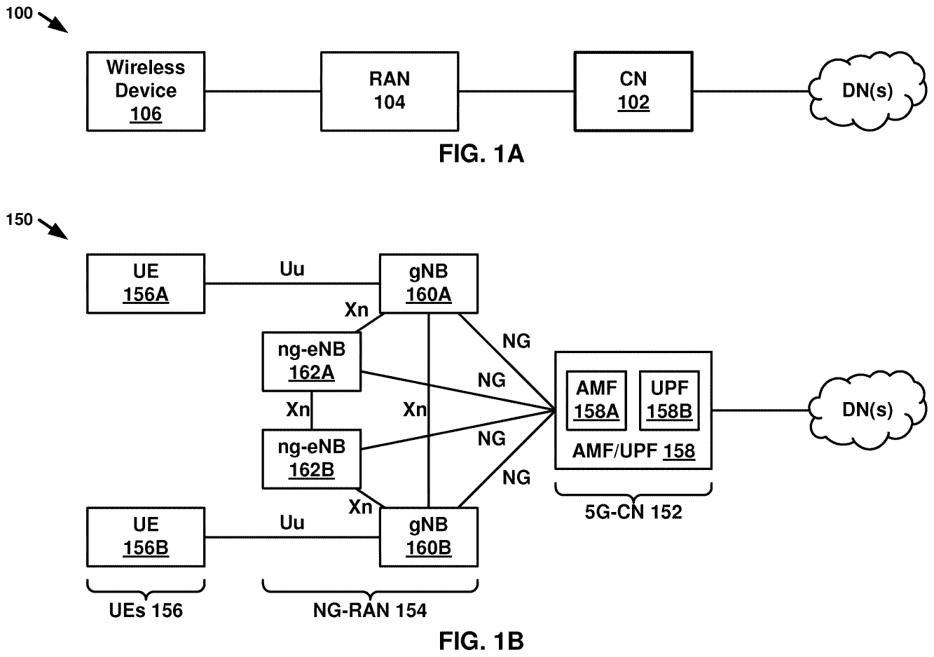

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNS, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng eNBs, illustrated as ng-eNB 162A and ng-eNB 162B (collectively ng eNBs 162). The gNBs 160 and ng eNBs 162 may be more generically referred to as base stations. The gNBs 160 and ng eNBs 162 may include one or more sets of antennas for communicating with the UEs 156 over an air interface. For example, one or more of the gNBs 160 and/or one or more of the ng eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E UTRA) user plane and control plane protocol terminations towards the UEs 156 over a Uu interface, where E UTRA refers to the 3GPP 4G radio-access technology. For example, the ng-eNB 162B may provide E UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

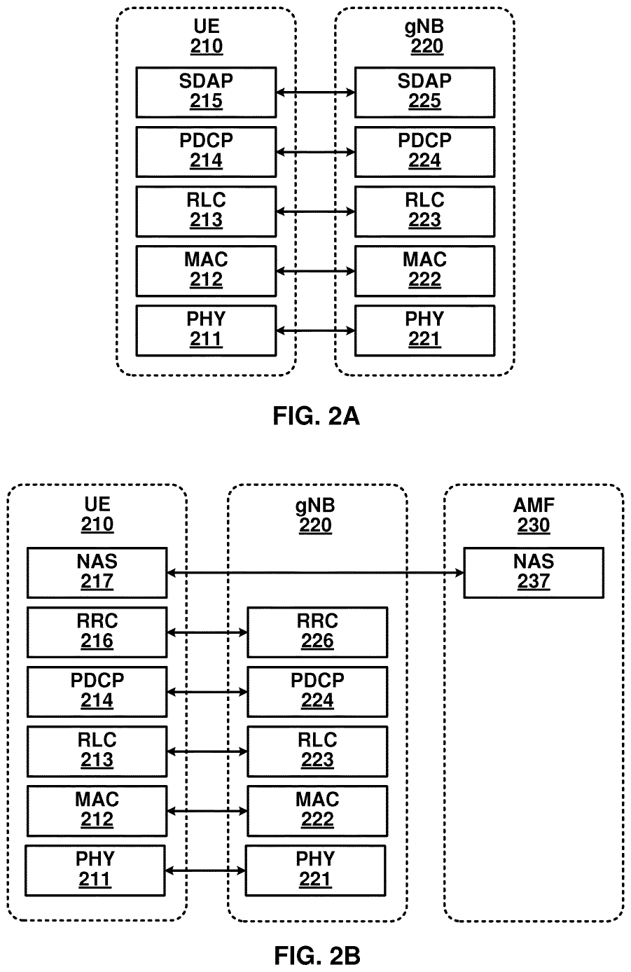

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

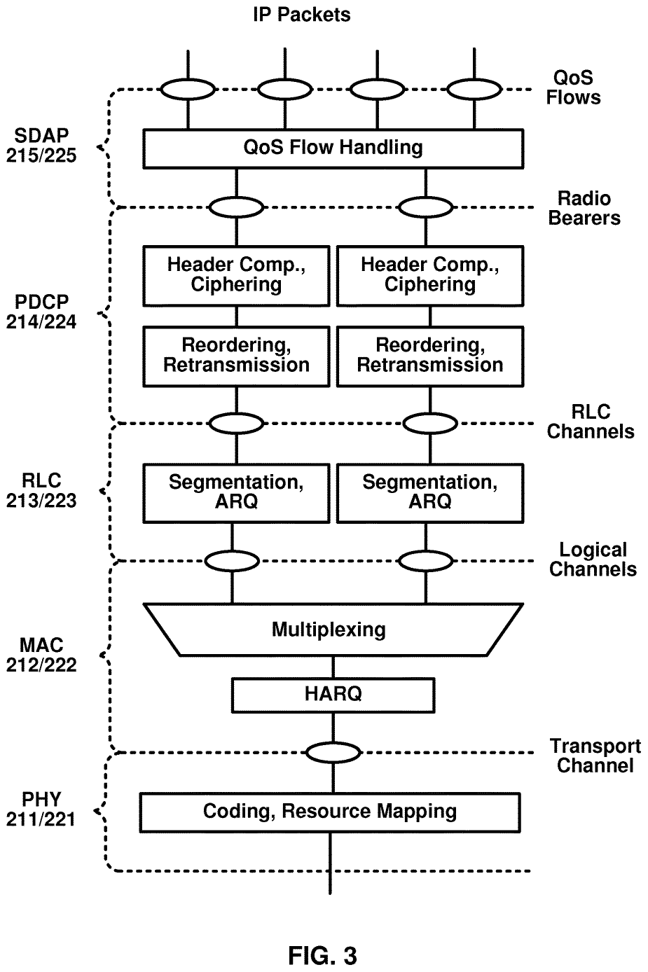

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

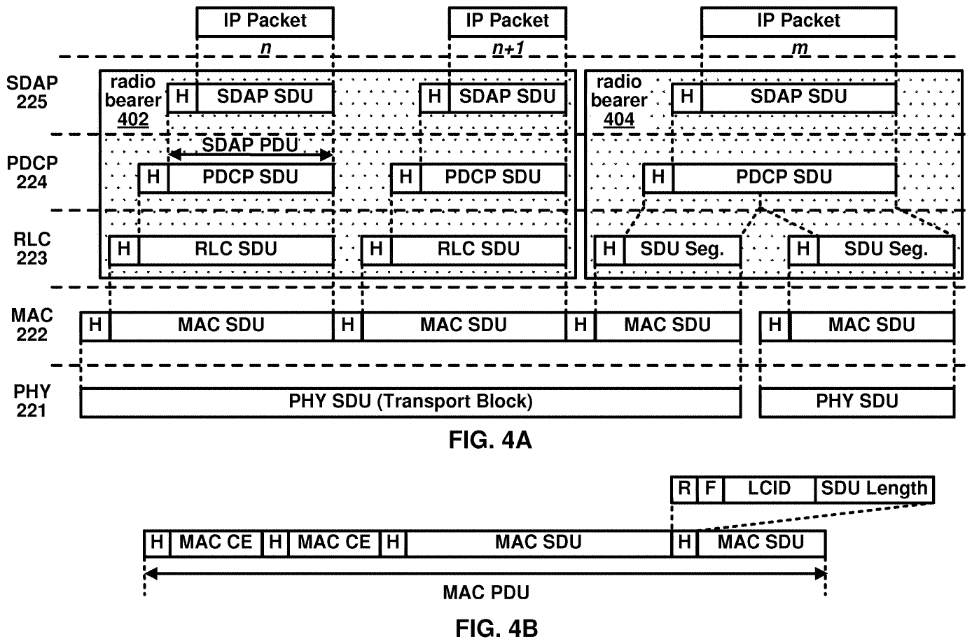

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

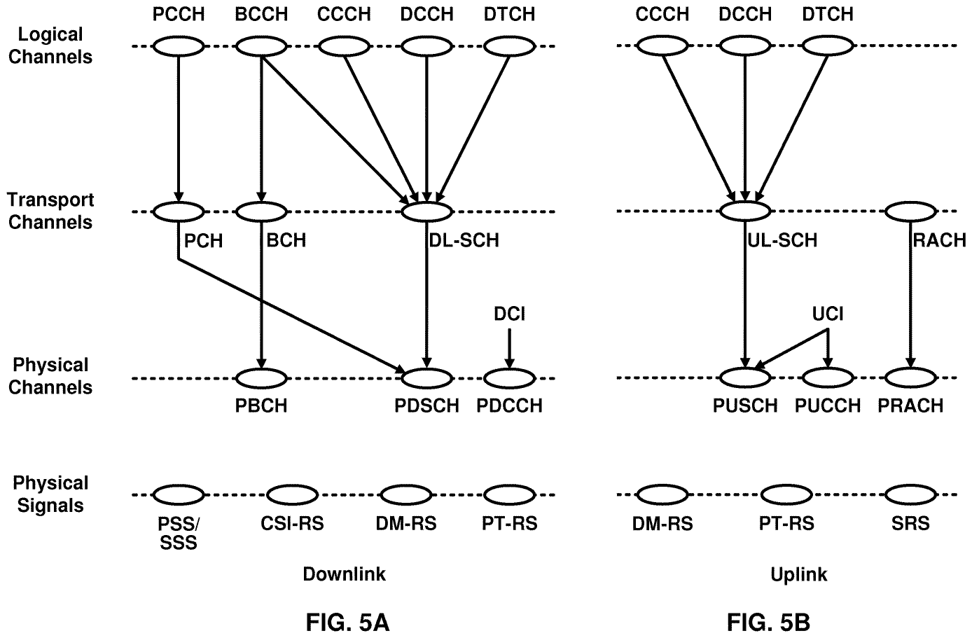

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

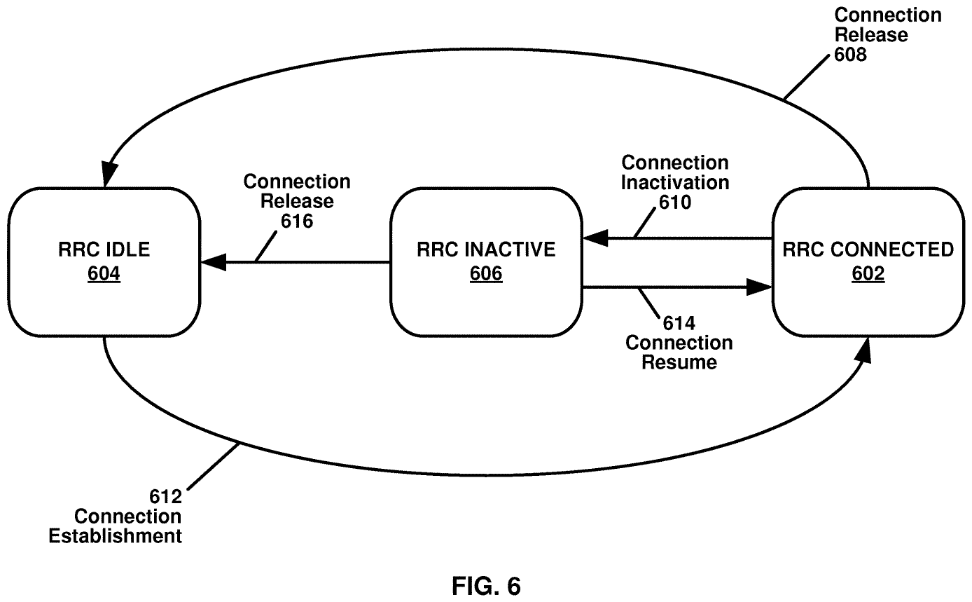

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB DU). A gNB CU may be coupled to one or more gNB DUs using an F1 interface. The gNB CU may comprise the RRC, the PDCP, and the SDAP. A gNB DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

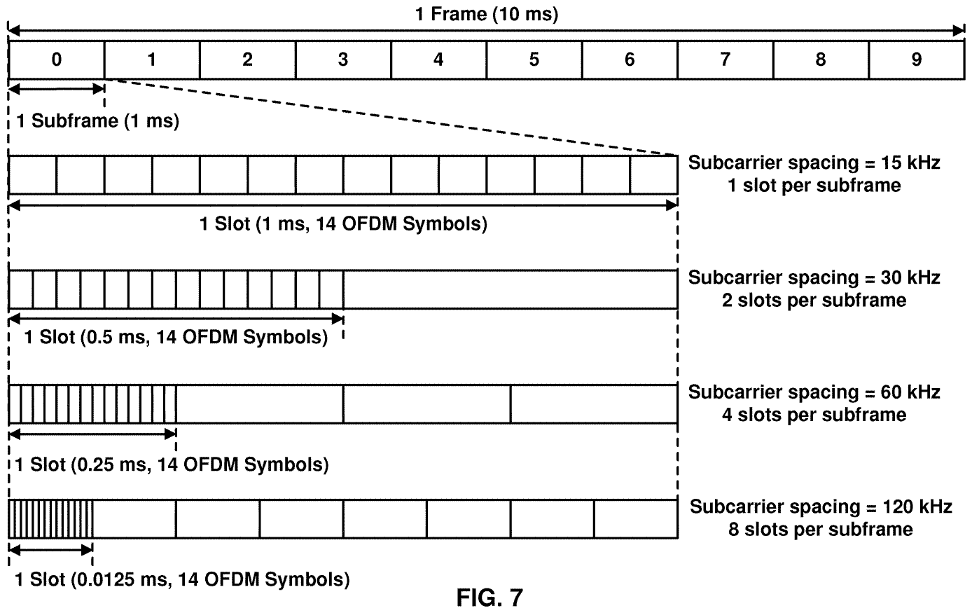

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 KHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

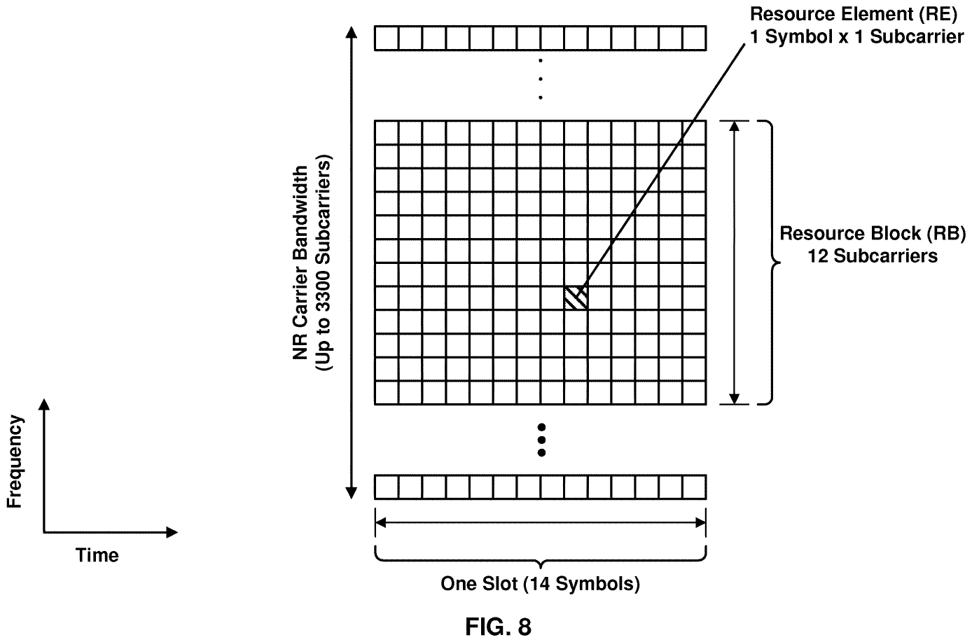

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

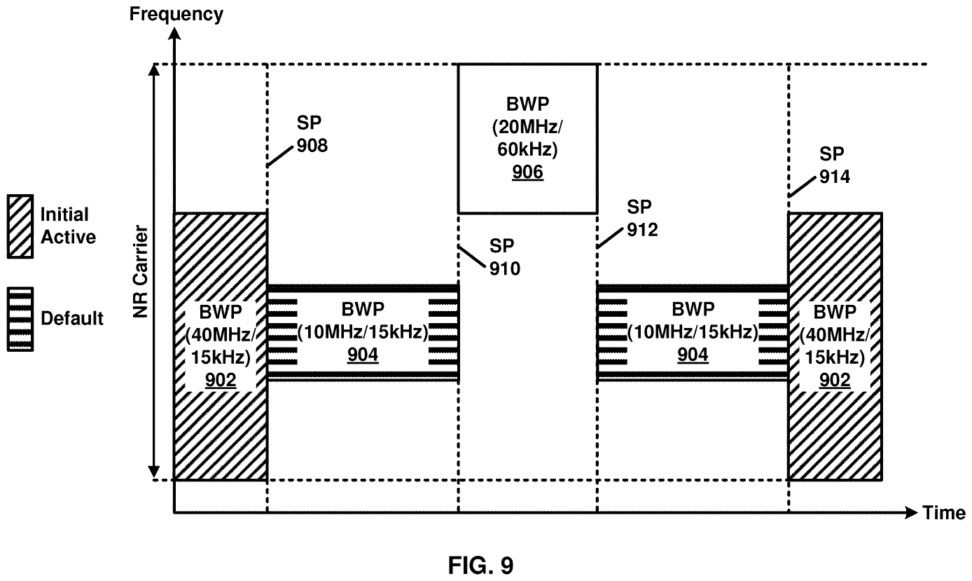

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

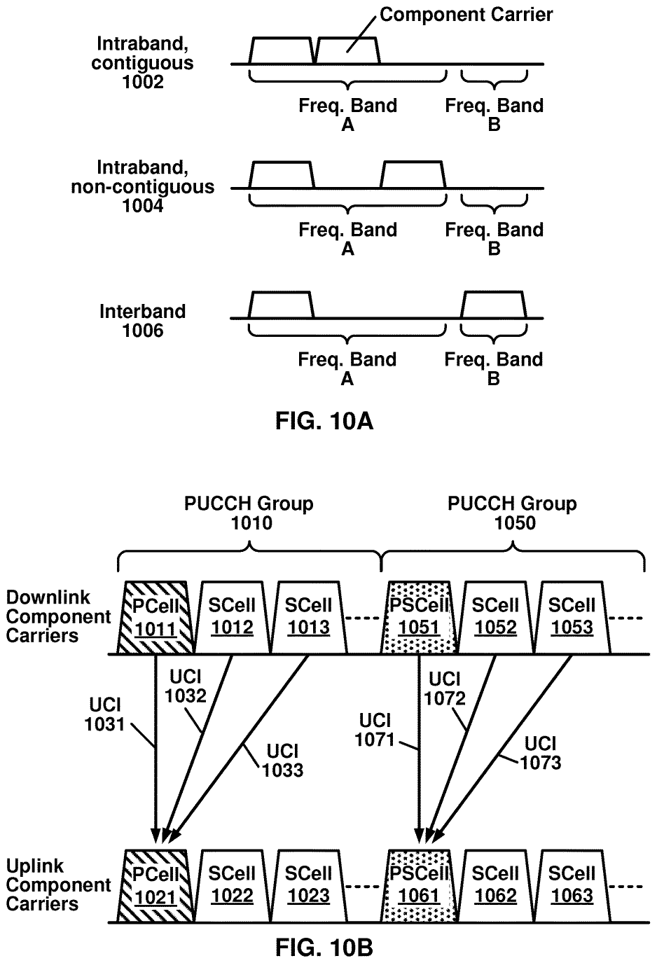

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

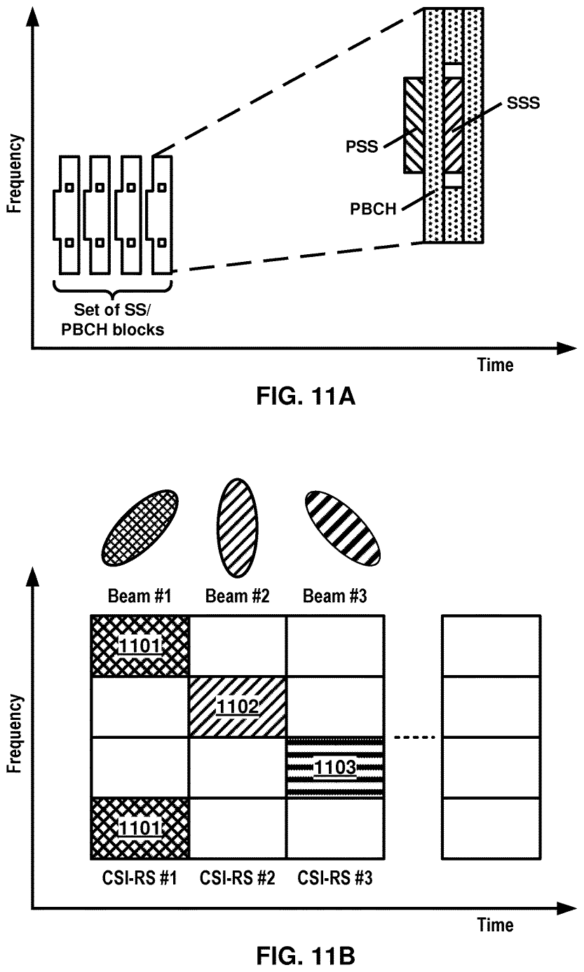

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI RS may be transmitted by the base station and used by the UE to acquire channel state information (CSI). The base station may configure the UE with one or more CSI RSs for channel estimation or any other suitable purpose. The base station may configure a UE with one or more of the same/similar CSI RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI RS resource sets. A CSI RS resource may be associated with a location in the time and frequency domains and a periodicity. The base station may selectively activate and/or deactivate a CSI RS resource. The base station may indicate to the UE that a CSI RS resource in the CSI RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI RS resource and provide a CSI report relating to the measurements. For semi-persistent CSI reporting, the base station may configure the UE to transmit periodically, and selectively activate or deactivate the periodic reporting. The base station may configure the UE with a CSI RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g., a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g., maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI RSs. One or more of the following parameters may be configured by higher layer signaling (e.g., RRC and/or MAC signaling) for a CSI-RS resource configuration: a CSI-RS resource configuration identity, a number of CSI-RS ports, a CSI RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

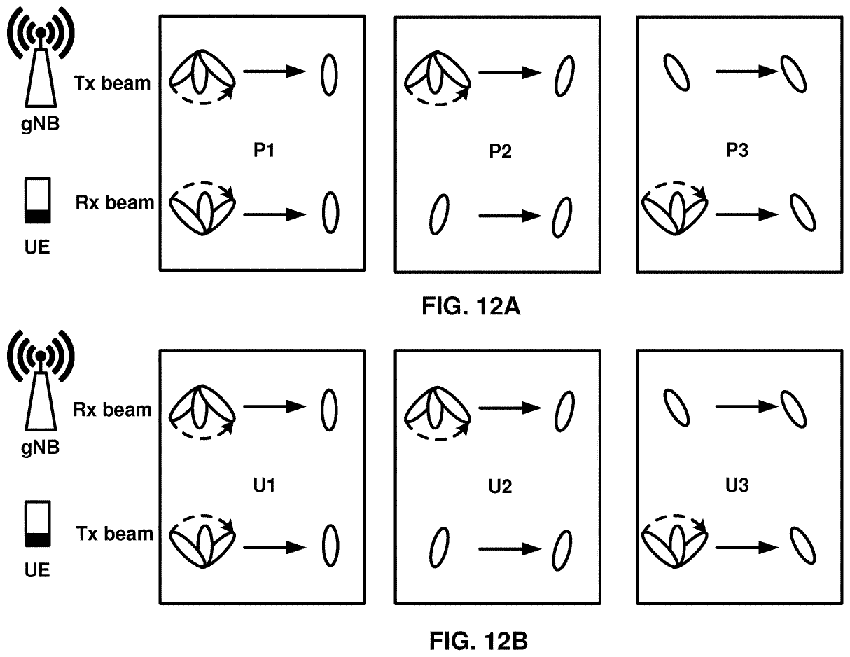

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

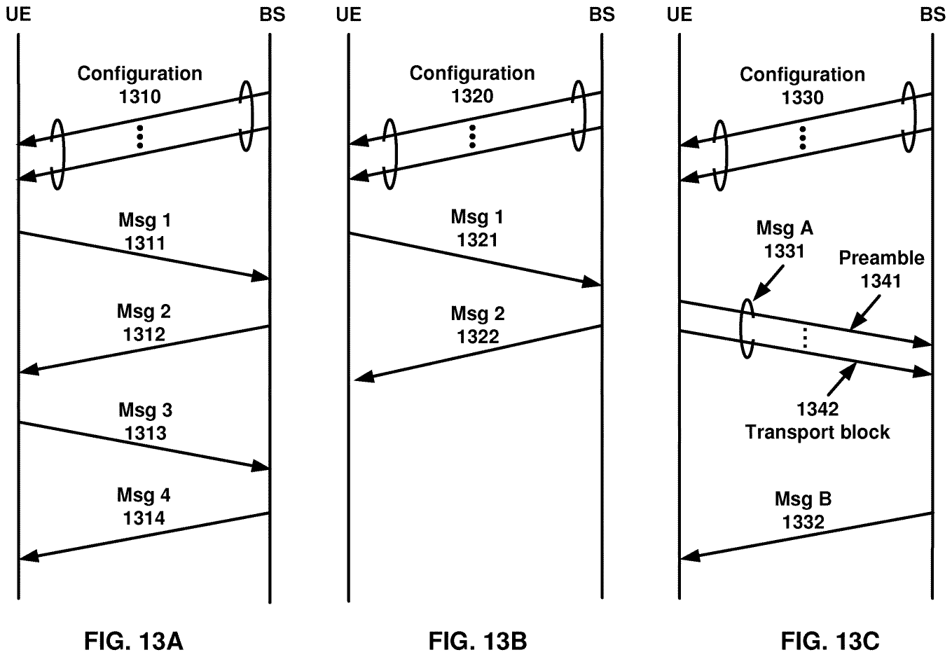

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL SCH and indicated on a PDCCH using a random access RNTI (RA RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC RNTI included in the Msg 2 1312, and/or any other suitable identifier).

The Msg 4 1314 may be received after or in response to the transmitting of the Msg 3 1313. If a C RNTI was included in the Msg 3 1313, the base station will address the UE on the PDCCH using the C RNTI. If the UE's unique C RNTI is detected on the PDCCH, the random access procedure is determined to be successfully completed. If a TC RNTI is included in the Msg 3 1313 (e.g., if the UE is in an RRC_IDLE state or not otherwise connected to the base station), Msg 4 1314 will be received using a DL-SCH associated with the TC RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

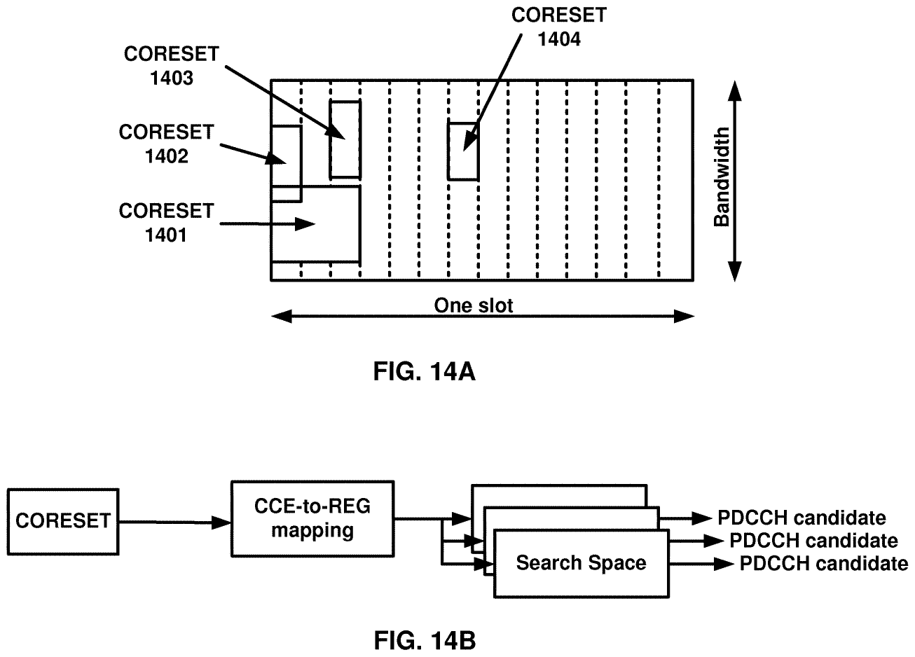

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

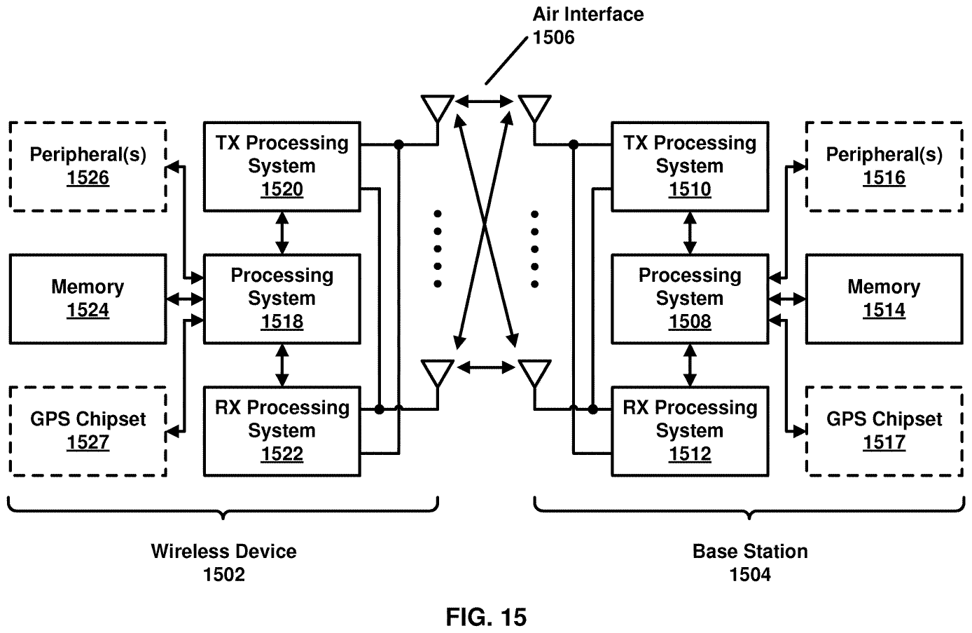

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

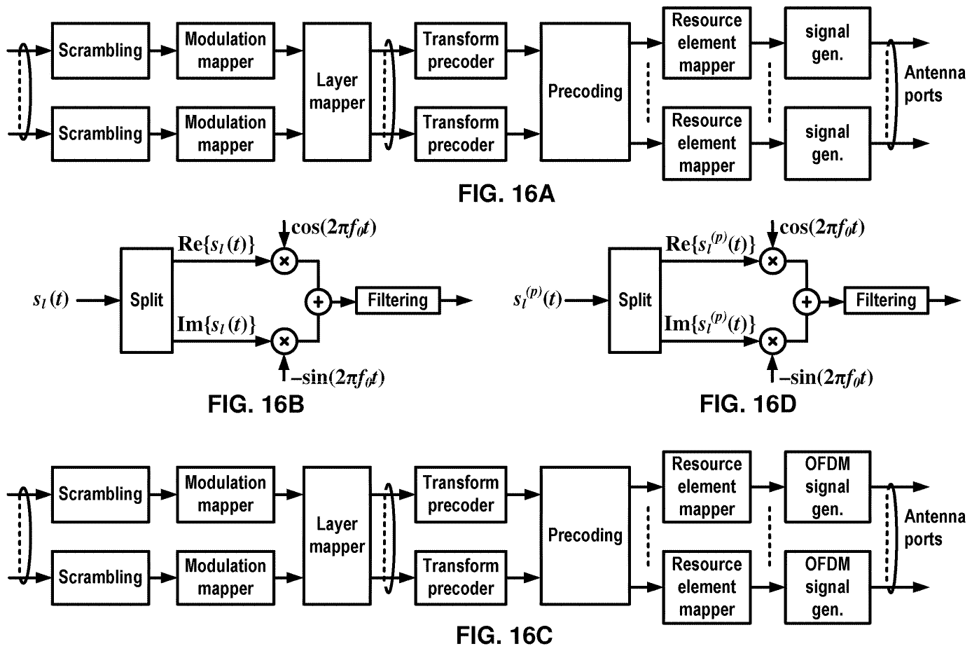

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g., RRC messages) comprising configuration parameters of a plurality of cells (e.g., primary cell, secondary cell). The wireless device may communicate with at least one base station (e.g., two or more base stations in dual connectivity) via the plurality of cells. The one or more messages (e.g., as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g., the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

A satellite may comprise a spaceborne/airborne vehicle (e.g., satellite, balloon, air ship, high altitude platform station, unmanned/uncrewed aircraft system, space-borne platform, drone, and the like). The spaceborne vehicle may, for example, provide a structure, power, commanding, telemetry, attitude control for the satellite, and possibly an appropriate thermal environment, radiation shielding. The satellite may be referred to, for example, as an NTN base station. The satellite may be referred to, for example, as a (serving) satellite. The satellite may be referred to, for example, as an NTN payload. The satellite may comprise, for example, an NTN payload. The NTN payload, for example, may be a network node embarked on board the satellite. The satellite may, for example, orbit the Earth.

The satellite may be a part of a bent-pipe/transparent payload non-terrestrial network (NTN) communication link/system. The satellite may forward a signal with amplification between a service link and a feeder link, for example, based on the satellite being part of the bent-pipe/transparent payload NTN system. The satellite may forward the signal with frequency change/conversion/shift between a service link and a feeder link, for example, based on the satellite being part of the bent-pipe/transparent payload NTN system. The satellite may operate, for example, as a repeater based on the satellite being part of the bent-pipe/transparent payload NTN system. The satellite may operate, for example, as a relay node based on the satellite being part of the bent-pipe/transparent payload NTN system. The satellite may operate, for example, as a regenerator based on the satellite being part of the bent-pipe/transparent payload NTN system. The service link may connect the satellite and the UE on earth. The feeder link may connect the satellite and an NTN gateway on earth. A terrestrial base station may comprise the NTN gateway. The terrestrial base station may be connected to a core network.

The satellite may be a part of a regenerative payload NTN communication link/system. The satellite may be equipped with on-board processing. The on-board processing may comprise demodulating and decoding a received signal. The demodulating and decoding procedures may be different for the service link and the feeder link. The on-board processing, for example, may comprise at least two demodulating and at least two decoding procedures. The at least two demodulating procedures may comprise a first demodulating procedure and a second demodulating procedure. The at least two decoding procedures may comprise a first decoding procedure and a second decoding procedure. The satellite, for example, may apply the first demodulating procedure to the signal that the satellite receives on the feeder link. The satellite may apply the second demodulating procedure for the signal that the satellite receives on the service link. The satellite, for example, may apply the first decoding procedure to the signal that the satellite receives on the feeder link. The satellite may apply the second decoding procedure for the signal that the satellite receives on the service link. The on-board processing may comprise regenerating the signal. The regenerating procedure may be different for the service link and the feeder link. The on-board processing, for example, may comprise at least two regenerating procedures. The at least two regenerating procedures may comprise a first regenerating procedure and a second regenerating procedure. The satellite, for example, may apply the first regenerating procedure to the signal that the satellite receives on the feeder link. The satellite may apply the second regenerating procedure to the signal that the satellite receives on the service link.

A UE may transmit an uplink signal to the satellite (or the NTN base station). The satellite may transmit the uplink signal to a terrestrial base station (or the NTN gateway). If the satellite transmits the uplink signal to the NTN gateway, the NTN gateway may transmit the uplink signal to a terrestrial base station. The terrestrial base station may transmit the uplink signal to the core network. The satellite may transmit the uplink signal to a different satellite, for example, over/via an inter-satellite link.

The UE may receive a downlink signal from the satellite (or the NTN base station). The satellite may receive the downlink signal from a terrestrial base station (or the NTN gateway). The satellite may receive the downlink signal from a different satellite, for example, over/via the inter-satellite link. The terrestrial base station may receive the downlink signal from the core network.

A base station/gNB/eNB in an NTN may comprise the NTN gateway. The base station/gNB/eNB in the NTN may comprise the satellite/NTN base station/NTN payload. The base station/gNB/eNB in the NTN may comprise the feeder link. The feeder link may connect the NTN gateway and the satellite. The base station/gNB/eNB in the NTN may comprise non-NTN infrastructure that perform(s) gNB/eNB functions. The non-NTN infrastructure may be referred to, for example, as a terrestrial base station/terrestrial gNB/terrestrial eNB. The base station/gNB/eNB (or a portion of the base station/gNB/eNB) in the NTN may be referred to, for example, as an NTN service link provisioning system. In an example, the NTN gateway may be referred to as a terrestrial base station/terrestrial gNB/terrestrial eNB.

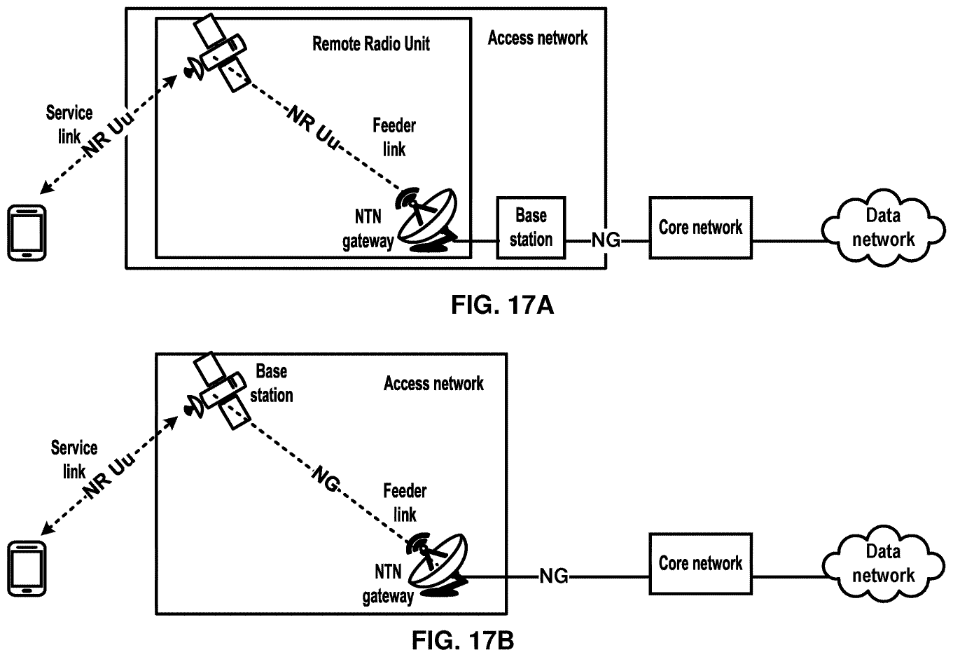

FIG. 17A and FIG. 17B illustrate an example of NTN architectures in which a satellite is used as part of a network as per embodiments of the present disclosure.

FIG. 17A illustrates an example of NTN architecture corresponding to a satellite with on-board transparent payload model as per an aspect of an embodiment of the present disclosure. The NTN architecture may comprise a UE, a satellite, an NTN gateway, a base station or gNB/eNB, a core network, and/or a data network. The satellite may behave as a remote radio unit (RRU) communicating with the NTN gateway. The satellite may implement frequency conversion and/or radio frequency (RF) amplification in the uplink direction. The satellite may implement frequency conversion and/or radio frequency amplification in the downlink direction. The NTN gateway may connect to a base station. In an example, the base station may be on the ground. A UE may transmit and receive via the satellite (e.g., as a relay or a repeater or a regenerator). The satellite (e.g., an RRU) may correspond to an analog or digital RF repeater that repeats the signal from a service link (e.g., between the satellite and the UE) to a feeder link (e.g., between the NTN gateway and the satellite), and vice versa.

FIG. 17B illustrates an example NTN architecture corresponding to a satellite with on-board regenerative payload model as per an aspect of an embodiment of the present disclosure. The NTN architecture may comprise a UE, a satellite, an NTN gateway, a core network, and/or the like. The satellite may regenerate signals received from earth (e.g., from a UE or from an NTN gateway). The satellite may regenerate the signal by decoding and re-encoding the signal. The satellite may regenerate the signal by amplifying the signal. The satellite may regenerate the signal by frequency shifting the signal. The satellite may regenerate the signal by changing the carrier frequency of the signal. In an example, the satellite may behave as a base station.

In an example, the NTN may comprise an earth fixed cell/beam. An NTN earth fixed cell/beam may be referred to, for example, as an NTN earth centric cell/beam. One or more satellites providing earth fixed cell/beam may cover the same (geographical) areas all/most of/a plurality of the time. The one or more satellites providing the earth fixed cell/beam may be one or more geostationary/geosynchronous satellite orbit (GEO/GSO) satellites. In an example, an NTN earth fixed cell/beam may be provisioned by beam(s) continuously covering the same geographical areas all the time.

In an example, the NTN may be/comprise a quasi-earth fixed cell/beam. A quasi-earth fixed cell/beam may be referred to, for example, as a quasi-earth centric cell/beam. One or more satellites in the quasi-earth fixed cell/beam may cover a (geographical) area for a fixed duration time and then cover a different (geographical) area for a next fixed duration of time. In an example, a quasi-earth fixed cell/beam may be provisioned by beam(s) covering one geographic area for a limited period of time and a different geographic area during another period of time. For example, the one or more satellites providing quasi-earth fixed cell/beam may cover a first (geographical) area at a first time. The one or more satellites in the quasi-earth fixed cell/beam may cover the first (geographical) area at a second time. The one or more satellites providing the quasi-earth fixed cell/beam may cover a second (geographical) area at a third time. The one or more satellites providing the quasi-earth fixed cell/beam may use steerable beams (and/or beam steering). The one or more satellites providing the quasi-earth fixed cell/beam may be one or more non-GSO (NGSO) or non-GEO satellites (e.g., one or more low-earth orbit (LEO) satellites, one or more medium earth orbit (MEO) satellites, and the like).

In an example, the NTN may be/comprise an earth moving cell/beam. The (geographical) area covered by one or more satellites in the earth moving cell/beam may move/slide over the Earth surface. In an example, an earth moving cell/beam may be provisioned by beam(s) whose coverage area slides over the Earth surface. For example, the one or more satellites providing the earth moving cell/beam may cover a first (geographical) area at a first time. The one or more satellites providing the earth moving (cell) system/coverage may cover a second (geographical) area at a second time. The one or more satellites providing the earth moving (cell) system/coverage may not use/generate steerable beams (or beam steering). The one or more satellites providing the earth moving (cell) system/coverage may use/generate, for example, fixed beams. The one or more satellites in the NTN earth moving (cell) system/coverage may use/generate, for example, non-steerable beams. The cell coverage covered by the one or more satellites providing the earth moving cell/beam may change with time. The one or more satellites providing the earth moving cell/beam may be one or more non-GSO (NGSO) or non-GEO (NGEO) satellites (e.g., one or more low-earth orbit (LEO) satellites, one or more medium earth orbit (MEO) satellites, and the like).

In an example, one or more satellites in an NTN may be one or more NGSO/NGEO satellites. The NTN may be/comprise, for example, an earth fixed cell/beam. The NTN may be/comprise, for example, quasi-earth fixed cell/beam. In another example, one or more satellites in an NTN may be one or more GSO/GEO satellites. The NTN may be/comprise, for example, NTN earth fixed cell/beam.

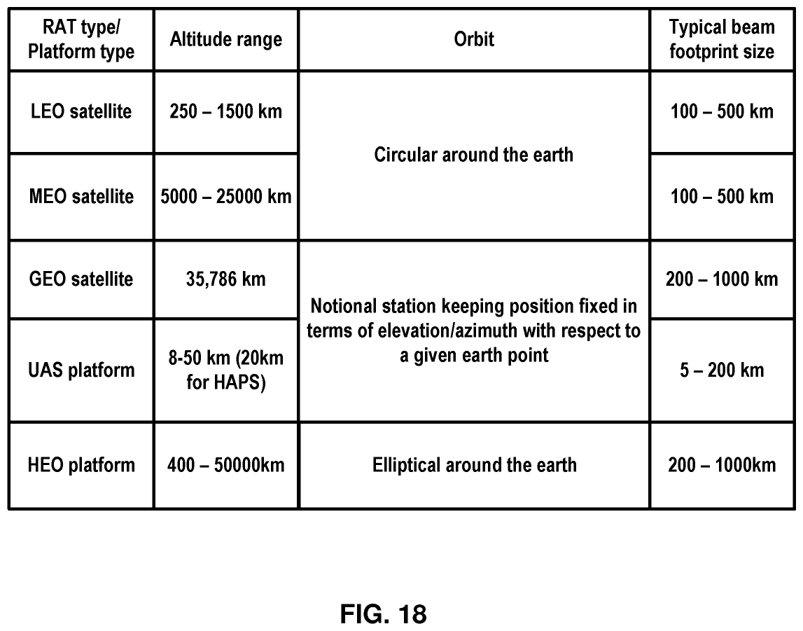

FIG. 18 illustrates examples of deployments of various platform types. The platform types may be satellite types. In an example, a satellite may be placed into a Low-Earth Orbit (LEO) at an altitude between 250 km to 1500 km, with orbital periods ranging from 90 to 130 minutes. A mean orbital velocity needed to maintain a stable LEO may be 7.8 km/s and may be reduced with increased orbital altitude. A mean orbital velocity for a circular orbit of 200 km may be 7.79 km/s. A mean orbital velocity for circular orbit 1500 km may be 7.12 km/s. From the perspective of a given point on the surface of the earth, the position of the LEO satellite may change. The LEO satellite may provide quasi-earth fixed cell/beam. The LEO satellite may provide earth moving cell/beam.

In an example, a satellite may be placed into a medium-earth orbit (MEO) at an altitude between 5000 to 20000 km, with orbital periods ranging from 2 hours to 14 hours. The MEO satellite may provide quasi-earth fixed cell/beam. The MEO satellite may provide earth moving cell/beam.

In an example, a satellite may be placed into a geostationary satellite earth orbit (GEO) at 35,786 km altitude, and directly above the equator. This may equate to an orbital velocity of 3.07 km/s and an orbital period of 1,436 minutes, which equates to almost one sidereal day (23.934461223 hours). From the perspective of a given point on the surface of the earth, the position of the GEO may not move. The GEO may provide earth-fixed cell/beam.

In an example, an NTN may be a network or network segment that uses a space-borne vehicle to embark a transmission equipment relay node or a base station. While a terrestrial network is a network located on the surface of the earth, an NTN may be a network which uses a satellite as an access network, a backhaul interface network, or both. A satellite may generate several beams over a given area.

In an example, a footprint of a beam of a satellite may be in an elliptical shape (e.g., which may be considered as a cell). The footprint of a beam may be referred to as a spotbeam. The footprint of a beam may be referred to as a beam footprint. The footprint of a beam may move over the Earth's surface with the satellite movement. The footprint of a beam may be Earth fixed with one or more beam pointing mechanisms used by the satellite to compensate for the satellite's motion. The size of a beam footprint may depend on the system design and may range from tens of kilometers to a few thousand kilometers.

The footprints of one or more beams may be a considered a cell. The footprint of one or more beams may be referred to be a beam. The beam may be associated with one or more aspects of a cell. For example, the beam may be associated with a cell-specific reference signal (CRS), for example, a beam-specific reference signal. In another example, the beam may be associated with a physical cell ID (PCI) or a physical beam ID. The terms cell and beam may be used interchangeably to refer to one or more footprints of at least one beam.

A UE may be in a range (or a coverage area) of a serving/primary cell/beam. One or more cells/beams (e.g., non-serving/neighbor/assisting/candidate cells/beams) may be installed or otherwise provided within the range (or the coverage area) of the serving cell/beam.

In an example, a propagation delay (e.g., between a satellite and the ground or between multiple satellites) may be the amount of time it takes for the head of the signal to travel from a sender to a receiver or vice versa. For uplink, the sender may be a UE and the receiver may be a base station/access network. For downlink, the sender may be a base station/access network and the receiver may be a UE. The propagation delay may vary depending on a distance between the sender and the receiver.

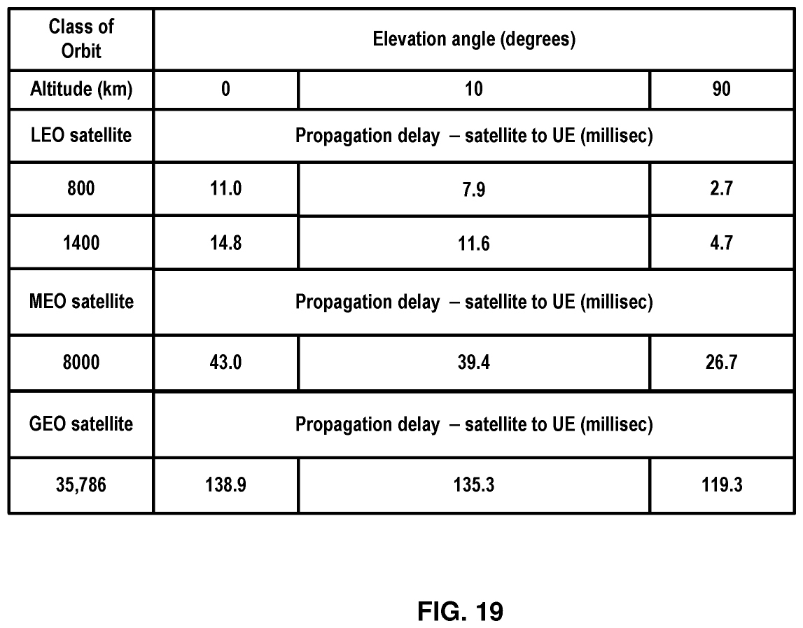

FIG. 19 illustrates examples of propagation delay corresponding to satellites' types of different altitudes and different elevation angle (degrees). The propagation delay in the figure may be one-way latency. In an example, one-way latency may be an amount of time required to propagate through a telecommunication system from a terminal (e.g., UE) to the receiver (e.g., base station, eNB, gNB, RRU of a base station).

In an example, for the transparent satellite model of GEO case, the round-trip propagation time (RTT) may comprise service link delay (e.g., between the satellite and the UE) and feeder link delay (e.g., between the NTN gateway and the satellite). The RTT may be four times of 138.9 milliseconds (approximately 556 milliseconds).

In an example, an RTT of the GEO satellite may be more than a few seconds if processing time and congestion are considered. In an example, an RTT of a terrestrial network (e.g., NR, E-UTRA, LTE) may be negligible. The RTT of a terrestrial network may be less than 1 millisecond. In an example, the RTT of a GEO satellite may be hundreds of times longer than the RTT of a terrestrial network.

In an example, a maximum RTT of a LEO satellite with transparent payload with altitude of 600 km may be 25.77 milliseconds. The differential RTT may be 3.12 milliseconds. The differential RTT within a beam of the satellite may be calculated based on the maximum diameter of the beam footprint at nadir. In an example, the differential RTT may imply the difference between communication latency that two UEs (e.g., one UE may be located close to the edge of the cell/beam and the other UE may be located close to the center of the cell/beam) may experience while communicating with an NTN node. In an example, for a LEO satellite with transparent payload with altitude of 1200 km, the maximum RTD of may be 41.77 milliseconds. The differential RTT may be 3.18 milliseconds.

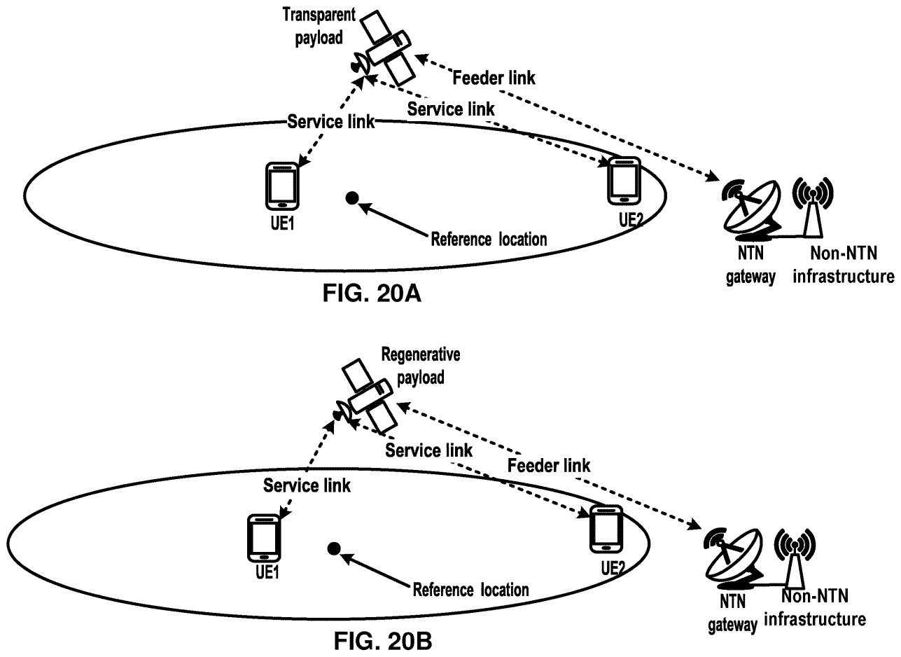

FIG. 20A and FIG. 20B illustrate examples of service links with maximum propagation delay of the cell/beam. In an example, an NTN may comprise at least one of: a transparent satellite, feeder link, ground/terrestrial gNB/eNB, a cell/beam, and service links of two wireless users.

In an example, as shown in FIG. 20A and/or FIG. 20B, a first UE (e.g., UE1) may be located closer to the cell/beam center than a second UE (e.g., UE2). In an example, the first UE (e.g., UE1) may not be at/close to the cell/beam center but may be otherwise closer to the satellite than the second UE (UE2). The UE1 may have smaller RTT compared to the UE2. For example, the RTT seen by UE1 may be 3.18 milliseconds lower than the RTT seen by UE2 for an NTN with LEO satellite with transparent payload with altitude of 1200 km.

In an example, the UE may receive information from the base station in a downlink message (e.g., SIB or RRC message) to estimate a location of the satellite. The UE may use the location of the satellite to estimate/determine/calculate/compute the propagation delay of the service link. For example, the UE may receive the satellite ephemeris via a downlink message (e.g., SIB or RRC message). For example, the UE may receive the satellite ephemeris via one or more configuration parameters from the base station. The satellite ephemeris may indicate a state vector indicating the coordinates of the satellite. The satellite ephemeris may indicate an orbital velocity of the satellite. In another example, the satellite ephemeris may comprise one or more Kepler orbit elements or orbital elements or Keplerian elements, e.g., semi-major axis, eccentricity, argument of periapsis, longitude of ascending node, inclination, and true anomaly at epoch time of the satellite. The UE may determine/calculate/compute/estimate the location of the satellite based on the satellite ephemeris. For example, the UE may determine/calculate/deduce/compute/estimate the Cartesian coordinates of the satellite at any given time instant using the satellite ephemeris.

In an example, the satellite ephemeris may be periodically broadcast by the satellite as part of system information (e.g., RRC message or SIB). The system information message/signal/command (e.g., SIB) may comprise an indication indicating the rate at which the calculation of RTT performed by the UE based on the satellite ephemeris should be updated. In an example, the UE may adjust the calculated RTT during a timer period based on the indicated rate. The timer period may indicate a duration between two consecutive receptions of the satellite ephemeris by the UE.

In an example, the satellite ephemeris may not accurately provide the location of the satellite if the periodicity during which the satellite ephemeris is broadcast is relatively long. For example, the location of the satellite determined by the UE may be inaccurate due to an expiry of the satellite ephemeris. The periodicity of the satellite ephemeris broadcast may be set such that the satellite ephemeris may be updated before expiry. The periodicity of the satellite ephemeris broadcast may, for example, depend on altitude of the satellite. For example, the periodicity of the satellite ephemeris broadcast may be larger for a GEO satellite than the periodicity of the satellite ephemeris broadcast for a LEO satellite. The periodicity of the satellite ephemeris broadcast may further depend on velocity of the satellite. For example, a UE on earth may have visibility of at least two satellites. The at least two satellites may be a first satellite and a second satellite. The first satellite may move at/with a first velocity. The second satellite may move at/with a second velocity. The first velocity may be greater/higher than the second velocity. The periodicity of the satellite ephemeris broadcast may be smaller for the first satellite than the periodicity of the satellite ephemeris for the second satellite. The satellite ephemeris broadcast may increase signaling overhead. The satellite ephemeris broadcast may increase the communication latency in an NTN.

In an example, the satellite ephemeris may not accurately provide the location of the satellite when required. For example, the location of the satellite determined by the UE may be accurate at the time the UE receives the satellite ephemeris but may be inaccurate by the time the UE uses the determined satellite location, for example, for random-access preamble transmission (e.g., MSG1), or random-access MSG3 transmission, or MSG5 transmission.

In an example, the satellite ephemeris may not accurately provide the location of the satellite if the movement of the satellite gradually drifts from the predicted orbital movement at the UE using the satellite ephemeris.

In an example, the satellite ephemeris data may provide the UE with a correction margin to help the UE compensate for the inaccuracy of the satellite ephemeris data. In an example, the UE may use the correction margin of the satellite ephemeris data to partially account for the drift of the satellite from the orbit of the satellite.

In an example, a reference location of a cell may be broadcast as a part of RRC message (e.g., RRCReconfiguration message, SIB). The reference location may describe a coordination in a geographic shape. The geographic shape may be ellipsoid point. The ellipsoid point may be a point on the surface of the ellipsoid. The ellipsoid point may comprise at least one of degrees of longitude, degrees of latitude, and sign of latitude (e.g., north or south).

In an example, the reference location of a cell may be provided via quasi-earth fixed cell. The UE may calculate the distance between the UE and the reference location of a cell. The location of the UE may be based on GNSS positioning information.

In an example, a reference location of a serving cell may be used for measurement rule in RRC_IDLE/INACTIVE state. The UE in RRC_IDLE/INACTIVE state may calculate the distance between the UE and the reference location of the serving cell. For example, the UE may choose not to perform intra-frequency measurements if the distance between UE and the serving cell reference location is shorter than a threshold. In another example, the UE may choose not to perform inter-frequency measurements if the distance between UE and the serving cell reference location is shorter than a threshold.

In an example, a reference location of a serving cell and a reference location of a CHO candidate target cell may be used for CHO execution condition(s). The UE state may calculate the distance between the UE and reference location of the serving cell. The UE may calculate the distance between the UE and reference location of the CHO candidate target cell. For example, the UE may perform CHO to the CHO candidate target cell if the distance between UE and a reference location of the serving cell becomes larger than a first threshold and the distance between UE and a reference location of the CHO candidate cell becomes shorter than a second threshold. The reference location of the serving cell, reference location of the CHO candidate target cell, the first threshold, and the second threshold may be provided in an RRC message (e.g., RRCReconfiguration message, SIB).

In an example, a Timing Advance (e.g., in NTN 5G NR) may be based on the orthogonal frequency-division multiple access (OFDMA) as the multi-access scheme in the uplink. The transmissions from different wireless devices in a cell/beam may need to be time-aligned at the gNB/eNB and/or the satellite to maintain uplink orthogonality. Time alignment may be achieved by using different timing advance (TA) values at different UEs to compensate for their different propagation delays or RTT. In an example, the transmissions from different UEs in a cell/beam may need to be time-aligned at the gNB/eNB. The TA value may comprise, or be a sum of, the service link delay and the feeder link delay. In another example, the transmissions from different UEs in a cell/beam may need to be time-aligned at the satellite. The TA value may comprise the service link delay. In another example, the transmissions from different UEs in a cell/beam may need to be time-aligned at a non-terrestrial point on the feeder link. The TA value may comprise the service link delay and a non-zero fraction of the feeder link delay. In another example, the transmissions from different UE in a cell/beam may need to be time-aligned at a non-terrestrial point on the service link. The TA value may comprise a non-zero fraction of the service link delay.

In NTNs, the size of the cells/beams may be larger than the size of cells in terrestrial networks. For example, the maximum footprint of GEO NTN cell/beam may be 3500 kilometers and the maximum footprint of LEO NTN cell/beam may be 1000 kilometers. The size of cell of the terrestrial network may be less than a kilometer to a few kilometers. Different UEs in an NTN may experience different propagation delays between the satellite and the UE due to the large footprint of the beam/cell. Different UEs in the NTN may experience different propagation delays between the NTN gateway and the UE due to the large footprint of the beam/cell. Different UEs in the NTN may experience different propagation delays between the gNB/eNB and the UE due to the large footprint of the cell/beam.

A differential delay between two UEs may indicate the difference between the one way propagation delay of the service link for the two UEs. A maximum differential delay may indicate the difference between the maximum one way delay (i.e., one way propagation delay experienced by a UE that is located at a point farthest away from the satellite) and the minimum one way delay (i.e., one way propagation delay experienced by a UE that is located at a point that is closest to the satellite) of/in the service link. For example, a UE that is at/close to the cell/beam center may be at a point that is closest to the satellite. A UE that is at/close to the cell/beam edge/boundary may be at a point that is farthest away from the satellite. The maximum differential delay for a LEO satellite based NTN may be 3.18 milliseconds. The maximum differential delay for a GEO satellite based NTN may be 10.3 milliseconds. The maximum differential delay in a terrestrial network may be less than one millisecond. The base station may receive random-access preambles transmitted by different NTN UEs at/in/on the same RACH occasion at different times based on the differential delay between the UEs.

In an example, the base station may use an expanded preamble reception window when operating in an NTN to receive random-access preambles transmitted in/on/at the same RACH occasion. For example, the base station may use a preamble reception window that starts from [RACH occasion timing+2*minimum one way propagation delay] and ends at [RACH occasion+2*maximum one way propagation delay]. Using an expanded preamble reception window may increase the time gap between two consecutive supported RACH occasions. For example, the time gap between two consecutive supported RACH occasions may be greater than 2*(maximum differential delay). A limited number of PRACH configurations (e.g., 3 for GEO satellite based NTNs) may support or allow the time gap between two consecutive supported RACH occasions to be greater than 2*(maximum differential delay). Based on the network traffic type, the limited number of PRACH configurations may support a small number of UEs in a given area, i.e., the limited number of PRACH configurations may support a small UE density. For example, the supported UE density may be 51 UEs per square kilometer when each UE accesses the RACH once every 10 minutes for an NTN served by a LEO satellite with a cell/beam coverage area of 26000 square kilometers. In an example, the UEs may pre-compensate random-access preamble transmission based on a TA value to compensate for the long RTT to allow for a smaller preamble reception window at the base station (e.g., 1 ms). This may allow for a larger number of UE density (e.g., 60,000 UEs per square kilometer). In an example, the random-access procedure may be a four-step random access procedure. In an example, the random-access procedure may be a two-step random access procedure.

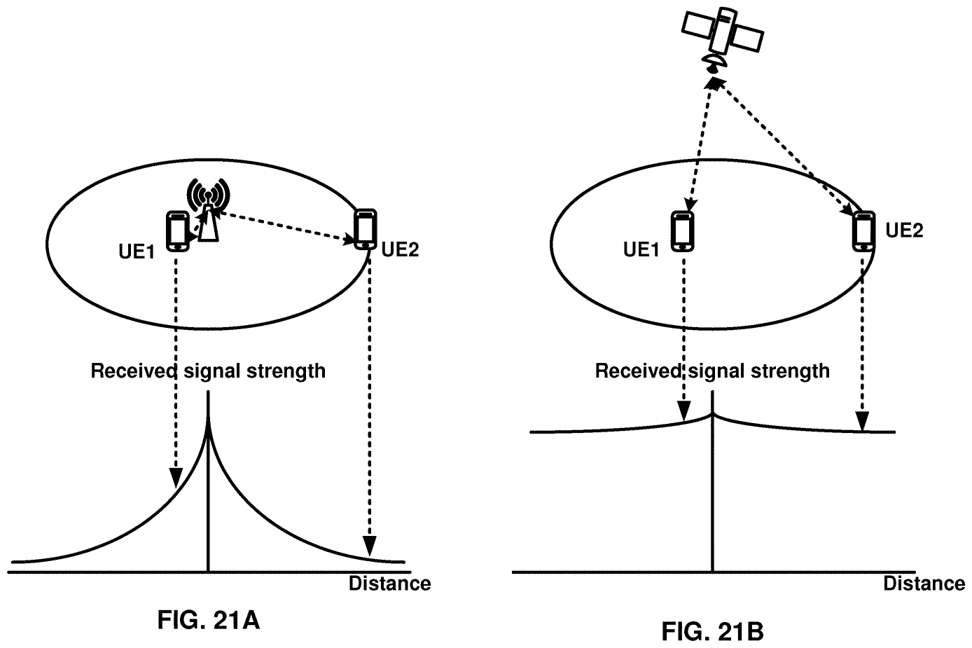

FIG. 21A and FIG. 21A illustrate examples of received signal strength when UE is in a terrestrial network and an NTN.

FIG. 21A illustrates an example in which UE1 is located near cell center and UE2 is located at cell edge in a terrestrial network. The received signal strength (e.g., RSRP) decreases when a UE moves from cell center to cell edge. The difference of received signal strength between the UE1 and UE2 may be measurable.

FIG. 21B illustrates an example in which UE1 is located near cell center and UE2 is located at cell edge in NTN. The difference of received signal strength between the UE1 and UE2 may be smaller than the case in terrestrial network, as illustrated in FIG. 21A. In NTN, the high received signal strength may not mean that the UE is at cell center. For example, UE at cell edge may have high received signal strength.

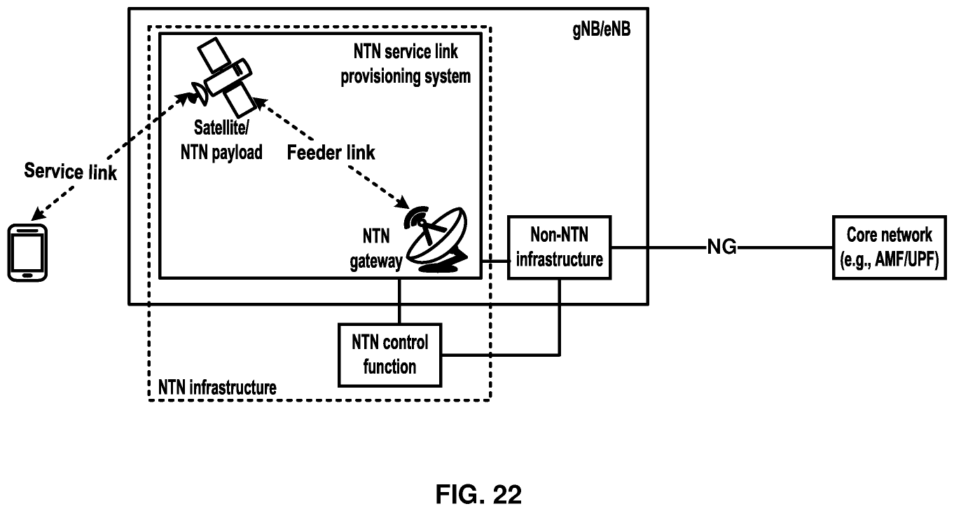

FIG. 22 illustrates an example of an NTN. The gNB depicted in FIG. 22 may be subdivided into non-NTN infrastructure gNB functions and an NTN Service Link provisioning System. The NTN infrastructure shown in FIG. 22 may be (thought of being) subdivided into an NTN Service Link provisioning System and an NTN Control function. The NTN Service Link provisioning System may comprise one or more NTN payloads and NTN Gateways. The NTN payload may be embarked on a spaceborne (or airborne) vehicle. The NTN payload may provide a structure, power, commanding, telemetry, and/or attitude control for the satellite. The NTN payload may provide an appropriate thermal environment and/or radiation shielding. The NTN Service Link provisioning System may map the NR-Uu radio protocol over radio resources of the NTN infrastructure (e.g., beams, channels, Tx power, and the like). The NTN control function may control the spaceborne (or airborne) vehicle(s). The NTN control function may control one or more radio resources of the NTN infrastructure (e.g., NTN payload(s) and NTN Gateway(s). The NTN control function may provide control data, e.g., satellite ephemeris, to the non-NTN infrastructure gNB functions of the gNB.

The NTN may provide non-terrestrial access to the UE by means of an NTN payload and an NTN Gateway, depicting a service link between the NTN payload and the UE, and a feeder link between the NTN Gateway and the NTN payload. The NTN payload may (also) be referred to as a satellite.

The NTN payload may transparently forward a radio protocol received from the UE (e.g., via the service link) to the NTN Gateway (e.g., via the feeder link) and vice-versa. The following connectivity may be supported by the NTN payload:
A gNB may serve multiple (e.g., more than one, plurality, and the like) NTN payloads;
An NTN payload may be served by multiple (e.g., more than one, plurality, and the like) gNBs.

The NTN payload may change a carrier frequency, before re-transmitting it on the service link, and vice versa (e.g., respectively on the feeder link).

For NTN, the following may apply in addition to Network Identities:
a Tracking Area may correspond to a fixed geographical area. Any respective mapping may be configured in a radio access network (RAN);
a mapped cell identity (ID).

Non-Geosynchronous orbit (NGSO) may include Low Earth Orbit at altitude approximately between 300 km and 1500 km. NGSO may include Medium Earth Orbit at altitude approximately between 7000 km and 25000 km.

At least three types of service links may be supported:
Earth-fixed (system/service link/cell/cell system): provisioned by beam(s) continuously covering the same geographical areas a plurality of (e.g., all) the time (e.g., the case of GSO satellites);
Quasi-Earth-fixed (system/service link/cell/cell system): provisioned by beam(s) covering one geographic area for a limited period and a different geographic area during another period (e.g., a case of NGSO satellites generating steerable beams);
Earth-moving (system/service link/cell/cell system): provisioned by beam(s) whose coverage area slides over the Earth surface (e.g., a case of NGSO satellites generating fixed or non-steerable beams).

With NGSO satellites, the gNB may provide either quasi-Earth-fixed cell coverage or Earth-moving cell coverage. The gNB operating with GSO satellite may provide Earth fixed cell coverage.

The UE supporting NTN may be GNSS-capable.

In case of NGSO NTN, a service link switch may refer to a change of serving satellite.

In an NTN, the UE may be configured to report a timing advance (TA) of the UE. The UE may be configured to report the TA, for example, during random-access procedure in RRC_IDLE and/or RRC_INACTIVE state. The UE may be configured to report the TA, for example, during random-access procedure in RRC_CONNECTED state (e.g., using event-triggered reporting; for RRC re-establishment procedure, if an indication is broadcasted by the target cell's SI; for handover, the UE may trigger TA report if the target cell indicates the TA report in a handover command).

To accommodate the long propagation delay, user plane procedures may be adapted. For example, for downlink, HARQ feedback may be enabled or disabled per HARQ process. For example, for uplink, the UE may be configured with a HARQ mode A or HARQ mode B per HARQ process. For example, a maximum number of HARQ processes may be extended to 32. For example, value ranges of MAC (e.g., sr-ProhibitTimer and configuredGrantTimer), RLC (e.g., t-Reassembly) and PDCP (e.g., discardTimer and t-reordering) layer timers may be extended.

For example, the gNB may ensure proper configuration of HARQ feedback (e.g., enabled or disabled) for HARQ processes used by a semi persistent scheduling (SPS) configuration and of HARQ mode for HARQ processes used by a configured grant (CG) configuration.

If a logical channel is configured with allowedHARQ-mode, the logical channel may (only) be mapped to a HARQ process with a same HARQ mode.

To accommodate the long propagation delays, several NR timings involving DL-UL timing interaction may be enhanced by the support of two scheduling offsets: K_offset and k_mac.

Timing relationships modified for NTN using K_offset may be transmission timing of DCI scheduled PUSCH including CSI transmission on PUSCH, transmission timing of random-access response (RAR) grant or fallbackRAR grant scheduled PUSCH, timing of the first PUSCH transmission opportunity in type-2 configured grant, transmission timing of HARQ-ACK on physical uplink control channel (PUCCH) including HARQ-ACK on PUCCH to message B (MsgB) in 2-step random access, transmission timing of PDCCH ordered physical random access channel (PRACH), timing of the adjustment of uplink transmission timing upon reception of a corresponding timing advance command, transmission timing of aperiodic sounding reference signal (SRS), and/or CSI reference resource timing.

k_mac may be a scheduling offset supported in NTN for MAC CE timing relationships enhancement. The k_mac may be provided by the network (e.g., via SIB, RRC configuration, and the like) in response to downlink and uplink frame timing not being aligned at the gNB. The k_mac may be needed for UE action and assumption on downlink configuration indicated by a MAC-CE command in PDSCH. The K_mac may be used in beam failure recovery, where after a PRACH transmission in uplink slot n the UE monitors the corresponding PDCCH starting from downlink slot “n+k_mac+4” within a corresponding RAR window.

In response to a UE being provided with a k_mac, when the UE transmits a PUCCH with HARQ-ACK information in uplink slot n corresponding to a PDSCH carrying a MAC CE command on a downlink configuration, the UE action and assumption on the downlink configuration may be applied starting from the first slot that is after slot n+[3N]_slot\hat{ }(subframe,μ)+k_mac, where μ is the SCS configuration for the PUCCH.

To accommodate long propagation delays experienced in NTN on both service link and feeder link, the UE may (be able to) perform time pre-compensation for (all) uplink transmissions (e.g., PRACH preamble transmissions, uplink transmissions during the RRC_CONNECTED state, and the like). To perform the pre-compensation, the UE may be assisted by GNSS (e.g., in/within the UE). To perform the pre-compensation, the UE may be assisted by the network (e.g., gNB). The gNB may periodically broadcast NTN assistance information. The NTN assistance information may comprise serving satellite ephemeris. The NTN assistance information may comprise higher layer Common-TA-related parameters. The higher layer Common-TA-related parameters may be used to calculate the common round-trip delay (RTD) e.g., delay on the feeder link.

The following formula for TA calculation may be applied by the UE for PRACH preamble transmission and in RRC_CONNECTED state: T_“TA”=(N_“TA”+N_“TA,offset”+N_“TA,adj”\hat{ }“common”+N_“TA,adj”\hat{ }“UE”)×T_“c” where N_“TA” may be a timing advance (or a timing advance value) between downlink and uplink, and N_“TA, offset” may be a fixed offset used to calculate the timing advance. For example, for msgA transmission on PUSCH, N_“TA”=0 may be used by the UE. N_“TA, adj” \hat{ }“common” may be network-controlled common TA. N_“TA, adj” \hat{ }“common” may include any timing offset considered necessary by the network (e.g., feeder link delay/delay of the feeder link). N_“TA, adj” \hat{ }“common” may be derived from higher-layer parameters (e.g., TACommon, TACommonDrift, and TACommonDriftVariation) if configured, otherwise N_“TA,adj” \hat{ }“common”=0. N_“TA, adj” \hat{ }“UE” may be self-estimated TA by the UE to pre-compensate for delay of the service link (e.g., service link delay). N_“TA, adj” \hat{ }“UE” may be computed by the UE based on a position of the UE and serving satellite-ephemeris-related higher-layers parameters if configured, otherwise N_“TA, adj”\hat{ }“UE”=0. T_c may be a NR basic time unit.

The UE may (be capable to) use an acquired GNSS position (of the UE) and serving satellite ephemeris information (when provided by the network) to calculate frequency pre-compensation to counter shift instantaneous Doppler shift experienced on the service link. The pre-compensation of the instantaneous Doppler shift experienced on the service link may be performed by the UE. Management of Doppler shift experienced over the feeder link as well as any transponder frequency error whether it is introduced in Downlink or Uplink may be network implementation.

The network (e.g., gNB) may broadcast multiple Tracking Area Codes per PLMN in an NTN cell. A tracking area code change in the System Information may be under network control, e.g., it may not be exactly synchronized with real-time illumination of beams on ground. The UE may determine a network type (e.g., terrestrial or non-terrestrial) implicitly by the existence of scheduling information of SIB19 in SIB1. Non-NTN capable UEs may be prevented from accessing an NTN cell.

The satellite ephemeris (or NTN ephemeris) may be divided into serving cell's satellite ephemeris and neighboring cell's satellite ephemeris.

At least in the quasi-earth fixed cell scenario, the UE may perform time-based and location-based cell selection/reselection. Timing information and location information associated to a (NTN) cell may be provided via system information (e.g., SIB, NTN-specific SIB, and the like). The timing information may refer to a time when a serving cell may stop serving a geographical area. The location information may refer to a reference location of the serving cell or neighboring cells. The location information may be used to assist cell reselection in NTN with, for example, a condition based on the distance between the UE and the reference location of the serving cell and/or neighbor cells. The UE may support mobility between radio access technologies based on different orbit (GSO, NGSO at different altitude, and the like).

A feeder link switch over may be a procedure where the feeder link is changed from a source NTN Gateway to a target NTN Gateway for a specific NTN payload. The feeder link switch over may be a Transport Network Layer procedure. Both hard and soft feeder link switch over may be applicable to NTN.

A feeder link switchover may result in transferring an established connection for affected UE between two gNBs. For soft feeder link switchover, an NTN payload may be able to connect to more than one NTN Gateway during a given period, e.g., a temporary overlap may be ensured during a transition between the feeder links. For hard feeder link switchover, an NTN payload may only connect to one NTN Gateway at any given time, e.g., a radio link interruption may occur during a transition between the feeder links.

An NTN Control function may determine a point in time when a feeder link switch over between two gNBs is performed. A transfer of the affected UEs' context between the two gNBs at feeder link switch over may be performed by means of either NG based or Xn based handover. The transfer may depend on the gNBs' implementation and configuration information provided to the gNBs by the NTN Control function.

During mobility between NTN and Terrestrial Network, a UE may not be required to connect to both NTN and Terrestrial Network at the same time. The mobility between NTN and Terrestrial Network may be referred to as NTN-Terrestrial Network hand-over. NTN-Terrestrial Network hand-over may refer to mobility in both directions, e.g., from NTN to Terrestrial Network (hand-in) and from Terrestrial Network to NTN (hand-out).

A UE may receive a conditional handover (CHO) configuration. The CHO configuration may be a conditional reconfiguration. The CHO configuration may include one or more CHO candidate cells. Each CHO candidate cell may comprise CHO execution condition. The UE may execute CHO to the Cho candidate cell based on the comprised CHO execution condition. For example, UE can execute CHO to a CHO candidate cell if all the configured CHO execution condition(s) of the CHO candidate cell are fulfilled. Up to two CHO execution conditions can be configured for a CHO candidate cell.

The CHO execution condition for a CHO candidate cell may comprise:
a cell quality-based CHO execution condition (event A3, event A4, event A5);
a time-based CHO execution condition (e.g., condEvent T1, or event T1);
a location-based CHO execution condition (e.g., event D1); and
a cell quality-based CHO execution condition may be based on measurement results of a cell quality (e.g., RSRP, RSRQ, or SINR).

In an example, event A3 may be satisfied if measured cell quality of the CHO candidate cell is offset higher than the SpCell (e.g., PCell, or SPCell). The event A3 may be condEvent A3.

In an example, event A4 may be satisfied if measured cell quality of the CHO candidate cell is higher than a threshold. The event A4 may be condEvent A4.

In an example, event A5 may be satisfied if measured cell quality of the SpCell (e.g., PCell, or SPCell) is lower than a first threshold and measured cell quality of the CHO candidate cell is higher than a second threshold. The event A5 may be condEvent A5.

A time-based CHO execution condition (e.g., event T1, or condEvent T1) may comprise a time period. The time period may comprise a starting time point of the time period and a time duration of the time period. End time point of the time period may be the time duration after the starting time point of the time period. For example, the time period may comprise a starting time point of 9:00 UTC and a time duration of 10 minutes. Then the time period may start at 9:00 UTC and may last 10 minutes. The time period may be from 9:00 UTC to 9:10 UTC. The time-based CHO execution condition may be satisfied when the time measured at UE is after the starting time point of the time period and before the end time point of the time period.

A location-based CHO execution condition may comprise a first reference location which is associated to serving cell (e.g., PCell, SPCell) and a second reference location which is associated to the CHO candidate cell (e.g., CHO target cell). The location-based CHO execution condition may be satisfied when the distance between the UE and the first reference location is higher than a first threshold and the distance between the UE and the second reference location is lower than a second threshold.

A time-based CHO execution condition or a location-based CHO execution condition may be configured together with a cell quality-based CHO execution condition (e.g., event A3, event A4, or A5). A time-based CHO execution condition and a location-based CHO execution may not be configured together for a CHO candidate cell.

The (NTN) base station/network may configure:
multiple SMTCs in parallel per carrier and/or for a given set of cells depending on UE capabilities using propagation delay difference, feeder link delay, and/or serving/neighbor satellite cell ephemeris; and/or
measurement gaps using a same propagation delay difference as computed for SMTC.

The adjustment of SMTCs may be possible under network control for connected mode and under UE control based on UE location information and ephemeris for idle/inactive modes.

Upon network request, after AS security in connected mode is established, a UE may report coarse UE location information (e.g., X most Significant Bits of GNSS coordinates of the UE with accuracy around 2 km level) to the NG-RAN without receiving any prior explicit user consent. If user consent is available at the UE, the UE may report the coarse UE location information. Else, the UE may respond “no coarse GNSS location available”. Periodic location reporting may be configured by gNB to obtain UE location update of mobile UE in RRC_CONNECTED mode/state.

The base station (e.g., gNB) may transmit/broadcast the NTN-specific SIB. The NTN-specific SIB may be, for example, SIB19. The NTN-specific SIB may comprise satellite assistance information. For example, the NTN-specific SIB may comprise ephemeris data. For example, the NTN-specific SIB may comprise common TA parameters. For example, the NTN-specific SIB may comprise common TA parameters. For example, the NTN-specific SIB may comprise k-offset. For example, the NTN-specific SIB may comprise a validity duration for UL synchronization information. For example, the NTN-specific SIB may comprise an epoch time. For example, the NTN-specific SIB may comprise a reference location of a (NTN) cell provided via NTN quasi-Earth fixed system.

The NTN-specific SIB may comprise a t-service. The t-service may indicate time information on when a (NTN) cell provided via NTN quasi-Earth fixed system is going to stop serving an area the (NTN) cell is currently covering. The t-service may count a number of universal time coordinated (UTC) seconds in 10 ms units since 00:00:00 on Gregorian calendar date 1 Jan. 1900 (midnight between Sunday, Dec. 31, 1899, and Monday, Jan. 1, 1900).

Upon receiving the NTN-specific SIB, the UE may instruct lower layers to start or restart ntn-UlSyncValidityDuration from the subframe/slot indicated by the epoch time. The UE may attempt to re-acquire the NTN-specific SIB before end of a duration indicated by ntn-UlSyncValidityDuration and the epoch time.

Support for bandwidth limited low complexity (BL) UEs, UEs in enhanced coverage, and/or narrowband Internet-of-Things (NB-IoT) UEs over NTN may be applicable. UEs not supporting NTN may be barred from an NTN cell.

In NTN, BL UEs, UEs in enhanced coverage, and NB-IoT wire UEs with GNSS capability may be supported.

To accommodate long propagation delays in NTN, increased timer values and window sizes, or delayed starting times may be supported for the physical layer and/or for higher layers.

UL segmented transmission may be supported for UL transmission with repetitions in NTN. The UE may apply UE pre-compensation per segment of UL transmission of PUSCH/PUCCH/PRACH for eMTC and NPUSCH/NPRACH for NB-IoT from one segment to a next segment.

To accommodate the long propagation delays, several IoT timings involving DL-UL timing interaction may be enhanced by the support of two scheduling offsets: K_offset and K_mac. K_offset may be a round-trip time between the UE and an uplink time synchronization reference point (RP). K_offset may correspond to a sum of a service link RTT and a common TA if indicated. K_mac may be a round trip time between the RP and the eNB/gNB.

DL and UL may frame aligned at the uplink time synchronization RP with an offset given by N_(TA, offset).

Timing relationships that may be modified for NB-IoT using K_offset are summarized as follows:
a transmission timing of NPDCCH scheduled NPUSCH format 1.
a transmission timing of random access response (RAR) grant scheduled NPUSCH format 1.
a transmission timing of HARQ-ACK on NPUSCH format 2.
a transmission timing of NPDCCH ordered NB-IoT physical random access channel (NPRACH).
a timing of the adjustment of uplink transmission timing upon reception of a corresponding timing advance command.

Timing relationships that may be modified for eMTC using K_offset are summarized as follows:
a transmission timing of MPDCCH scheduled PUSCH.
a transmission timing of random access response (RAR) grant scheduled PUSCH.
a timing of the first PUSCH transmission opportunity in UL SPS.
a transmission timing of HARQ-ACK on physical uplink control channel (PUCCH).
a transmission timing of MPDCCH ordered physical random access channel (PRACH).
a timing of the adjustment of uplink transmission timing upon reception of a corresponding timing advance command.
a transmission timing of aperiodic sounding reference signal (SRS).
a CSI reference resource timing.
a transmission timing of a preamble retransmission.

For initial access, information of K_offset may be carried in system information. Update of the K_offset after initial access may be supported. A UE-specific K_offset may be provided and updated by network/gNB/eNB/base station with MAC CE.

K_mac is a scheduling offset that may be supported in NTN for MAC CE timing relationships enhancement. K_mac may be provided by the network if downlink and uplink frame timing are not aligned at eNB. K_mac may be needed for UE action and assumption on downlink configuration indicated by a MAC-CE command in (N) PDSCH. The K_mac may also be used in pre-configured uplink resources, in response to the UE initiating an (N) PUSCH transmission using pre-configured uplink resources ending in subframe n, the UE may start or restart to monitor the N/MPDCCH from DL subframe n+4+K_mac.

For a serving cell, a network/eNB/gNB may broadcast ephemeris information and common TA parameters for the UE to autonomously perform TA pre-compensation. For the serving cell, the network/gNB/eNB may broadcast ephemeris information and common TA parameters for the UE to autonomously perform frequency shift pre-compensation.

The UE may acquire a GNSS position of the UE before connecting to an NTN cell to ensure the UE is synchronized. The UE may acquire satellite ephemeris and common TA before connected to the NTN cell to ensure the UE is synchronized. Before performing random-access, the UE may autonomously pre-compensate a TA for the long propagation delay as well as the frequency doppler shift by considering the common TA, position of the UE and a satellite position through the satellite ephemeris.

In RRC_CONNECTED mode, the UE may continuously update the TA and frequency pre-compensation. The UE may not be expected to perform GNSS acquisition. One or more timers may ensure that the UE does not perform any transmissions due to outdated satellite ephemeris, common TA, or GNSS position. In connected mode, upon outdated satellite ephemeris and common TA, the UE may re-acquire one or more broadcasted parameters. Upon outdated GNSS position the UE may move to RRC_IDLE mode.

The UE may be configured to report TA at initial access or in the RRC_CONEECTED mode. In the RRC_CONEECTED mode, triggered reporting of the TA may be supported.

The UE may be capable of using an acquired GNSS position of UE and the satellite ephemeris information (when provided by the network/gNB/eNB) to calculate frequency pre-compensation to counter shift an instantaneous Doppler shift experienced on a service link.

The management of Doppler shift experienced over a feeder link as well as any transponder frequency error whether introduced in DL or UL may be left to network implementation.

As a satellite moves on a specified orbit, for example, in case of a NGSO satellite, a satellite beam's coverage area may move and cover different portions of a geographical area due to an orbital movement of the satellite. As a consequence, a UE located in a concerned geographical area may experience a situation of discontinuous coverage, due to, for example, a sparse satellites constellation deployment.

To enable the UE to save power during periods of no coverage, the network/gNB/eNB may provide satellite assistance information (e.g., satellite ephemeris parameters, a start-time of upcoming satellite's coverage, end-time of satellite's coverage, and the like) ephemeris parameters to enable the UE to predict when coverage will be provided by upcoming satellites. Predicting out of coverage and in coverage may be up to UE implementation. When out of coverage, the UE may not be required to perform access stratum functions.

A feeder link switch over may be a procedure where a feeder link is changed from a source NTN Gateway to a target NTN Gateway for a specific NTN payload. The feeder link switch over may be a Transport Network Layer procedure. Both hard and soft feeder link switch over may be applicable to NTN.

A feeder link switch over may result in transferring an established connection for affected UE between two eNBs/gNBs/base stations.

For soft feeder link switch over, an NTN payload may be able to connect to more than one NTN Gateway during a given period, e.g., a temporary overlap may be ensured during transition between feeder links. For hard feeder link switch over, an NTN payload may only connect to one NTN Gateway at any given time, e.g., a radio link interruption may occur during a transition between the feeder links.

An NTN control function may determine a point in time when the feeder link switch over between two eNBs/gNBs/base stations is performed. For BL UEs and UEs in enhanced coverage, transfer of the affected UEs' contexts between the two eNBs/gNBs/base stations at the feeder link switch over may be performed by means of either S1 based or X2 based handover. The transfer may depend on implementations of the two eNBs/gNBs/base stations and configuration information provided to the two eNBs/gNBs/base stations by the NTN control function.

A base station may transmit to a wireless device an RRC message indicating a time value, t-service, and a reference location of the serving cell of the wireless device, referenceLocation. The t-service may indicate a time information on when a cell provided via NTN quasi-Earth fixed system is going to stop serving the area it is currently covering. The referenceLocation may indicate reference location of the serving cell provided via NTN quasi-Earth fixed system. The RRC message may be system information (e.g., SIB19) or an RRC reconfiguration message. For example, in NTN, a base station may transmit an RRC reconfiguration comprising CHO configuration to a wireless device. The CHO configuration may comprise location-based CHO execution condition (e.g., condEvent D1). The location-based CHO execution condition may be associated with a reference location of a serving cell and/or candidate cell. For example, the location-based CHO execution condition may comprise a value of referencelocation1 and a value of referencelocation2. Each value may be associated with serving cell and candidate cell, respectively. The wireless device may evaluate whether the location-based CHO execution condition is fulfilled. The wireless device evaluating the location-based CHO execution condition may determine a distance with the serving cell and/or the candidate cell based on the reference location (for example, the distance from the serving cell and/or the candidate cell or a round trip distance with respect to the service cell and/or the candidate cell).

A reference location of an earth moving cell may change over time. A fixed value of a reference location may not indicate the reference location of an earth moving cell which moves over a time. A base station may transmit to a wireless device a message indicating the reference location of the earth moving cell. This procedure results in signals and uses resources which are used for indicting the reference location being changed over a time, thereby generating signal overhead and resource usage overhead. In existing technologies, a base station may transmit assistance information for calculating the reference location to a wireless device. For example, the assistance information may comprise ephemeris information. Based on the ephemeris information and/or the assistance information, the wireless device may calculate the reference location of the earth moving cell. This approach reduces signal overhead as compared to the option of the message indicating the reference location of the earth moving cell.

The wireless device evaluating the location-based CHO execution condition of the earth moving cell may determine a distance with the serving cell and/or the candidate cell based on calculating the reference location of the serving cell and/or the candidate cell. The wireless device calculating the reference location may detect/determine an event. Based on the event, the wireless device may transmit, to a base station, a report comprising contents related to the event. The event may comprise at least one of: an RLF or a successful completion of a handover. The RLF may comprise a connection failure while connected to a base station or a handover failure. For example, the report may comprise RLF-Report indicating RLF report related contents. For example, the report may comprise successHO-Report indicating successful handover report. The report for the successful completion of a handover may indicate a parameter when the wireless device executed the handover. The parameter may comprise at least one of: a distance with a serving cell and/or a candidate cell; a signal strength of the serving cell; or a signal strength of the serving cell.

The report may comprise the distance with the serving cell and/or the candidate cell (for example, the distance between the wireless device and the serving cell and/or the candidate cell, and/or the round trip distance). The distance may be a distance when the wireless device detects the event (e.g., execution of CHO). Based on receiving the report, the base station may optimize a parameter associated with a procedure (e.g., CHO). For example, the base station receiving the report may transmit an updated condition, for the procedure, to the wireless device.

For example, the wireless device may transmit the report to the base station in response to receiving a request indication (e.g., rlf-ReportReq) from the base station. For example, the report may be an RLF-Report, comprising an RLF report related contents. If the RLF-Report indicates a handover failure information and the failed handover was triggered based on the location-based CHO execution condition, the RLF-Report omits the value of the reference location when the handover was executed. Therefore, the base station does not know the value of the reference location which was failed.

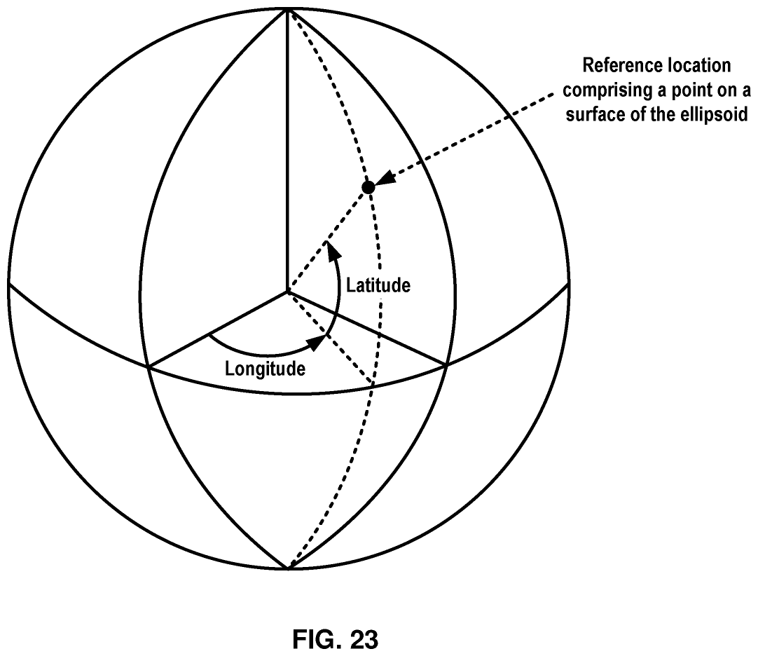

FIG. 23 illustrates an example of reference location containing location information. A reference location may comprise an ellipsoid point (e.g., Ellipsoid-Point) indicating a point on a surface of an ellipsoid. The ellipsoid point may consist of a latitude and a longitude. The latitude may be an angle between an equatorial plane and a perpendicular to a plane tangent to the ellipsoid surface at the point. Positive latitudes correspond to the North hemisphere. The longitude may be an angle between a half-plane determined by the Greenwich meridian and a half-plane defined by the point and a polar axis, measured Eastward.

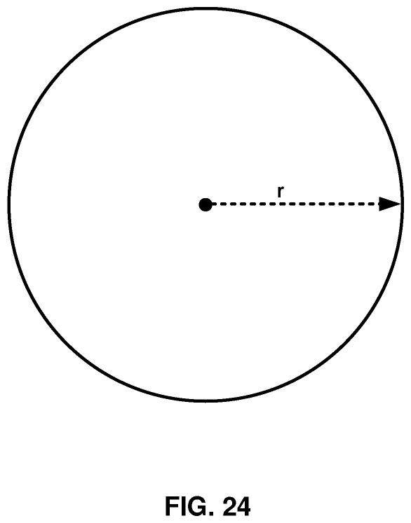

FIG. 24 illustrates an example of a reference location comprising an ellipsoid point with an uncertainty circle. The ellipsoid point with the uncertainty circle may comprise co-ordinates of the ellipsoid point (the origin) and a distance r. It may comprise a set of points on the ellipsoid where each point of the set of points are at a distance from the origin less than or equal to a value of the r. Each point of the set of points may indicate a reference location. The distance may be the geodesic distance over the ellipsoid. For example, the distance may be minimum length of a path staying on the ellipsoid and joining the two points. As for the ellipsoid point, the ellipsoid point with the uncertainty circle may be used to indicate points on the Earth surface, or near the Earth surface, of same latitude and longitude. The typical use of this shape is to indicate a point when its position is known only with a limited accuracy. For example, a position of the point may be known only within the uncertainty circle.

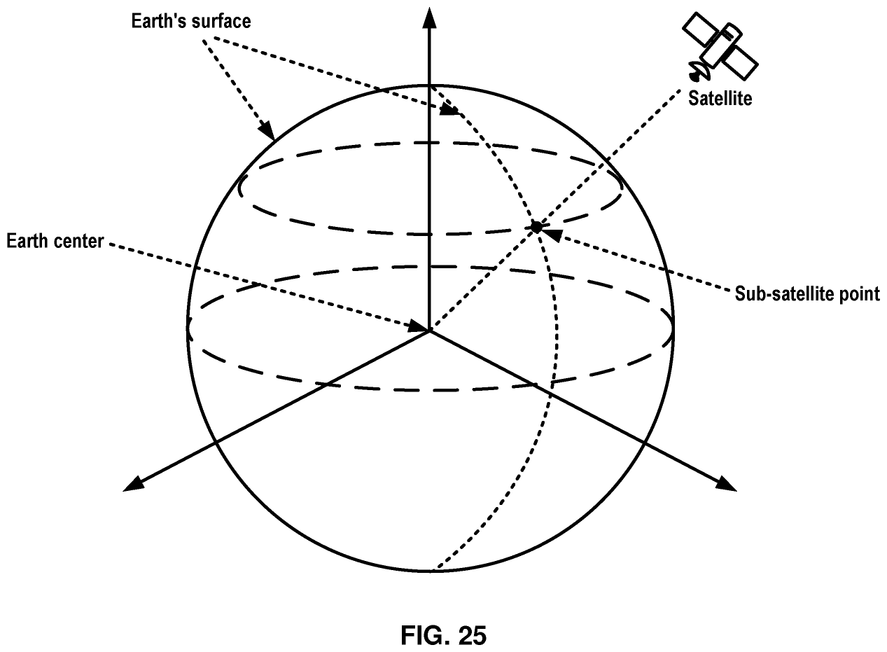

FIG. 25 illustrates an example of a reference location comprising a sub-satellite point. The sub-satellite point may be an intersection of a line from the Earth center to a position of a satellite with the earth's surface. The sub-satellite point may be derived based on a satellite ephemeris and an epoch time.

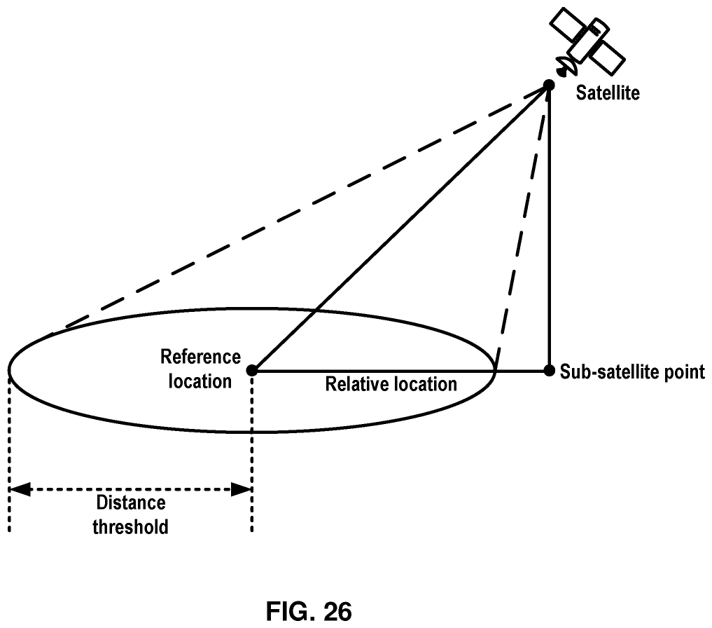

FIG. 26 illustrates an example of a reference location comprising a sub-satellite point, a relative location, and a distance threshold. The wireless device may derive a position of a reference location based on a sub-satellite point of a satellite, a relative location from the sub-satellite point, and a distance threshold. For example, the wireless device may determine that the position of the reference location is the relative location from the sub-satellite point. A cell coverage of the reference location may be based on the distance threshold from the reference location.

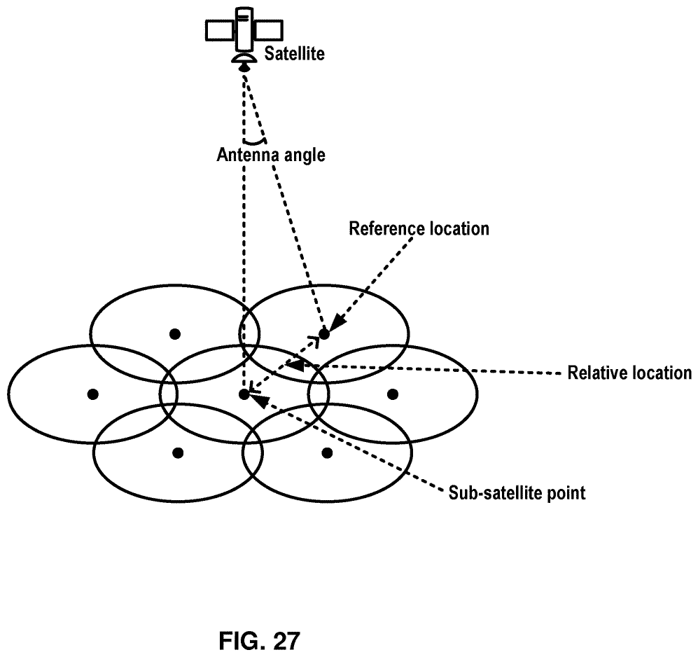

FIG. 27 illustrates an example of a reference location comprising a sub-satellite point, an antenna angle, and a relative location. A satellite may serve one or more reference locations. Each of the one or more reference locations may be associated with a relative location and/or an antenna angle. For example, a position of a reference location may be a relative location from a sub-satellite point. For example, an angle between a line from a satellite to the sub-satellite point of the satellite and a line from the satellite to the reference location may be an antenna angle of the reference location.

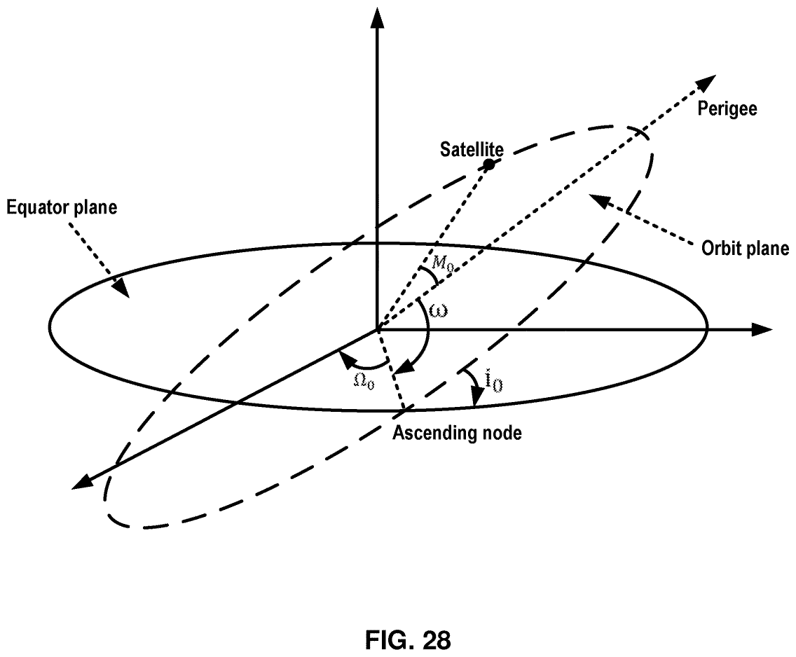

FIG. 28 illustrates an example of an ephemeris data based on a satellite orbit and Keplerian elements. Ephemeris data may contain information about orbital trajectories of artificial satellites relative to an equator plane. There may be different possible representations of the ephemeris data. One option may be to use orbital parameters, e.g., semi-major axis, eccentricity, inclination, right ascension of the ascending node, argument of periapsis, mean anomaly at a reference point in time, and the epoch. The first five parameters may determine an orbital plane, and the other two parameters may be used to determine exact satellite location at a time. For example, orbital plane parameters may comprise:
\sqrt{a} indicating square root of semi major axis (semi-major axis);
e indicating an eccentricity (eccentricity);
i₀ indicating inclination angle at a reference time (inclination);
Ω₀ indicating a longitude of ascending node of an orbit plane (right ascension of the ascending node); and
ω indicating an argument of perigee (argument of periapsis).

For example, satellite level parameters may comprise:
M₀ indicating a mean anomaly at reference time (true anomaly and a reference point in time); and
t₀ₑ indicating an ephemeris reference time (the epoch).

A wireless device may receive, from a network via a system information, relaxedMeasurement. relaxedMeasurement may be a configuration of relaxed measurement to allow the wireless device to perform a relaxation of radio resource management (RRM) measurement requirements for cell reselection. In NTN, the configuration may be only applicable for GSO neighbor cells. relaxedMeasurement may comprise lowMobilityEvaluation and cellEdgeEvaluation. lowMobilityEvaluation may indicate a low mobility criterion for the wireless device to detect low mobility to relax the measurement requirements for cell reselection. cellEdgeEvaluation may indicate a not-at-cell edge criterion for the wireless device to detect that the wireless device is not at cell edge to relax the measurement requirements for cell reselection. The wireless device may perform relaxed measurement based on the low mobility criterion being fulfilled if the low mobility criterion is fulfilled. The wireless device may perform relaxed measurement based on the not-at-cell edge criterion being fulfilled if the not-at-cell edge criterion is fulfilled. The wireless device may perform relaxed measurement based on the low mobility criterion being fulfilled and the not-at-cell edge criterion if the low mobility criterion is fulfilled and the not-at-cell edge criterion is fulfilled. Based on performing a relaxed measurement, the wireless device may relax the measurement requirements for cell reselection.

The low mobility criterion may be a criterion for the wireless device with low mobility. The low mobility criterion may be fulfilled when (SrxlevRef−Srxlev)<SSearchDeltaP. Srxlev may be a current Srxlev value of the serving cell (dB). SrxlevRef may be a reference Srxlev value of the serving cell (dB). The wireless device may set a value of the SrxlevRef to the current Srxlev value of the serving cell based on: after selecting or reselecting a new cell; or if (Srxlev−SrxlevRef)>0 (i.e., a value of Srxlev is higher than a value of SrxlevRef); or if the relaxed measurement criterion has not been met for TSearchDeltaP.

The not-at-cell edge criterion may be a criterion for the wireless device not at cell edge. The not-at-cell edge criterion may be fulfilled when: Srxlev>SSearchThresholdP; and Squal>SSearchThresholdQ, if SSearchThresholdQ is configured. Srxlev may be a current Srxlev value of the serving cell (dB). Squal may be a current Squal value of the serving cell (dB).

When a wireless device is configured with relaxedMeasurement, if lowMobilityEvaluation is configured and cellEdgeEvaluation is not configured; and the wireless device has performed normal intra-frequency, NR inter-frequency, or inter-RAT frequency measurements for at least TSearchDeltaP after (re-)selecting a new cell; and if the low mobility criterion is fulfilled for a period of TSearchDeltaP, the wireless device may choose to perform relaxed measurements for intra-frequency cells, NR inter-frequency cells or inter-RAT frequency cells based on the low mobility criterion being fulfilled.

When a wireless device is configured with relaxedMeasurement, if cellEdgeEvaluation is configured and low MobilityEvaluation is not configured; and the not-at-cell edge criterion is fulfilled, the wireless device may choose to perform relaxed measurements for intra-frequency cells based on the not-at-cell edge criterion being fulfilled. If the serving cell, of the wireless device, fulfils Srxlev≤SnonIntraSearchP or Squal≤SnonIntraSearchQ, the wireless device may choose to perform relaxed measurements for NR inter-frequency cells or inter-RAT frequency cells based on fulfilling not-at-cell edge criterion.

When a wireless device is configured with relaxedMeasurement, if both lowMobilityEvaluation and cellEdgeEvaluation are configured, if the wireless device has performed normal intra-frequency, NR inter-frequency, or inter-RAT frequency measurements for at least TSearchDeltaP after (re-)selecting a new cell; and if the low mobility criterion is fulfilled for a period of TSearchDeltaP; and if the not-at-cell edge criterion is fulfilled, the wireless device may choose to perform relaxed measurements for NR intra-frequency cells, inter-frequency cells or inter-RAT frequency cells based on and the not-at-cell edge criterion.

When a wireless device is configured with relaxedMeasurement, if both lowMobilityEvaluation and cellEdgeEvaluation are configured, if the wireless device has performed normal intra-frequency, NR inter-frequency, or inter-RAT frequency measurements for at least TSearchDeltaP after (re-)selecting a new cell and the low mobility criterion is fulfilled for a period of TSearchDeltaP, or the not-at-cell edge criterion is fulfilled, the wireless device may choose to perform relaxed measurements for intra-frequency cells, NR inter-frequency cells of equal or lower priority, or inter-RAT frequency cells of lower priority based on the low mobility criterion being fulfilled or the not-at-cell edge criterion being fulfilled if combineRelaxedMeasCondition is not configured. Distance Thresh may be a parameter indicating a distance threshold associated with a distance from the serving cell reference location to the wireless device.

enhancedMeasurementLEO may be a parameter indicating that the wireless device may apply the enhanced cell reselection requirements for NTN LEO.

Ês/lot may be a condition of measurement performance requirements.

Kcarrier may be a parameter indicating a number of NR inter-frequency carriers indicated by the serving cell.

Kcarrier_HST may be a number of NR inter-frequency carriers which are configured with highSpeedMeasInterFreq-r17 for FR1 indicated by the serving cell.

Srxlev may be a parameter indicating a cell selection RX level.

Squal may be a parameter indicating a cell selection quality.

SIntraSearchP may be a parameter indicating an Srxlev threshold for NR intra-frequency and inter-RAT measurements.

SnonIntraSearchP may be a parameter indicating an Srxlev threshold for NR inter-frequency and inter-RAT measurements.

SIntraSearchQ may be an Squal threshold for NR intra-frequency and inter-RAT measurements.

SnonIntraSearchQ may be an Squal threshold for NR inter-frequency and inter-RAT measurements.

Tdetect,NR_Intra may be a parameter that refers to intra-frequency cell detection delay in RRC idle or inactive state.

Tdetect,NR_Intra_enh may be a parameter that refers to intra-frequency cell detection delay for enhanced cell reselection requirements for LEO in RRC idle or inactive state.

Tdetect,NR_Inter may be a parameter that refers to inter-frequency cell detection delay in RRC idle or inactive state.

Tdetect,NR_Inter_enh may be a parameter that refers to inter-frequency cell detection delay for enhanced cell reselection requirements for LEO in RRC idle or inactive state.

Tdetect,NR_Inter_HST may be a parameter that refers to inter-frequency cell detection delay for high speed requirements in RRC idle or inactive state.

Tdetect,NR_Inter_Relax may be a parameter that refers to inter-frequency cell detection delay for relaxed measurement requirements in RRC idle or inactive state.

Tmeasure,NR_Intra may be a parameter indicating a measurement period for intra-frequency on NR cells.

Tmeasure,NR_Inter may be a parameter indicating a measurement period for inter-frequency on NR cells.

Tmeasure,NR_Inter_Relax be a parameter indicating a relaxed measurement period for inter-frequency on NR cells.

Treselection may be a parameter specifying/indicating a cell reselection timer value.

Tevaluate,NR_Intra may be a parameter indicating an evaluation period of whether a cell has met intra-frequency cell reselection criterion.

Tevaluate,NR_Inter may be a parameter indicating an evaluation period of whether a cell has met inter-frequency cell reselection criterion.

Tevaluate,NR_Inter_HST may be a parameter indicating an evaluation period of whether a cell has met inter-frequency cell reselection criterion while applying high speed measurement requirements.

Tevaluate,NR_Inter_Relax may be a parameter indicating an evaluation period of whether a cell has met inter-frequency cell reselection criterion while applying relaxed measurement requirements.

Kmulti_SMTC may be a scaling factor for measurements of multiple SMTCs which correspond to different satellites.

The parameter Kmulti_SMTC,i may be a scaling factor for measurement of multiple SMTCs or multiple satellites.

absThreshSS-BlocksConsolidation indicates a minimum threshold for beams which can be used for selection of the highest ranked cells.

rangeToBestCell may indicate an R value range which the cells whose R value is within the range can be a candidate for the highest ranked cell.

highSpeedMeasFlag indicates to apply an enhanced intra-NR and inter-RAT EUTRAN RRM requirements.

highSpeedMeasFlagFR2 indicates to apply an enhanced intra-NR RRM requirement set one to support high speed up to 350 km/h for FR2.

PSS may indicate a primary synchronization signal.

SSS may indicate a secondary synchronization signal.

Ncarrier_Relax may indicate a total number of inter-frequency carriers configured for mobility measurements while performing relaxed measurement.

Ncarrier_Non_relax may indicate a total number of inter-frequency carriers configured for mobility measurements.

Thigher_priority_search may indicate a measurement period of searching every layer of higher priority.

A wireless device in RRC idle or inactive state may perform a cell reselection procedure to select a more suitable cell and camp on it. When the wireless device is in either a “Camped Normally” state or “Camped on Any Cell” state on a cell, the wireless device may attempt to detect, synchronize, and monitor one or more intra-frequency, inter-frequency and inter-RAT cells indicated by a serving cell of the wireless device. For the intra-frequency and inter-frequency cells the serving cell may not provide an explicit neighbor list but carrier frequency information and bandwidth information only. The wireless device measurement activity may be controlled by measurement rules allowing the wireless device to limit its measurement activity.

A wireless device may be able to identify one or more intra-frequency cells and perform SS-RSRP and SS-RSRQ measurements of the identified one or more intra-frequency cells without an explicit intra-frequency neighbor list containing physical layer cell identities.

The wireless device may be able to evaluate whether a detectable intra-frequency cell meets the reselection criteria, for cell reselection, within Tdetect,NR_Intra when that Treselection=0. An intra frequency cell is considered to be detectable according to Table 1 and Table 2.

TABLE 1
Conditions for intra-frequency cell re-selection in FR1

| | | Minimum SSB_RP | | |
|---|---|---|---|---|
| | | dBm/SCS_{SSB} | | SSB |
| | NR operating band | SCS_{SSB} = | SCS_{SSB} = | Ês/lot |
| Parameter | groups ^{Note1} | 15 kHz | 30 kHz | dB |
| Conditions | NR_FDD_FR1_A, | −124 | −121 | ≥−4 |
| | NR_TDD_FR1_A | | | |
| | NR_FDD_FR1_B | −123.5 | −120.5 | |
| | NR_TDD_FR1_C | −123 | −120 | |
| | NR_FDD_FR1_D, | −122.5 | −119.5 | |
| | NR_TDD_FR1_D | | | |
| | NR_FDD_FR1_E, | −122 | −119 | |
| | NR_TDD_FR1_E | | | |
| | NR_FDD_FR1_F | −121.5 | −118.5 | |
| | NR_FDD_FR1_G, | −121 | −118 | |
| | NR_TDD_FR1_G | | | |
| | NR_FDD_FR1_H | −120.5 | −117.5 | |

^{Note1} :
NR operating band groups are defined in clause 3.5.2.

TABLE 2
Conditions for intra-frequency cell re-selection in FR2

| | | | Minimum SSB_RP ^{Note 2, Note 3} | | | | | | |
|---|---|---|---|---|---|---|---|---|---|
| | | | dBm / SCS_{SSB} | | | | | | |
| | | | | | | | | SCS_{SSB} = | |
| | | | | | | | | 240 kHz | |
| | | NR | SCS_{SSB} = 120 kHz | | | | | UE Power | SSB |
| | Angle of | operating | UE Power class | | | | | class | Ês/Iot |
| Parameter | arrival | bands | 1 | 2 | 3 | 4 | 5 | 1, 2, 3, 4, 5 | dB |
| Conditions | Rx Beam | n257 | −125.3 + Y₁ | −110.8 | −109.1 | −124.8 + Y₄ | −120.4 + Y₅ | (Value for | ≥−4 |
| | Peak | n258 | −125.3 + Y₁ | −110.8 | −109.1 | −124.8 + Y₄ | −120.6 + Y₅ | SCS_{SSB} = | |
| | | n259 | | | −105.5 | | −117.5 + Y₅ | 120 kHz) + | |
| | | n260 | −122.3 + Y₁ | | −106.5 | −122.8 + Y₄ | | 3 dB | |
| | | n261 | −125.3 + Y₁ | −110.8 | −109.1 | −124.8 + Y₄ | | | |
| | | n262 | −120.3 + Y₁ | −105.6 | −103.6 | −118.8 + Y₄ | | | |
| | Spherical | n257 | −117.3 + Z₁ | −99.8 | −98.2 | −115.8 + Z₄ | −112.4 + Z₅ | (Value for | ≥−4 |
| | coverage | n259 | | | −92.7 | | | SCS_{SSB} = | |
| | ^{Note 1} | n258 | −117.3 + Z₁ | −99.8 | −98.2 | −115.8 + Z₄ | −112.6 + Z₅ | 120 kHz) + | |
| | | n260 | −114.3 + Z₁ | | −93.9 | −110.8 + Z₄ | | 3 dB | |
| | | n261 | −117.3 + Z₁ | −99.8 | −98.2 | −115.8 + Z₄ | | | |
| | | n262 | −112.1 + Z₁ | −93.7 | −90.5 | −106.7 + Z₄ | | | |

^{NOTE 1}
Values based on EIS spherical coverage as defined in clause 7.3.4 of TS 38.101-2 [19]. Side condition applies for directions in which EIS spherical coverage requirement is met.
^{NOTE 2}
Values specified at the Reference point to give minimum SSB Ês/Iot, with no applied noise.
^{NOTE 3}
For UEs that support multiple FR2 bands, Rx Beam Peak values are increased by ΔMB_{P, n} and Spherical coverage values are increased by ΔMB_{S, n}, the UE multi-band relaxation factor in dB specified in clause 6.2.1 of TS 38.101-2 [19].

The wireless device may measure SS-RSRP and SS-RSRQ at least every Tmeasure,NR_Intra for intra-frequency cells that are identified and measured according to measurement rules. The value of Tmeasure,NR_Intra may be based on Table 3-1, Table 3-2, Table 3-3, Table 3-4, or Table 3-5.

The wireless device may filter SS-RSRP and SS-RSRQ measurements of each measured intra-frequency cell using at least 2 measurements. Within the set of measurements used for the filtering, at least two measurements may be spaced by at least Tmeasure,NR_Intra/2.

The wireless device may not consider a NR neighbor cell in cell reselection if the NR neighbor cell is indicated as not allowed in the measurement control system information of the serving cell.

For an intra-frequency cell that has been already detected, but that has not been reselected to, the filtering may be such that the wireless device may be capable of evaluating that the intra-frequency cell has met reselection criterion, for cell reselection within Tevaluate,NR_Intra when Treselection=0 based on Table 3-1, Table 3-2, Table 3-3, Table 3-4 or Table 3-5 provided that: when rangeToBestCell is not configured, the cell is at least 3 dB better ranked in FR1 or 4.5 dB better ranked in FR2; and when rangeToBestCell is configured, the cell has the highest number of beams above the threshold absThreshSS-BlocksConsolidation among all detected cells whose cell-ranking criterion R value is within rangeToBestCell of the cell-ranking criterion R value of the highest ranked cell. If there are multiple cells whose cell-ranking criterion R value is within rangeToBestCell of the cell-ranking criterion R value of the highest ranked cell, the cell has the highest rank among them, the cell is at least 3 dB better ranked in FR1 or 4.5 dB better ranked in FR2 if the current serving cell is among them.

When evaluating cells for reselection, the SSB side conditions may apply to both serving and non-serving intra-frequency cells.

If a Treselection timer has a nonzero value and an intra-frequency cell is satisfied with the reselection criteria, for cell reselection, the wireless device may evaluate the intra-frequency cell for the Treselection time. If the cell remains satisfied with the reselection criteria within this duration, then the wireless device may reselect the cell.

For the wireless device neither configured with highSpeedMeasFlag nor highSpeedMeasFlagFR2, value of Tdetect,NR_Intra, Tmeasure,NR_Intra and Tevaluate,NR_intra are based on Table 3-1. For the wireless device configured with highSpeedMeasFlag-r16, value of Tdetect,NR_Intra, Tmeasure,NR_Intra and Tevaluate,NR_intra are specified in Table 3-2. For FR2 power class 6 wireless device configured with highSpeedMeasFlagFR2-r17, value of Tdetect,NR_Intra, Tmeasure,NR_Intra and Tevaluate,NR_intra are specified in Table 3-3.

For the wireless device not configured with eDRX_IDLE cycle, value of Tdetect,NR_Intra, Tmeasure,NR_Intra and Tevaluate,NR_Intra are based on Table 3-1, Table 3-2 and Table 3-3.

For the wireless device configured with eDRX_IDLE cycle, Tdetect,NR_Intra, Tmeasure,NR_Intra and Tevaluate,NR_Intra are specified in Table 3-4 and Table 3-5 for FR1 and FR2 respectively, where the requirements may apply provided that the serving cell of the wireless device is configured with eDRX_IDLE and is the same in all PTWs during any of Tdetect,NR_Intra, Tmeasure,NR_Intra and Tevaluate,NR_Intra when multiple PTWs are used.

The requirements in Table 3-2 apply only when the UE supports measurementEnhancement-r16 or intraNR-MeasurementEnhancement-r16. For the wireless device neither supporting either measurementEnhancement-r16 nor intraNR-MeasurementEnhancement-r16, the wireless device is not required to meet the requirements specified in Table 3-2.

TABLE 3-1
T_{detect, NR}_{_{—}}_{Intra,} T_{measure, NR}_{_{—}}_{Intra} and T_{evaluate, NR}_{_{—}}_{Intra}

| DRX | | | | T_{detect, NR}_{_{—}}_{Intra} | T_{measure, NR}_{_{—}}_{Intra} | T_{evaluate, NR}_{_{—}}_{Intra} |
|---|---|---|---|---|---|---|
| cycle | | | | [s] (number | [s] (number | [s] (number |
| length | Scaling Factor (N1) | | | of DRX | of DRX | of DRX |
| [s] | FR1 | FR2-1^{Note1} | FR2-2 ^{Note2} | cycles) | cycles) | cycles) |
| 0.32 | 1 | 8 | 12 | 11.52 × N1 × | 1.28 × N1 × | 5.12 × N1 × |
| | | | | M2 (36 × | M2 (4 × | M2 (16 × |
| | | | | N1 × M2) | N1 × M2) | N1 × M2) |
| 0.64 | | 5 | 8 | 17.92 × N1 | 1.28 × N1 | 5.12 × N1 |
| | | | | (28 × N1) | (2 × N1) | (8 × N1) |
| 1.28 | | 4 | 6 | 32 × N1 | 1.28 × N1 | 6.4 × N1 |
| | | | | (25 × N1) | (1 × N1) | (5 × N1) |
| 2.56 | | 3 | 5 | 58.88 × N1 | 2.56 × N1 | 7.68 × N1 |
| | | | | (23 × N1) | (1 × N1) | (3 × N1) |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.
Note 3:
M2 = 1.5 if SMTC periodicity of measured intra-frequency cell > 20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}ᵢₙₜᵣₐ is expected.

TABLE 3-2
T_{detect, NR}_{_{—}}_{Intra,} T_{measure, NR}_{_{—}}_{Intra} and T_{evaluate, NR}_{_{—}}_{Intra} for UE
configured with highSpeedMeasFlag-r16 (Frequency range FR1)

| DRX | | | | |
|---|---|---|---|---|
| cycle | T_{detect, NR}_{_{—}}_{Intra} | | T_{measure, NR}_{_{—}}_{Intra} | T_{evaluate, NR}_{_{—}}_{Intra} |
| length | [s] (number of | | [s] (number of | [s] (number of |
| [s] | DRX cycles) | | DRX cycles) | DRX cycles) |
| 0.32 | 2.56 × M2 | | 0.32 × M3 | 0.96 × M4 |
| | (8 × M2) | | (1 × M3) | (3 × M4) |
| 0.64 | 5.12 | (8) | 0.64 (1) | 1.92 (3) |
| 1.28 | 8.96 | (7) | 1.28 (1) | 3.84 (3) |
| 2.56 | 58.88 | (23) | 2.56 (1) | 7.68 (3) |

Note 1:
when SMTC <= 40 ms, M2 = M3 = M4 = 1; and when SMTC > 40 ms, M2 = 1.5, M3 = M4 = 2
Note 2:
When highSpeedMeasFlag-r16 is configured, the requirements apply only to UE supporting either measurementEnhancement-r16 or intraNR-MeasurementEnhancement-r16.

TABLE 3-3
T_{detect, NR}_{_{—}}_{Intra,} T_{measure, NR}_{_{—}}_{Intra} and T_{evaluate, NR}_{_{—}}_{Intra}
for UE configured with highSpeedMeasFlagFR2-r17
(Frequency range FR2)

| DRX | | | | |
|---|---|---|---|---|
| cycle | Scaling | T_{detect, NR}_{_{—}}_{Intra} | T_{measure, NR}_{_{—}}_{Intra} | T_{evaluate, NR}_{_{—}}_{Intra} |
| length | Factor | [s] (number of | [s] (number of | [s] (number of |
| [s] | (N1) | DRX cycles) | DRX cycles) | DRX cycles) |
| 0.32 | N2^{Note2} | 2.56 × N1 × M2 | 0.32 × N1 × M3 | 0.96 × N1 × M4 |
| | | (8 × N1 × M2) | (1 × N1 × M3) | (3 × N1 × M4) |
| 0.64 | 5 | 17.92 × N1 | 1.28 × N1 | 5.12 × N1 |
| | | (28 × N1) | (2 × N1) | (8 × N1) |
| 1.28 | 4 | 32 × N1 | 1.28 × N1 | 6.4 × N1 |
| | | (25 × N1) | (1 × N1) | (5 × N1) |
| 2.56 | 3 | 58.88 × N1 | 2.56 × N1 | 7.68 × N1 |
| | | (23 × N1) | (1 × N1) | (3 × N1) |

Note 1:
When SMTC <= 40 ms, M2 = M3 = M4 = 1; and when SMTC > 40 ms, M2 = 1.5, M3 = M4 = 2
^{Note2}:
N2 = 2 when [highSpeedMeasFlagFR2-r17] = [set1]; N2 = 6 when [highSpeedMeasFlagFR2-r17] = [set2].

TABLE 3-4
T_{detect, NR}_Intra, T_{measure, NR}_Intra and T_{evaluate, NR}_Intra for UE configured with eDRX_IDLE cycle (Frequency
range FR1)

| | | PTW | | | |
|---|---|---|---|---|---|
| | | length | | | |
| | DRX | [s] | | T_{measure, NR}_Intra [s] | T_{evaluate, NR}_Intra [s] |
| eDRX_IDLE | cycle | (number | | (number of DRX | (number of DRX |
| cycle | length | of 1.28 s | T_{detect, NR}_Intra [s] (number of DRX | cycles or eDRX | cycles or eDRX |
| length [s] | [s] | periods) | cycles or eDRX cycles ^{Note 3}) | cycles ^{Note 3}) | cycles ^{Note 3}) |
| 2.56 | — | — | 58.88 (23) | 2.56 (1) | 7.68 (3) |
| 5.12 | — | — | 117.76 (23) | 5.12 (1) | 10.24 (2) |
| 10.24 | — | — | 235.52 (23) | 10.24 (1) | 20.48 (2) |
| 20.48 ≤ eDRX_IDLE | 0.32 | ≥[1.28] ([1]) | $eDRX\_cycle \_length \times ⌈ \frac{23}{PTW / DRX\_cycle \_length} ⌉ ( 23 )$ | 0.32 × M2 (1 × M2) | 0.64 × M2 (2 × M2) |
| cycle length | 0.64 | ≥[1.28] | | 0.64 (1) | 1.28 (2) |
| ≤ 10485.76 | | ([1]) | | | |
| | 1.28 | ≥[2.56] | | 1.28 (1) | 2.56 (2) |
| | | ([2]) | | | |
| | 2.56 | ≥[5.12] | | 2.56 (1) | 5.12 (2) |
| | | ([4]) | | | |

^{Note 1}:
The number of DRX cycles in this table is given for the DRX cycles within PTWs.
^{Note 2}:
The eDRX_IDLE cycle lengths are as specified in Section 10.5.5.32 of TS 24.008 [34].
^{Note 3}:
Number of eDRX cycles when eDRX_IDLE cycle length equals 2.56 s, 5.12 s and 10.24 s. Otherwise, number of DRX cycles.
^{Note 4}:
$The lower bound of PTW length is derived based on ⌈ \frac{Tevaluate , NR\_Intra * DRX\_cycle}{1.28} ⌉ * 1.28 .$ ^{Note 5}:
M2 = 2 if SMTC periodicity of measured intra-frequency cell > 20 ms; otherwise M2 = 1.

TABLE 3-5
T_{detect, NR}_Intra, T_{measure, NR}_Intra and T_{evaluate, NR}_Intra for UE configured with eDRX_IDLE cycle (Frequency
range FR2)

| | | PTW | | | | |
|---|---|---|---|---|---|---|
| | | length | | | | |
| eDRX_IDLE | DRX | [s] | Scaling | T_{detect, NR}_Intra [s] | T_{measure, NR}_Intra [s] | T_{evaluate, NR}_Intra [s] |
| cycle | cycle | (number | Factor | (number of DRX | (number of DRX | (number of DRX |
| length | length | of 1.28 s | (N1) | cycles or eDRX | cycles or eDRX | cycles or eDRX |
| [s] | [s] | periods) | ^{Note1} | cycles ^{Note 4}) | cycles ^{Note 4}) | cycles ^{Note 4}) |
| 2.56 | — | — | 3 | 58.88 × N1 (23 × N1) | 2.56 × N1 (1 × N1) | 7.68 × N1 (3 × N1) |
| 5.12 | — | — | 3 | 117.76 × N1 (23 × N1) | 5.12 × N1 (1 × N1) | 10.24 × N1 (2 × N1) |
| 10.24 | — | — | 3 | 235.52 × N1 (23 × N1) | 10.24 × N1 (1 × N1) | 20.48 × N1 (2 × N1) |
| 20.48 ≤ eDRX_ | 0.32 | ≥5.12 (4) | 8 | $eDRX\_cycle \_ \text{?} \times ⌈ \frac{23 \times \text{?}}{PTW / DRX\_ \text{?}} \text{?} ( 23 \times N 1 )$ | 0.32 × N1 (1 × N1) | 0.64 × N1 (2 × N1) |
| IDLE cycle | 0.64 | ≥6.4 (5) | 5 | | 0.64 × N1 (1 × N1) | 1.28 × N1 (2 × N1) |
| length | 1.28 | ≥10.24 | 4 | | | |
| ≤10485.76 | | (8) | | | 1.28 × N1 (1 × N1) | 2.56 × N1 (2 × N1) |
| | 2.56 | ≥15.36 | 3 | | | |
| | | (12) | | | | |

^{NOTE1}:
Applies for UE supporting FR2-1 power class 2 & 3 & 4. For UE supporting FR2-1 power class 1 or 5, N1 = 8 for all DRX cycle length.
^{NOTE 2}:
The number of DRX cycles in this table is given for the DRX cycles within PTWs.
^{NOTE 3}:
The eDRX_IDLE cycle lengths are as specified in Section 10.5.5.32 of TS 24.008 [34].
^{NOTE 4}:
Number of eDRX cycles when eDRX_IDLE cycle length equals 2.56 s, 5.12 s and 10.24 s. Otherwise, number of DRX cycles.
^{NOTE 5}:
$The lower bound of PTW length is derived based on ⌈ \frac{Tevaluate , NR\_Intra * DRX\_cycle}{1.28} ⌉ * 1.28 .$ ^{NOTE 6}:
When eDRX = 20.48 s and DRX = 0.32 s, UE is allowed to perform cell evaluation within PTW in every 2 eDRX cycles.

A wireless device may be able to identify one or more inter-frequency cells and perform SS-RSRP or SS-RSRQ measurements of the identified one or more inter-frequency cells if carrier frequency information is provided by the serving cell of the wireless device, even if no explicit neighbor list with physical layer cell identities is provided.

If Srxlev>SnonIntraSearchP and Squal>SnonIntraSearchQ then the wireless device may search for inter-frequency layers of higher priority at least every Thigher_priority_search.

If Srxlev≤SnonIntraSearchP or Squal≤SnonIntraSearchQ then the wireless device may search for and measure inter-frequency layers of higher, equal or lower priority, than a priority of the serving frequency of the wireless device, in preparation for possible reselection.

The wireless device may be able to evaluate whether a detectable inter-frequency cell meets the reselection criteria, for cell reselection, within Kcarrier*Tdetect,NR_Inter+Kcarrier_HST*Tdetect,NR_Inter_HST if at least carrier frequency information is provided for inter-frequency neighbor cells by the serving cells when Treselection=0 provided that the reselection criteria is met by a margin of at least 5 dB in FR1 or 6.5 dB in FR2 for reselections based on ranking or 6 dB in FR1 or 7.5 dB in FR2 for SS-RSRP reselections based on absolute priorities or 4 dB in FR1 and 4 dB in FR2 for SS-RSRQ reselections based on absolute priorities.

Kcarrier may be a number of NR inter-frequency carriers which are not configured with highSpeedMeasInterFreq-r17 for FR1 indicated by the serving cell.

Kcarrier_HST may be a number of NR inter-frequency carriers which are configured with highSpeedMeasInterFreq-r17 for FR1 indicated by the serving cell.

Kcarrier for a UE configured with idle mode CA measurements (while T331 is running), is a combined number of NR inter-frequency carriers indicated by the serving cell and the number of NR inter-frequency carriers configured for idle mode CA measurements which are not configured with highSpeedMeasInterFreq-r17 for FR1.

Kcarrier_HST for a wireless device configured with idle mode CA measurements (while T331 is running), is the combined number of NR inter-frequency carriers indicated by the serving cell and the number of NR inter-frequency carriers configured for idle mode CA measurements which are configured with highSpeedMeasInterFreq-r17 for FR1.

An inter-frequency cell may be considered to be detectable based on the conditions defined in Table 4 or Table 5 for a corresponding Band.

TABLE 4
Conditions for inter-frequency cell re-selection in FR1

| | | Minimum SSB_RP | | |
|---|---|---|---|---|
| | | dBm/SCS_{SSB} | | SSB |
| | NR operating band | SCS_{SSB} = | SCS_{SSB} = | Ês/lot |
| Parameter | groups ^{Note1} | 15 kHz | 30 kHz | dB |
| Conditions | NR_FDD_FR1_A, | −124 | −121 | ≥−4 |
| | NR_TDD_FR1_A | | | |
| | NR_FDD_FR1_B | −123.5 | −120.5 | |
| | NR_TDD_FR1_C | −123 | −120 | |
| | NR_FDD_FR1_D, | −122.5 | −119.5 | |
| | NR_TDD_FR1_D | | | |
| | NR_FDD_FR1_E, | −122 | −119 | |
| | NR_TDD_FR1_E | | | |
| | NR_FDD_FR1_F | −121.5 | −118.5 | |
| | NR_FDD_FR1_G, | −121 | −118 | |
| | NR_TDD_FR1_G | | | |
| | NR_FDD_FR1_H | −120.5 | −117.5 | |

^{Note1} :
NR operating band groups are defined in clause 3.5.2.

TABLE 5
Conditions for inter-frequency cell re-selection in FR2

| | | | Minimum SSB_RP ^{Note 2, Note 3} | | | | | | |
|---|---|---|---|---|---|---|---|---|---|
| | | | dBm / SCS_{SSB} | | | | | | |
| | | | | | | | | SCS_{SSB} = | |
| | | NR | SCS_{SSB} = 120 kHz | | | | | 240 kHz | SSB |
| | Angle of | operating | UE Power class | | | | | UE Power class | Ês/Iot |
| Parameter | arrival | bands | 1 | 2 | 3 | 4 | 5 | 1, 2, 3, 4, 5 | dB |
| Conditions | Rx Beam | n257 | −125.3 + Y₁ | −110.8 | −109.1 | −124.8 + Y₄ | −120.4 + Y₅ | (Value for | ≥−4 |
| | Peak | n258 | −125.3 + Y₁ | −110.8 | −109.1 | −124.8 + Y₄ | −120.6 + Y₅ | SCS_{SSB} = | |
| | | n259 | | | −105.5 | | −117.5 + Y₅ | 120 kHz) + | |
| | | n260 | −122.3 + Y₁ | | −106.5 | −122.8 + Y₄ | | 3 dB | |
| | | n261 | −125.3 + Y₁ | −110.8 | −109.1 | −124.8 + Y₄ | | | |
| | | n262 | −120.3 + Y₁ | −105.6 | −103.6 | −118.8 + Y₄ | | | |
| | Spherical | n257 | −117.3 + Z₁ | −99.8 | −98.2 | −115.8 + Z₄ | −112.4 + Z₅ | (Value for | ≥−4 |
| | coverage | n259 | | | −92.7 | | | SCS_{SSB} = | |
| | ^{Note 1} | n258 | −117.3 + Z₁ | −99.8 | −98.2 | −115.8 + Z₄ | −112.6 + Z₅ | 120 kHz) + | |
| | | n260 | −114.3 + Z₁ | | −93.9 | −110.8 + Z₄ | | 3 dB | |
| | | n261 | −117.3 + Z₁ | −99.8 | −98.2 | −115.8 + Z₄ | | | |
| | | n262 | −112.1 + Z₁ | −93.7 | −90.5 | −106.7 + Z₄ | | | |

^{NOTE 1}
Values based on EIS spherical coverage as defined in clause 7.3.4 of TS 38.101-2 [19]. Side condition applies for directions in which EIS spherical coverage requirement is met.
^{NOTE 2}
Values specified at the Reference point to give minimum SSB Ês/Iot, with no applied noise.
^{NOTE 3}
For UEs that support multiple FR2 bands, Rx Beam Peak values are increased by ΔMB_{P, n} and Spherical coverage values are increased by ΔMB_{S, n}, the UE multi-band relaxation factor in dB specified in clause 6.2.1 of TS 38. 101-2 [19].

When one or more higher priority cells are found based on a higher priority search by the wireless device, the one or more higher priority cells may be measured at least every Tmeasure,NR_Inter. If, after detecting a cell based on a higher priority search, it is determined that reselection has not occurred then the wireless device is not required to continuously measure the detected cell to evaluate the ongoing possibility of reselection. If the wireless device detects on a NR carrier a cell whose physical identity is indicated as not allowed for that carrier in the measurement control system information of the serving cell, the wireless device is not required to perform measurements on the cell.

The wireless device not configured with eDRX_IDLE cycle may measure SS-RSRP or SS-RSRQ at least every Kcarrier*Tmeasure,NR_Inter+Kcarrier_HST*Tmeasure,NR_Inter_HST, based on Table 6-1 and Table 6-2 if the wireless device declares support of idle mode inter-frequency measurement enhancement when configured with highSpeedMeasInterFreq-r17 for FR1, otherwise based on Table 6-1 only, for identified one or more lower or equal priority, than a priority of the serving frequency of the wireless device, inter-frequency cells. If the wireless device detects on a NR carrier a cell whose physical identity is indicated as not allowed for that carrier in the measurement control system information of the serving cell, the wireless device is not required to perform measurements on the cell.

The wireless device not configured with eDRX_IDLE cycle may filter SS-RSRP or SS-RSRQ measurements of each measured higher, lower and equal priority, than a priority of serving frequency of the wireless device, inter-frequency cell using at least 2 measurements. Within the set of measurements used for the filtering, at least two measurements may be spaced by at least Tmeasure,NR_Inter/2 for carriers which are not configured with highSpeedMeasInterFreq-r17 for FR1 or Tmeasure,NR_Inter_HST/2 for carriers which are configured with highSpeedMeasInterFreq-r17 for FR1.

The wireless device configured with eDRX_IDLE cycle may measure SS-RSRP or SS-RSRQ at least every Kcarrier*Tmeasure,NR_Inter, based on Table 6-3 and Table 6-4, for identified lower or equal priority, than a priority of the serving frequency of the wireless device, inter-frequency cells. If the wireless device detects on a NR carrier a cell whose physical identity is indicated as not allowed for that carrier in the measurement control system information of the serving cell, the UE is not required to perform measurements on the cell.

The wireless device is configured with eDRX_IDLE cycle may filter SS-RSRP or SS-RSRQ measurements of each measured higher, lower and equal priority, than a priority of the serving frequency of the wireless device, inter-frequency cell using at least 2 measurements. Within the set of measurements used for the filtering, at least two measurements may be spaced by at least Tmeasure,NR_Inter/2.

The wireless device may not consider a NR neighbor cell in cell reselection if it is indicated as not allowed in the measurement control system information of the serving cell.

For an inter-frequency cell that has been already detected, but that has not been reselected to, the filtering may be such that the wireless device is not configured with eDRX_IDLE cycle may be capable of evaluating that the inter-frequency cell has met reselection criterion, for cell reselection, within Kcarrier*Tevaluate,NR_Inter+Kcarrier_HST*Tevaluate,NR_Inter_HST when Treselection=0 as specified in Table 6-1 and Table 6-2 if the wireless device declares support of idle mode inter-frequency measurement enhancement when configured with highSpeedMeasInterFreq-r17 for FR1, otherwise based on Table 6-1 only, provided that the reselection criteria is met based on: the condition when performing equal priority reselection; and when rangeToBestCell is not configured, the cell is at least 5 dB better ranked in FR1 or 6.5 dB better ranked in FR2; or when rangeToBestCell is configured, the cell has the highest number of beams above the threshold absThreshSS-BlocksConsolidation among all detected cells whose cell-ranking criterion R value is within rangeToBestCell of the cell-ranking criterion R value of the highest ranked cell. If there are multiple cells whose cell-ranking criterion R value is within rangeToBestCell of the cell-ranking criterion R value of the highest ranked cell, the cell has the highest rank among the multiple cells. The cell is at least 5 dB better ranked in FR1 or 6.5 dB better ranked in FR2 if the current serving cell is among them.

For an inter-frequency cell that has been already detected, but that has not been reselected to, the filtering may be such that the wireless device is configured with eDRX_IDLE cycle may be capable of evaluating that the inter-frequency cell has met reselection criterion, for cell reselection, within Kcarrier*Tevaluate,NR_Inter when Treselection=0 based on Table 6-3 and Table 6-4, provided that the reselection criteria is met based on: the condition when performing equal priority reselection; and when rangeToBestCell is not configured, the cell is at least 5 dB better ranked in FR1 or 6.5 dB better ranked in FR2; or when rangeToBestCell is configured, the cell has the highest number of beams above the threshold absThreshSS-BlocksConsolidation among all detected cells whose cell-ranking criterion R value is within rangeToBestCell of the cell-ranking criterion R value of the highest ranked cell. If there are multiple cells whose cell-ranking criterion R value is within rangeToBestCell of the cell-ranking criterion R value of the highest ranked cell, the cell has the highest rank among them. The cell is at least 5 dB better ranked in FR1 or 6.5 dB better ranked in FR2 if the current serving cell is among them.

When evaluating cells for reselection, the SSB side conditions may apply to both serving and inter-frequency cells.

If a Treselection timer has a nonzero value and the inter-frequency cell is satisfied with the reselection criteria, the wireless device may evaluate the inter-frequency cell for the Treselection time. If the cell remains satisfied with the reselection criteria within this duration, then the wireless device may reselect the cell.

The wireless device is not expected to meet the measurement requirements for an inter-frequency carrier under DRX cycle=320 ms defined in Table 6-1 and Table 6-2 based on: TSMTC_intra=TSMTC_inter=160 ms. TSMTC_intra may be a periodicity of the SMTC configured for the intra-frequency carrier if no identified intra-frequency cell is in the PCI list of smtc2-LP on this intra-frequency carrier. TSMTC_intra is a periodicity of the smtc2-LP configured for the intra-frequency carrier if at least one identified intra-frequency cell is in the PCI list of smtc2-LP on this intra-frequency carrier. During a PSS/SSS detection, the periodicity of the SMTC configured for the intra-frequency carrier is assumed for TSMTC_intra. If the actual SSB transmission periodicity is greater than the SMTC configured for the intra-frequency carrier, longer Tdetect,NR_intra is expected. TSMTC_inter is an actual SMTC periodicity used by the inter-frequency cell being identified. During a PSS/SSS detection, the periodicity of the SMTC configured for the inter-frequency carrier is assumed for TSMTC_inter. If the actual SSB transmission periodicity is greater than the SMTC configured for the inter-frequency carrier, longer Tdetect,NR_inter is expected; SMTC occasions configured for the inter-frequency carrier occur up to 1 ms before the start or up to 1 ms after the end of the SMTC occasions configured for the intra-frequency carrier, and SMTC occasions configured for the intra-frequency carrier and for the inter-frequency carrier occur up to 1 ms before the start or up to 1 ms after the end of a paging occasion.

For the wireless device not configured with eDRX_IDLE cycle, values of Tdetect,NR_Inter, Tmeasure,NR_Inter and Tevaluate,NR_Inter are based on Table 6-1 and Table 6-2.

For the wireless device configured with eDRX_IDLE cycle, values of Tdetect,NR_Inter, Tmeasure,NR_Inter and Tevaluate,NR_Inter are based on Table 6-3 and Table 6-4 for FR1 and FR2, respectively. The requirements may apply provided that the serving cell is configured with eDRX_IDLE and is the same in all PTWs during any of Tdetect,NR_Inter, Tmeasure,NR_Inter and Tevaluate,NR_Inter when multiple PTWs are used.

TABLE 6-1
T_{detect, NR}_{_{—}}_{Inter,} T_{measure, NR}_{_{—}}_{Inter} and T_{evaluate, NR}_{_{—}}_{Inter}

| DRX | | | | T_{detect, NR}_{_{—}}_{Inter} | T_{measure, NR}_{_{—}}_{Inter} | T_{evaluate, NR}_{_{—}}_{Inter} |
|---|---|---|---|---|---|---|
| cycle | | | | [s] (number | [s] (number | [s] (number |
| length | Scaling Factor (N1) | | | of DRX | of DRX | of DRX |
| [s] | FR1 | FR2-1^{Note1} | FR2-2 ^{Note2} | cycles) | cycles) | cycles) |
| 0.32 | 1 | 8 | 12 | 11.52 × N1 × | 1.28 × N1 × | 5.12 × N1 × |
| | | | | 1.5 (36 × | 1.5 (4 × | 1.5 (16 × |
| | | | | N1 × 1.5) | N1 × 1.5) | N1 × 1.5) |
| 0.64 | | 5 | 8 | 17.92 × N1 | 1.28 × N1 | 5.12 × N1 |
| | | | | (28 × N1) | (2 × N1) | (8 × N1) |
| 1.28 | | 4 | 6 | 32 × N1 | 1.28 × N1 | 6.4 × N1 |
| | | | | (25 × N1) | (1 × N1) | (5 × N1) |
| 2.56 | | 3 | 5 | 58.88 × N1 | 2.56 × N1 | 7.68 × N1 |
| | | | | (23 × N1) | (1 × N1) | (3 × N1) |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.

TABLE 6-2
T_{detect, NR}_{_{—}}_{Inter}_{_{—}}_{HST,} T_{measure, NR}_{_{—}}_{Inter}_{_{—}}_{HST}
and T_{evaluate, NR}_{_{—}}_{Inter}_{_{—}}_{HST} for FR1 configured with highSpeedMeasInterFreq-r17 ^{note2}

| | T_{detect, NR}_{_{—}}_{Inter}_{_{—}}_{HST} | | T_{measure, NR}_{_{—}}_{Inter}_{_{—}}_{HST} | | T_{evaluate, NR}_{_{—}}_{Inter}_{_{—}}_{HST} |
|---|---|---|---|---|---|
| DRX cycle | [s] (number of | | [s] (number of | | [s] (number of |
| length [s] | DRX cycles) | | DRX cycles) | | DRX cycles) |
| 0.32 | [3.2 × M2 | | [0.32 × M3 | | 0.96 × M4 |
| | (10 × M2)] ^{Note 1} | | ([1] × M3)] ^{Note 1} | | (3 × M4) ^{Note 1} |
| 0.64 | [6.4 | (10)] | [0.64 | (1)] | 1.92 (3) |
| 1.28 | [10.24 | (8)] | 1.28 | (1) | 3.84 (3) |
| 2.56 | 58.88 | (23) | 2.56 | (1) | 7.68 (3) |

^{Note 1} :
When SMTC <= 40 ms, M2 = M3 = M4 = 1; and when SMTC > 40 ms, M2 = 1.5, M3 = M4 = 2
^{note2} :
The support of HST Idle mode inter-frequency measurement enhancement is optional without capability signalling.
Apply for UE declaring (indicating) supports of idle mode inter-frequency measurement enhancement for HST, otherwise Table 4.2.2.4-1 may be used.

TABLE 6-3
T_{detect, NR}_Inter, T_{measure, NR}_Inter and T_{evaluate, NR}_Inter for UE configured with eDRX_IDLE cycle
(Frequency range FR1)

| | | | | T_{measure,} | T_{evaluate,} |
|---|---|---|---|---|---|
| | | | | _{NR}_Inter [s] | _{NR}_Inter [s] |
| | | | | (number | (number |
| | | PTW | | of DRX | of DRX |
| eDRX_ | | length | | cycles | cycles |
| IDLE | DRX | [s] | | or | or |
| cycle | cycle | (number | | eDRX | eDRX |
| length | length | of 1.28 s | T_{detect, NR}_Inter [s] (number of DRX | cycles | cycles |
| [s] | [s] | periods) | cycles or eDRX cycles ^{Note 3}) | ^{Note 3}) | ^{Note 3}) |
| 2.56 | — | — | 58.88 (23) | 2.56 (1) | 7.68 (3) |
| 5.12 | — | — | 117.76 (23) | 5.12 (1) | 10.24 |
| | | | | | (2) |
| 10.24 | — | — | 235.52 (23) | 10.24 | 20.48 |
| | | | | (1) | (2) |
| 20.48 ≤ eDRX_ | 0.32 | ≥1.28 (1) | $eDRX\_cycle \_length \times ⌈ \frac{23}{PTW / DRX\_cycle \_length} ⌉ ( 23 )$ | 0.32 × 1.5 (1 × 1.5) | 0.64 × 1.5 (2 × 1.5) |
| IDLE | 0.64 | ≥1.28 | | 0.64 (1) | 1.28 (2) |
| cycle | | (1) | | | |
| length ≤ | 1.28 | ≥2.56 | | 1.28 (1) | 2.56 (2) |
| 10485.76 | | (2) | | | |
| | 2.56 | ≥5.12 | | 2.56 (1) | 5.12 (2) |
| | | (4) | | | |

^{NOTE 1}:
The number of DRX cycles in this table is given for the DRX cycles within PTWs.
^{NOTE 2}:
The eDRX_IDLE cycle lengths are as specified in Section 10.5.5.32 of TS 24.008 [34].
^{NOTE 3}:
Number of eDRX cycles when eDRX_IDLE cycle length equals 2.56 s, 5.12 s and 10.24 s. Otherwise, number of DRX cycles.
^{NOTE 4}:
$The lower bound of PTW length is derived based on ⌈ \frac{Tevaluate , NR\_Inter * DRX\_cycle}{1.28} ⌉ * 1.28 .$

TABLE 6-4
T_{detect, NR}_Inter, T_{measure, NR}_Inter and T_{evaluate, NR}_Inter for UE configured with eDRX_IDLE cycle (Frequency
range FR2)

| | | PTW | | | T_{measure, NR}_Inter | T_{evaluate, NR}_Inter |
|---|---|---|---|---|---|---|
| | | length | | | [s] | [s] |
| eDRX_ | DRX | [s] | | | (number of | (number of |
| IDL | cycle | (number | Scaling | T_{detect, NR}_Inter [s] | DRX cycles | DRX cycles |
| E cycle | length | of 1.28 s | Factor | (number of DRX cycles | or eDRX | or eDRX |
| length [s] | [s] | periods) | (N1) ^{Note1} | or eDRX cycles ^{Note 3}) | cycles ^{Note 3}) | cycles ^{Note 3}) |
| 2.56 | — | — | 3 | 58.88 × N1 (23 × N1) | 2.56 × N1 | 7.68 × N1 |
| | | | | | (1 × N1) | (3 × N1) |
| 5.12 | — | — | 3 | 117.76 × N1 (23 × N1) | 5.12 × N1 | 10.24 × N1 |
| | | | | | (1 × N1) | (2 × N1) |
| 10.24 | — | — | 3 | 235.52 × N1 (23 × N1) | 10.24 × N1 | 20.48 × N1 |
| | | | | | (1 × N1) | (2 × N1) |
| 20.48 ≤ eDRX_ DLE cycle length ≤10485.76 | 0.32 0.64 1.28 2.56 | ≥5.12 (4) ≥6.4 (5) ≥10.24 (8) ≥15.36 (12) | 8 5 4 3 | $eDRX\_cycle \_length \times ⌈ \frac{23 \times N 1}{PTW / DRX\_cycle \_ \text{?}} \text{?} ( 23 \times N 1 )$ | 0.32 × N1 (1 × N1) 0.64 × N1 (1 × N1) 1.28 × N1 (1 × N1) 2.56 × N1 (1 × N1) | 0.64 × N1 (2 × N1) 1.28 × N1 (2 × N1) 2.56 × N1 (2 × N1) 5.12 × N1 (2 × N1) |

^{NOTE1}:
Applies for UE supporting FR2-1 power class 2 & 3 & 4. For UE supporting FR2-1 power class 1 or 5, N1 = 8 for all DRX cycle length.
^{NOTE 3}:
The number of DRX cycles in this table is given for the DRX cycles within PTWs.
^{NOTE 3}:
The eDRX_IDLE cycle lengths are as specified in Section 10.5.5.32 of TS 24.008 [34].
^{NOTE 4}:
Number of eDRX cycles when eDRX_IDLE cycle length equals 2.56 s, 5.12 s and 10.2 4 s. Otherwise, number of DRX cycles.
^{NOTE 5}:
The lower bound of PTW length is derived based on
$The lower bound of PTW length is derived based on ⌈ \frac{Tevaluate , NR\_Inter * DRX\_cycle}{1.28} ⌉ * 1.28 .$ ^{NOTE 6}:
When eDRX = 20.48 s and DRX = 0.32 s, UE is allowed to perform cell evaluation within PTW in every 2 eDRX cycles.

When a wireless device is configured with a lowMobilityEvaluation criterion and the wireless device has fulfilled the criterion; or the wireless device is configured with both the lowMobilityEvaluation criterion and a cellEdgeEvaluation criterion and combineRelaxedMeasCondition not configured, and the wireless device has fulfilled only the lowMobilityEvaluation criterion, the wireless device may perform relaxed measurement based on the low mobility criterion being fulfilled. Values of Tdetect,NR_Intra, Tmeasure,NR_Intra, and Tevaluate,NR_Intra are based on Table 7-1, Table 7-2, Table 7-3, Table 7-4, or Table 7-5. If the wireless device is configured with eDRX_IDLE cycle then the requirements in Table 7-2 and Table 7-3 are applicable for eDRX cycle up to 10.24 s in FR1 and FR2, respectively. If the wireless device is configured with eDRX_IDLE cycle greater than 10.24 s in FR1 and FR2, then the requirements in Table 7-4 and Table 7-5 respectively may apply provided eDRX cycle is ≤[163.84] sec and evaluation/measurement time with relaxation on one carrier is not greater than single PTW window length.

TABLE 7-1
T_{detect, NR}_{_{—}}_{Intra,} T_{measure, NR}_{_{—}}_{Intra} and T_{evaluate, NR}_{_{—}}_{Intra}

| DRX | | | | T_{detect, NR}_{_{—}}_{Intra} | T_{measure, NR}_{_{—}}_{Intra} | T_{evaluate, NR}_{_{—}}_{Intra} |
|---|---|---|---|---|---|---|
| cycle | | | | [s] (number | [s] (number | [s] (number |
| length | Scaling Factor (N1) | | | of DRX | of DRX | of DRX |
| [s] | FR1 | FR2-1^{Note1} | FR2-2 ^{Note2} | cycles) | cycles) | cycles) |
| 0.32 | 1 | 8 | 12 | 11.52 × N1 × | 1.28 × N1 × | 5.12 × N1 × |
| | | | | M2 × K1 | M2 × K1 | M2 × K1 |
| | | | | (36 × N1 × | (4 × N1 × | (16 × N1 × |
| | | | | M2 × K1) | M2 × K1) | M2 × K1) |
| 0.64 | | 5 | 8 | 17.92 × N1 × | 1.28 × N1 × | 5.12 × N1 × |
| | | | | K1 (28 × | K1 (2 × | K1 (8 × |
| | | | | N1 × K1) | N1 × K1) | N1 × K1) |
| 1.28 | | 4 | 6 | 32 × N1 × | 1.28 × N1 × | 6.4 × N1 × |
| | | | | K1 (25 × | K1 (1 × | K1 (5 × |
| | | | | N1 × K1) | N1 × K1) | N1 × K1) |
| 2.56 | | 3 | 5 | 58.88 × N1 × | 2.56 × N1 × | 7.68 × N1 × |
| | | | | K1 (23 × | K1 (1 × | K1 (3 × |
| | | | | N1 × K1) | N1 × K1) | N1 × K1) |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.
Note 3:
M2 = 1.5 if SMTC periodicity of measured intra-frequency cell > 20 ms; otherwise M2 = 1. If high layer signalling smtc2-LP-r16 is configured, for cells indicated in the pci-List parameter in smtc2-LP-r16, the SMTC periodicity corresponds to the value of higher layer parameter smtc2-LP-r16; for the other cells, the SMTC periodicity corresponds to the value of higher layer parameter smtc.
Note 4:
K1 = 3 is the measurement relaxation factor applicable for UE fulfilling the lowMobilityEvaluation [2] criterion.

TABLE 7-2
T_{detect, NR}_{_{—}}_{Intra}_{_{—}}_{Relax}, T_{measure, NR}_{_{—}}_{Intra}_{_{—}}_{Relax} and
T_{evaluate, NR}_{_{—}}_{Intra}_{_{—}}_{Relax} for UE configured with eDRX_IDLE
cycle (Frequency range FR1) for eDRX_IDLE cycle up to 10.24 s

| DRX_IDLE | T_{detect, NR}_{_{—}}_{Intra}_{_{—}}_{Relax} | T_{measure, NR}_{_{—}}_{Intra}_{_{—}}_{Relax} | T_{evaluate, NR}_{_{—}}_{Intra}_{_{—}}_{Relax} |
|---|---|---|---|
| cycle | [s] (number of | [s] (number of | [s] (number of |
| length | eDRX IDLE | eDRX IDLE | eDRX IDLE |
| [s] | cycles) | cycles) | cycles) |
| 2.56 | 58.88 × K1 | 2.56 × K1 | 7.68 × K1 |
| | (23 × K1) | (1 × K1) | (3 × K1) |
| 5.12 | 117.76 × K1 | 5.12 × K1 | 10.24 × K1 |
| | (23 × K1) | (1 × K1) | (2 × K1) |
| 10.24 | 235.52 × K1 | 10.24 × K1 | 20.48 × K1 |
| | (23 × K1) | (1 × K1) | (2 × K1) |

Note 1:
Applies for UE of all supporting FR1 power classes.
Note 2:
K1 = 3 is the measurement relaxation factor applicable for UE fulfilling the lowMobilityEvaluation [2] criterion.

TABLE 7-3
T_{detect, NR}_{_{—}}_{Intra}_{_{—}}_{Relax}, T_{measure, NR}_{_{—}}_{Intra}_{_{—}}_{Relax} and
T_{evaluate, NR}_{_{—}}_{Intra}_{_{—}}_{Relax} for UE configured with eDRX_IDLE
cycle (Frequency range FR2-1) for eDRX_IDLE cycle up to 10.24 s

| DRX_IDLE | T_{detect, NR}_{_{—}}_{Intra}_{_{—}}_{Relax} | T_{measure, NR}_{_{—}}_{Intra}_{_{—}}_{Relax} | T_{evaluate, NR}_{_{—}}_{Intra}_{_{—}}_{Relax} |
|---|---|---|---|
| cycle | [s] (number of | [s] (number of | [s] (number of |
| length | eDRX IDLE | eDRX IDLE | eDRX IDLE |
| [s] | cycles) | cycles) | cycles) |
| 2.56 | 58.88 × N1 × | 2.56 × N1 × | 7.68 × N1 × |
| | K1 (23 × | K1 (1 × | K1 (3 × |
| | N1 × K1 | N1 × K1 | N1 × K1) |
| 5.12 | 117.76 × N1 × | 5.12 × N1 × | 10.24 × N1 × |
| | K1 (23 × | K1 (1 × | K1 (2 × |
| | N1 × K1) | N1 × K1) | N1 × K1) |
| 10.24 | 235.52 × N1 × | 10.24 × N1 × | 20.48 × N1 × |
| | K1 (23 × | K1 (1 × | K1 (2 × |
| | N1 × K1) | N1 × K1) | N1 × K1) |

Note 1:
Applies for UE supporting FR2-1 power class 2&3&4. For UE supporting FR2-1 power class 1 or 5, N1 = 8 for all DRX cycle length.
Note 2:
N1 = 3.
Note 3:
K1 = 3 is the measurement relaxation factor applicable for UE fulfilling the lowMobilityEvaluation [2] criterion.

TABLE 7-4
T_{detect, NR}_Intra_Relax, T_{measure, NR}_Intra__{Relax} and T_{evaluate, NR}_Intra__{Relax} for UE configured with eDRX_IDLE cycle
(Frequency range FR1)

| | | PTW | | | |
|---|---|---|---|---|---|
| | | length | | | |
| | | [s] | | T_{measure, NR}_Intra__{Relax} | T_{evaluate, NR}_Intra_Relax |
| | DRX | (number | | [s] (number of | [s] (number of |
| eDRX_IDLE | cycle | of | | DRX cycles or | DRX cycles or |
| cycle | length | 1.28 s | T_{detect, NR}_Intra_Relax [s] (number of | eDRX cycles | eDRX cycles |
| length [s] | [s] | periods) | DRX cycles or eDRX cycles ^{Note 3}) | ^{Note 3}) | ^{Note 3}) |
| 20.48 ≤ eDRX_IDLE | 0.32 | ≥[3.84] ([3]) | $eDRX\_cycle \_length \times ⌈ \frac{23}{PTW / DRX\_cycle \_length} ⌉ \times K 1 ( 23 \times K 1 )$ | 0.32 × M2 × K1 (1 × M2 × K1) | 0.64 × M2 × K1 (2 × M2 × K1) |
| cycle | 0.64 | ≥[3.84] | | 0.64 × K1 (1 × K1) | 1.28 × K1 (2 × K1) |
| length | | ([3]) | | | |
| ≤[163.84] | 1.28 | ≥[7.68] | | 1.28 × K1 (1 × K1) | 2.56 × K1 (2 × K1) |
| | | ([6] | | | |
| | 2.56 | ≥[15.36] | | 2.56 × K1 (1 × K1) | 5.12 × K1 (2 × K1) |
| | | ([12]) | | | |

^{Note 1}:
The number of DRX cycles in this table is given for the DRX cycles within PTWs.
^{Note 2}:
The eDRX_IDLE cycle lengths are as specified in Section 10.5.5.32 of TS 24.008 [34].
^{Note 3}:
$The lower bound of PTW length is serived based on ⌈ \frac{Tevaluate , NR\_Intra * DRX\_cycle}{1.28} ⌉ * 1.28 .$ ^{Note 4}:
M2 = 1.5 if SMTC periodicity of measured intra-frequency cell > 20 ms; otherwise M2 = 1.
^{Note 5}:
K1 = 3 is the measurement relaxation factor applicable for UE fulfilling the lowMobilityEvaluation [2] criterion.

TABLE 7-5
T_{detect, NR}_Intra_Relax, T_{measure, NR}_Intra__{Relax} and T_{evaluate, NR}_Intra__{Relax} for UE configured with eDRX_IDLE cycle
(Frequency range FR2-1)

| | | PTW | | | | |
|---|---|---|---|---|---|---|
| | | length | | | | |
| eDRX_ | | [s] | | T_{detect, NR}_Intra_Relax | T_{measure, NR}_Intra__{Relax} | T_{evaluate, NR}_Intra__{Relax} |
| IDLE | DRX | (number | Scaling | [s] (number of | [s] (number of | [s] (number of |
| cycle | cycle | of | Factor | DRX cycles or | DRX cycles or | DRX cycles or |
| length | length | 1.28 s | (N1) | eDRX cycles | eDRX cycles | eDRX cycles |
| [s] | [s] | periods) | ^{Note1} | ^{Note 3}) | ^{Note 3}) | ^{Note 3}) |
| 20.48 ≤ eDRX_ IDLE | 0.32 | ≥15.36 (12) | 8 | $K 1 \times eDRX\_cycle \_ \text{?} ⌈ \frac{23 \times N 1}{PTW / DRX\_cycle \_ \text{?}} \text{?} ( 23 \times N 1 \times K 1 )$ | 0.32 × N1 × K1 (1 × N1 × K1) | 0.64 × N1 × K1 (2 × N1 × K1) |
| cycle | 0.64 | ≥19.2 | 5 | | 0.64 × N1 × K1 | 1.28 × N1 × K1 |
| length | | (15) | | | (1 × N1 × K1) | (2 × N1 × K1) |
| ≤[163.84] | 1.28 | ≥30.72 | 4 | | 1.28 × N1 × K1 | 2.56 × N1 × K1 |
| | | (24) | | | (1 × N1 × K1) | (2 × N1 × K1) |
| | 2.56 | 40.96 | 3 | | 20.48 | 40.96 |
| | | (32) | | | | |

^{Note1}:
Applies for UE supporting FR2-1 power class 2 & 3 & 4. For UE supporting FR2-1 power class 1 or 5, N1 = 8 for all DRX cycle length.
^{Note 2}:
The number of DRX cycles in this table is given for the DRX cycles within PTWs.
^{Note 3}:
The eDRX_IDLE cycle lengths are as specified in Section 10.5.5.32 of TS 24.008 [34].
^{Note 4}:
$The lower bound of PTW length is derived based on ⌈ \frac{Tevaluate , NR\_Intra * DRX\_cycle}{1.28} ⌉ * 1.28 .$ ^{Note 5}:
The measurement may not be performed across PTW’s. In this case the measurement is performed in the next available PTW.
^{Note 6}:
The evaluation may not be performed across PTW’s.
^{Note 7}:
K1 = 3 is the measurement relaxation factor applicable for UE fulfilling the lowMobilityEvaluation criterion [2].

When a wireless device is configured with a cellEdgeEvaluation criterion and the wireless device has fulfilled the cellEdgeEvaluation criterion; or the wireless device is configured with both a lowMobilityEvaluation criterion and the cellEdgeEvaluation criterion and combineRelaxedMeasCondition not configured, and the wireless device has fulfilled only the cellEdgeEvaluation criterion, the wireless device may perform relaxed measurement based on the not-at-cell edge criterion being fulfilled. Values of Tdetect,NR_Intra, Tmeasure,NR_Intra, and Tevaluate,NR_Intra are based on Table 8-1, Table 8-2, Table 8-3, Table 8-4, or Table 8-5. If the wireless device is configured with eDRX_IDLE cycle then the requirements in Table 8-2 and Table 8-3 are applicable for eDRX cycle up to 10.24 s in FR1 and FR2, respectively. If the wireless device is configured with eDRX_IDLE cycle greater than 10.24 s in FR1 and FR2, then the requirements in Table 8-4 and Table 8-5 respectively may apply provided eDRX cycle is ≤[163.84] sec and evaluation/measurement time with relaxation on one carrier is not greater than single PTW window length.

TABLE 8-1
T_{detect, NR}_{_{—}}_{Intra,} T_{measure, NR}_{_{—}}_{Intra} and T_{evaluate, NR}_{_{—}}_{Intra}

| DRX | | | | T_{detect, NR}_{_{—}}_{Intra} | T_{measure, NR}_{_{—}}_{Intra} | T_{evaluate, NR}_{_{—}}_{Intra} |
|---|---|---|---|---|---|---|
| cycle | | | | [s] (number | [s] (number | [s] (number |
| length | Scaling Factor (N1) | | | of DRX | of DRX | of DRX |
| [s] | FR1 | FR2-1^{Note1} | FR2-2 ^{Note2} | cycles) | cycles) | cycles) |
| 0.32 | 1 | 8 | 12 | 11.52 × N1 × | 1.28 × N1 × | 5.12 × N1 × |
| | | | | M2 × K1 | M2 × K1 | M2 × K1 |
| | | | | (36 × N1 × | (4 × N1 × | (16 × N1 × |
| | | | | M2 × K1) | M2 × K1) | M2 × K1) |
| 0.64 | | 5 | 8 | 17.92 × N1 × | 1.28 × N1 × | 5.12 × N1 × |
| | | | | K1 (28 × | K1 (2 × | K1 (8 × |
| | | | | N1 × K1) | N1 × K1) | N1 × K1) |
| 1.28 | | 4 | 6 | 32 × N1 × | 1.28 × N1 × | 6.4 × N1 × |
| | | | | K1 (25 × | K1 (1 × | K1 (5 × |
| | | | | N1 × K1) | N1 × K1) | N1 × K1) |
| 2.56 | | 3 | 5 | 58.88 × N1 × | 2.56 × N1 × | 7.68 × N1 × |
| | | | | K1 (23 × | K1 (1 × | K1 (3 × |
| | | | | N1 × K1) | N1 × K1) | N1 × K1) |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.
Note 3:
M2 = 1.5 if SMTC periodicity of measured intra-frequency cell > 20 ms; otherwise M2 = 1. If high layer signalling smtc2-LP-r16 is configured, for cells indicated in the pci-List parameter in smtc2-LP-r16, the SMTC periodicity corresponds to the value of higher layer parameter smtc2-LP-r16; for the other cells, the SMTC periodicity corresponds to the value of higher layer parameter smtc.
Note 4:
K1 = 3 is the measurement relaxation factor applicable for UE fulfilling the cellEdgeEvaluation [2] criterion.

TABLE 8-2
T_{detect, NR}_{_{—}}_{Intra}_{_{—}}_{Relax}, T_{measure, NR}_{_{—}}_{Intra}_{_{—}}_{Relax} and T_{evaluate, NR}_{_{—}}_{Intra}_{_{—}}_{Relax}
for UE configured with eDRX_IDLE cycle (Frequency range FR1)
for eDRX_IDLE cycle up to 10.24 s

| DRX_IDLE | T_{detect, NR}_{_{—}}_{Intra}_{_{—}}_{Relax} | | T_{measure, NR}_{_{—}}_{Intra}_{_{—}}_{Relax} | | T_{evaluate, NR}_{_{—}}_{Intra}_{_{—}}_{Relax} | |
|---|---|---|---|---|---|---|
| cycle length | [s] (number of | | [s] (number of | | [s] (number of | |
| [s] | eDRX IDLE cycles) | | eDRX IDLE cycles) | | eDRX IDLE cycles) | |
| 2.56 | 58.88 × K1 | (23 × K1) | 2.56 × K1 | (1 × K1) | 7.68 × K1 | (3 × K1) |
| 5.12 | 117.76 × K1 | (23 × K1) | 5.12 × K1 | (1 × K1) | 10.24 × K1 | (2 × K1) |
| 10.24 | 235.52 × K1 | (23 × K1) | 10.24 × K1 | (1 × K1) | 20.48 × K1 | (2 × K1) |

Note 1:
Applies for UE of all supporting FR1 power classes.
Note 2:
K1 = 3 is the measurement relaxation factor applicable for UE fulfilling the cellEdgeEvaluation [2] criterion.

TABLE 8-3
T_{detect, NR}_{_{—}}_{Intra}_{_{—}}_{Relax}, T_{measure, NR}_{_{—}}_{Intra}_{_{—}}_{Relax} and T_{evaluate, NR}_{_{—}}_{Intra}_{_{—}}_{Relax}
for UE configured with eDRX_IDLE cycle (Frequency range FR2)
for eDRX_IDLE cycle up to 10.24 s

| DRX_IDLE | T_{detect, NR}_{_{—}}_{Intra}_{_{—}}_{Relax} | T_{measure, NR}_{_{—}}_{Intra}_{_{—}}_{Relax} | T_{evaluate, NR}_{_{—}}_{Intra}_{_{—}}_{Relax} |
|---|---|---|---|
| cycle length | [s] (number of | [s] (number of | [s] (number of |
| [s] | eDRX IDLE cycles) | eDRX IDLE cycles) | eDRX IDLE cycles) |
| 2.56 | 58.88 × N1 × K1 | 2.56 × N1 × K1 | 7.68 × N1 × K1 |
| | (23 × N1 × K1) | (1 × K1) | (3 × N1 × K1) |
| 5.12 | 117.76 × N1 × K1 | 5.12 × N1 × K1 | 10.24 × N1 × K1 |
| | (23 × N1 × K1) | (1 × N1 × K1) | (2 × N1 × K1) |
| 10.24 | 235.52 × N1 × K1 | 10.24 × N1 × K1 | 20.48 × N1 × K1 |
| | (23 × N1 × K1) | (1 × N1 × K1) | (2 × N1 × K1) |

Note 1:
Applies for UE supporting FR2-1 power class 2&3&4. For UE supporting FR2-1 power class 1 or 5, N1 = 8 for all DRX cycle length.
Note 2:
N1 = 3.
Note 3:
K1 = 3 is the measurement relaxation factor applicable for UE fulfilling the cellEdgeEvaluation [2] criterion.

TABLE 8-4
T_{detect, NR}_Intra_Relax, T_{measure, NR}_Intra__{Relax} and T_{evaluate, NR}_Intra__{Relax} for UE configured with eDRX_IDLE cycle
(Frequency range FR1)

| | | PTW | | | |
|---|---|---|---|---|---|
| | | length | | | |
| | | [s] | | T_{measure, NR}_Intra__{Relax} | T_{evaluate, NR}_Intra__{Relax} |
| | DRX | (number | | [s] (number of | [s] (number of |
| eDRX_IDLE | cycle | of | | DRX cycles or | DRX cycles or |
| cycle | length | 1.28 s | T_{detect, NR}_Intra_Relax [s] (number of | eDRX cycles | eDRX cycles |
| length [s] | [s] | periods) | DRX cycles or eDRX cycles ^{Note 3}) | ^{Note 3}) | ^{Note 3}) |
| 20.48 ≤ eDRX_IDLE | 0.32 | ≥[3.84] ([3]) | $eDRX\_cycle \_length \times ⌈ \frac{23}{PTW / DRX\_cycle \_length} ⌉ \times K 1 ( 23 \times K 1 )$ | 0.32 × M2 × K1 (1 × M2 × K1) | 0.64 × M2 × K1 (2 × M2 × K1) |
| cycle | 0.64 | ≥[3.84] | | 0.64 × K1 (1 × K1) | 1.28 × K1 (2 × K1) |
| length | | ([3]) | | | |
| ≤[163.84] | 1.28 | ≥[7.68] | | 1.28 × K1 (1 × K1) | 2.56 × K1 (2 × K1) |
| | | ([6]) | | | |
| | 2.56 | ≥[15.36] | | 2.56 × K1 (1 × K1) | 5.12 × K1 (2 × K1) |
| | | ([12]) | | | |

^{Note 1}:
The number of DRX cycles in this table is given for the DRX cycles within PTWs.
^{Note 2}:
The eDRX_IDLE cycle lengths are as specified in Section 10.5.5.32 of TS 24.008 [34].
^{Note 3}:
$The lower bound of PTW length is derived based on ⌈ \frac{Tevaluate , NR\_Intra * DRX\_cycle}{1.28} ⌉ * 1.28 .$ ^{Note 4}:
M2 = 1.5 if SMTC periodicity of measured intra-frequency cell > 20 ms; otherwise M2 = 1.
^{Note 5}:
K1 = 3 is the measurement relaxation factor applicable for UE fulfilling the cellEdgeEvaluation [2] criterion.

TABLE 8-5
T_{detect, NR}_Intra_Relax, T_{measure, NR}_Intra_ _{Relax} and T_{evaluate, NR}_Intra__{Relax} for UE configured with eDRX_IDLE cycle
(Frequency range FR2)

| | | PTW | | | | |
|---|---|---|---|---|---|---|
| | | length | | | T_{measure, NR}_Intra_ | T_{evaluate, NR}_Intra_ |
| | | [s] | | T_{detect, NR}_Intra_Relax | _{Relax} [s] | _{Relax} [s] |
| | DRX | (number | Scaling | [s] (number of | (number of | (number of |
| eDRX_IDLE | cycle | of | Factor | DRX cycles or | DRX cycles | DRX cycles |
| cycle | length | 1.28 s | (N1) | eDRX cycles | or eDRX | or eDRX |
| length [s] | [s] | periods) | ^{Note1} | ^{Note 3}) | cycles ^{Note 3}) | cycles ^{Note 3}) |
| 20.48 ≤ eDRX_IDLE cycle | 0.32 | ≥15.36 (12) | 8 | $K 1 \times eDRX\_cycle \_ \text{?} ⌈ \frac{23 \times N 1}{PTW / DRX\_cycle \_ \text{?}} \text{?} ( 23 \times N 1 \times K 1 )$ | 0.32 × N1 × K1 (1 × N1 × K1) | 0.64 × N1 × K1 (2 × N1 × K1) |
| length | 0.64 | ≥19.2 | 5 | | 0.64 × N1 × | 1.28 × N1 × |
| ≤[163.84] | | (15) | | | K1 (1 × N1 × | K1 (2 × N1 × |
| | | | | | K1) | K1) |
| | 1.28 | ≥30.72 | 4 | | 1.28 × N1 × | 2.56 × N1 × |
| | | (24) | | | K1 (1 × N1 × | K1 (2 × N1 × |
| | | | | | K1) | K1) |
| | 2.56 | 40.96 | 3 | | 20.48 | 40.96 |
| | | (32) | | | | |

^{Note1}:
Applies for UE supporting FR2-1 power class 2 & 3 & 4. For UE supporting FR2-1 power class 1 or 5, N1 = 8 for all DRX cycle length.
^{Note 2}:
The number of DRX cycles in this table is given for the DRX cycles within PTWs.
^{Note 3}:
The eDRX_IDLE cycle lengths are as specified in Section 10.5.5.32 of TS 24.008 [34].
^{Note 4}:
$The lower bound of PTW length is derived based on ⌈ \frac{Tevaluate , NR\_Intra * DRX\_cycle}{1.28} ⌉ * 1.28 .$ ^{Note 5}:
The measurement may not be performed across PTW’s. In this case the measurement is performed in the next available PTW.
^{Note 6}:
The evaluation may not be performed across PTW’s.
^{Note 7}:
K1 = 3 is the measurement relaxation factor applicable for UE fulfilling the cellEdgeEvaluation criterion [2].

When a wireless device is configured with a low MobilityEvaluation criterion and a cellEdgeEvaluation criterion; and the wireless device also fulfilled the both the lowMobilityEvaluation criterion and the cellEdgeEvaluation criterion; and less than one hour have passed since measurements for cell reselection were last performed, the wireless device may perform the relaxed measurement based on the low mobility criterion being fulfilled and the not-at-cell edge criterion being fulfilled. Based on performing the relaxed measurement based on the low mobility criterion being fulfilled and the not-at-cell edge criterion being fulfilled, the wireless device may not be required to meet Tdetect,NR_Intra, Tmeasure,NR_Intra and Tevaluate,NR_Intra as defined in Table 3-1.

When a wireless device is configured with a lowMobilityEvaluation criterion and the wireless device has fulfilled the criterion, or the wireless device is configured with both the lowMobilityEvaluation criterion and a cellEdgeEvaluation criterion and combineRelaxedMeasCondition not configured and the wireless device has fulfilled only the lowMobilityEvaluation criterion, the wireless device may perform relaxed measurement based on the low mobility criterion being fulfilled. When Srxlev≤SnonIntraSearchP or Squal≤SnonIntraSearchQ: value of Tdetect,NR_Inter_Relax, Tmeasure,NR_Inter_Relax, and Tevaluate,NR_Inter_Relax may be based on Table 9-1; the wireless device may be able to evaluate whether a detectable inter-frequency NR cell meets the reselection criteria, for cell reselection, within Ncarrier_Relax*Tdetect,NR_Inter_Relax+Ncarrier_Non_relax*Tdetect,NR_Inter. Cells which have been detected may be measured at least every Ncarrier_Relax*Tmeasure,NR_Inter_Relax+Ncarrier_Non_relax*Tmeasure,NR_Inter. The UE may be able to evaluate that an identified inter-frequency NR cell has met reselection criterion, for cell reselection, within Ncarrier_Relax*Tevaluate,NR_Inter_Relax+Ncarrier_Non_relax*Tevaluate,NR_Inter. When timer T331 is running, a parameter Ncarrier_Relax may be a total number of NR inter-frequency carriers not configured for idle mode CA/DC measurements. A parameter Ncarrier_Non_relax may be a total number of NR inter-frequency carriers configured for idle mode CA/DC measurements. The parameter Ncarrier_Non_relax=0 when Srxlev>SnonIntraSearchP and Squal>SnonIntraSearchQ and the wireless device is configured with highPriorityMeasRelax then the wireless device may search for inter-frequency layers of higher priority at least every K2*Thigher_priority_search. If the wireless device is not configured with highPriorityMeasRelax then the wireless device may search for inter-frequency layers of higher priority, than a priority of the serving frequency of the wireless device, at least every Thigher_priority_search.

If the wireless device is configured with eDRX_IDLE cycle then the requirements in Table 9-2 and Table 9-3 are applicable for eDRX cycle up to 10.24 s in FR1 and FR2, respectively.

If the wireless device is configured with eDRX_IDLE cycle greater than 10.24 s in FR1 and FR2, then the requirements in Table 9-4 and Table 9-5 respectively apply provided eDRX cycle is ≤[163.84] sec and evaluation/measurement time with relaxation on one carrier is not greater than single PTW window length.

TABLE 9-1
T_{detect, NR}_{_{—}}_{Inter}_{_{—}}_{Relax,} T_{measure, NR}_{_{—}}_{Inter}_{_{—}}_{Relax} and T_{evaluate, NR}_{_{—}}_{Inter}_{_{—}}_{Relax}

| DRX | | | | T_{detect, NR}_{_{—}}_{Inter} | T_{measure, NR}_{_{—}}_{Inter} | T_{evaluate, NR}_{_{—}}_{Inter} |
|---|---|---|---|---|---|---|
| cycle | | | | [s] (number | [s] (number | [s] (number |
| length | Scaling Factor (N1) | | | of DRX | of DRX | of DRX |
| [s] | FR1 | FR2-1^{Note1} | FR2-2 ^{Note2} | cycles) | cycles) | cycles) |
| 0.32 | 1 | 8 | 12 | 11.52 × N1 × | 1.28 × N1 × | 5.12 × N1 × |
| | | | | K1 × 1.5 | K1 × 1.5 | K1 × 1.5 |
| | | | | (36 × N1 × | (4 × N1 × | (16 × N1 × |
| | | | | K1 × 1.5) | K1 × 1.5) | K1 × 1.5) |
| 0.64 | | 5 | 8 | 17.92 × N1 × | 1.28 × N1 × | 5.12 × N1 × |
| | | | | K1 (28 × | K1 (2 × | K1 (8 × |
| | | | | N1 × K1) | N1 × K1) | N1 × K1) |
| 1.28 | | 4 | 6 | 32 × N1 × | 1.28 × N1 × | 6.4 × N1 × |
| | | | | K1 (25 × | K1 (1 × | K1 (5 × |
| | | | | N1 × K1) | N1 × K1) | N1 × K1) |
| 2.56 | | 3 | 5 | 58.88 × N1 × | 2.56 × N1 × | 7.68 × N1 × |
| | | | | K1 (23 × | K1 (1 × | K1 (3 × |
| | | | | N1 × K1) | N1 × K1) | N1 × K1) |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.
Note 3:
K1 = 3 is the measurement relaxation factor applicable for UE fulfilling the low mobility.

TABLE 9-2
T_{detect, NR}_{_{—}}_{Inter}_{_{—}}_{Relax}, T_{measure, NR}_{_{—}}_{Inter}_{_{—}}_{Relax} and T_{evaluate, NR}_{_{—}}_{Inter}_{_{—}}_{Relax}
for UE configured with eDRX_IDLE cycle (Frequency range
FR1) for eDRX_IDLE cycle up to 10.24 s

| eDRX_IDLE | T_{detect, NR}_{_{—}}_{Inter}_{_{—}}_{Relax} | | T_{measure, NR}_{_{—}}_{Inter}_{_{—}}_{Relax} | | T_{evaluate, NR}_{_{—}}_{Inter}_{_{—}}_{Relax} | |
|---|---|---|---|---|---|---|
| cycle length | [s] (number of | | [s] (number of | | [s] (number of | |
| [s] | eDRX IDLE cycles) | | eDRX IDLE cycles) | | eDRX IDLE cycles) | |
| 2.56 | 58.88 × K1 | (23 × K1) | 2.56 × K1 | (1 × K1) | 7.68 × K1 | (3 × K1) |
| 5.12 | 117.76 × K1 | (23 × K1) | 5.12 × K1 | (1 × K1) | 10.24 × K1 | (2 × K1) |
| 10.24 | 235.52 × K1 | (23 × K1) | 10.24 × K1 | (1 × K1) | 20.48 × K1 | (2 × K1) |

Note 1:
Applies for UE of all supporting FR1 power classes.
Note 2:
K1 = 3 is the measurement relaxation factor applicable for UE fulfilling the lowMobilityEvaluation [2] criterion.

TABLE 9-3
T_{detect, NR}_{_{—}}_{Inter}_{_{—}}_{Relax}, T_{measure, NR}_{_{—}}_{Inter}_{_{—}}_{Relax} and T_{evaluate, NR}_{_{—}}_{Inter}_{_{—}}_{Relax}
for UE configured with eDRX_IDLE cycle (Frequency range FR2)
for eDRX_IDLE cycle up to 10.24 s

| eDRX_IDLE | T_{detect, NR}_{_{—}}_{Inter}_{_{—}}_{Relax} | T_{measure, NR}_{_{—}}_{Inter}_{_{—}}_{Relax} | T_{evaluate, NR}_{_{—}}_{Inter}_{_{—}}_{Relax} |
|---|---|---|---|
| cycle length | [s] (number of | [s] (number of | [s] (number of |
| [s] | eDRX IDLE cycles) | eDRX IDLE cycles) | eDRX IDLE cycles) |
| 2.56 | 58.88 × N1 × K1 | 2.56 × N1 × K1 | 7.68 × N1 × K1 |
| | (23 × N1 × K1) | (1 × N1 × K1) | (3 × N1 × K1) |
| 5.12 | 117.76 × N1 × K1 | 5.12 × N1 × K1 | 10.24 × N1 × K1 |
| | (23 × N1 × K1) | (1 × N1 × K1) | (2 × N1 × K1) |
| 10.24 | 235.52 × N1 × K1 | 10.24 × N1 × K1 | 20.48 × N1 × K1 |
| | (23 × N1 × K1) | (1 × N1 × K1) | (2 × N1 × K1) |

Note 1:
Applies for UE supporting FR2-1 power class 2&3&4. For UE supporting FR2-1 power class 1 or 5, N1 = 8 for all DRX cycle length.
Note 2:
N1 = 3.
Note 3:
K1 = 3 is the measurement relaxation factor applicable for UE fulfilling the lowMobilityEvaluation [2] criterion.

TABLE 9-4
T_{detect, NR}_Inter_Relax, T_{measure, NR}_Inter__{Relax} and T_{evaluate, NR}_Inter__{Relax} for UE configured with eDRX IDLE cycle
(Frequency range FR1)
[s] (number of

| | | PTW | | | |
|---|---|---|---|---|---|
| | | length | | | |
| | | [s] | | T_{measure, NR}_Inter_Relax | T_{evaluate, NR}_Inter_Relax |
| | DRX | (number | | [s] (number of | [s] (number of |
| eDRX_IDLE | cycle | of | | DRX cycles or | DRX cycles or |
| cycle | length | 1.28 s | T_{detect, NR}_Inter_Relax [s] (number of | eDRX cycles | eDRX cycles |
| length [s] | [s] | periods) | DRX cycles or eDRX cycles ^{Note 3}) | ^{Note 3}) | ^{Note 3}) |
| 20.48 ≤ eDRX_IDLE | 0.32 | ≥[3.84] ([3]) | $eDRX\_cycle \_length \times ⌈ \frac{23}{PTW / DRX\_cycle \_length} ⌉ \times K 1 ( 23 \times K 1 )$ | 0.32 × 1.5 × K1 (1 × M2 × K1) | 0.64 × 1.5 × K1 (2 × M2 × K1) |
| cycle | 0.64 | ≥[3.84] | | 0.64 × K1 (1 × K1) | 1.28 × K1 (2 × K1) |
| length | | ([3]) | | | |
| ≤[163.84] | 1.28 | ≥[7.68] | | 1.28 × K1 (1 × K1) | 2.56 × K1 (2 × K1) |
| | | ([6]) | | | |
| | 2.56 | ≥[15.36] | | 2.56 × K1 (1 × K1) | 5.12 × K1 (2 × K1) |
| | | ([12]) | | | |

^{Note 1}:
The number of DRX cycles in this table is given for the DRX cycles within PTWs.
^{Note 2}:
The eDRX_IDLE cycle lengths are as specified in Section 10.5.5.32 of TS 24.008 [34].
^{Note 3}:
$The lower bound of PTW length is derived based on ⌈ \frac{Tevaluate , NR\_Intra * DRX\_cycle}{1.28} ⌉ * 1.28 .$ ^{Note 4}:
K1 = 3 is the measurement relaxation factor applicable for UE fulfilling the lowMobilityEvaluation [2] criterion.

TABLE 9-5
T_{detect, NR}_Inter_Relax, T_{measure, NR}_Inter__{Relax} and T_{evaluate, NR}_Inter__{Relax} for UE configured with eDRX_IDLE cycle
(Frequency range FR2)

| | | PTW | | | T_{measure, NR}_ | T_{evaluate, NR}_ |
|---|---|---|---|---|---|---|
| | | length | Scaling | | _{Inter}_Relax | _{Inter}_Relax |
| eDRX_ | DRX | [s] | Factor | | [s] (number | [s] (number of |
| IDLE | cycle | (number | (N1) | T_{detect, NR}_Inter_Relax [s] | of DRX cycles | DRX cycles or |
| cycle | length | of 1.28 s | ^{Note1} | (number of DRX cycles | or eDRX cycles | eDRX cycles |
| length [s] | [s] | periods) | | or eDRX cycles ^{Note 3}) | ^{Note 3}) | ^{Note 3}) |
| 20.48 ≤ eDRX_ | 0.32 | ≥15.36 (12) | 8 | $K 1 \times eDRX\_cycle \_length \times ⌈ \frac{23 \times N 1}{PTW / DRX\_cycle \_length} ⌉ ( 23 \times N 1 \times K 1 )$ | 0.32 × N1 × K1 (1 × N1 × K1) | 0.64 × N1 × K1 (2 × N1 × K1) |
| IDLE | 0.64 | ≥19.2 | 5 | | 0.64 × N1 × K1 | 1.28 × N1 × K1 |
| cycle | | (15) | | | (1 × N1 × K1) | (2 × N1 × K1) |
| length | 1.28 | ≥30.72 | 4 | | 1.28 × N1 × K1 | 2.56 × N1 × K1 |
| ≤[163.84] | | (24) | | | (1 × N1 × K1) | (2 × N1 × K1) |
| | 2.56 | 40.96 | 3 | | 20.48 | 40.96 |
| | | (32) | | | | |

^{Note1}:
Applies for UE supporting FR2-1 power class 2 & 3 & 4. For UE supporting FR2-1 power class 1 or 5, N1 = 8 for all DRX cycle length.
^{Note 2}:
The number of DRX cycles in this table is given for the DRX cycles within PTWs.
^{Note 3}:
The eDRX_IDLE cycle lengths are as specified in Section 10.5.5.32 of TS 24.008 [34].
^{Note 4}:
$The lower bound of PTW length is derived based on ⌈ \frac{Tevaluate , NR\_Intra * DRX\_cycle}{1.28} ⌉ * 1.28 .$ ^{Note 5}:
The measurement may not be performed across PTW’s. In this case the measurement is performed in the next available PTW.
^{Note 6}:
The evaluation may not be performed across PTW’s.
^{Note 7}:
K1 = 3 is the measurement relaxation factor applicable for UE fulfilling the lowMobilityEvaluation criterion [2].

When a wireless device is configured with a cellEdgeEvaluation criterion and the wireless device has fulfilled the criterion, or the wireless device is configured with both a lowMobilityEvaluation criterion and the cellEdgeEvaluation criterion and combineRelaxedMeasCondition not configured and the wireless device has fulfilled only the low MobilityEvaluation criterion, the wireless device may perform relaxed measurement based on the not-at-cell edge criterion being fulfilled. When Srxlev≤SnonIntraSearchP or Squal≤SnonIntraSearchQ: value of Tdetect,NR_Inter_Relax, Tmeasure,NR_Inter_Relax, and Tevaluate,NR_Inter_Relax may be based on Table 10-1; the wireless device may be able to evaluate whether a detectable inter-frequency NR cell meets the reselection criteria, for cell reselection, within Ncarrier_Relax*Tdetect,NR_Inter_Relax+Ncarrier_Non_relax*Tdetect,NR_Inter. Cells which have been detected may be measured at least every Ncarrier_Relax*Tmeasure,NR_Inter_Relax+Ncarrier_Non_relax*Tmeasure,NR_Inter. The wireless device may be able to evaluate that an identified inter-frequency NR cell has met reselection criterion, for cell reselection, within Ncarrier_Relax*Tevaluate,NR_Inter_Relax+Ncarrier_Non_relax*Tevaluate,NR_Inter.

When timer T331 is running: a parameter Ncarrier_Relax may be a total number of NR inter-frequency carriers not configured for idle mode CA/DC measurements; and a parameter Ncarrier_Non_relax may be a total number of NR inter-frequency carriers configured for idle mode CA/DC measurements. When timer T331 is not running, a parameter Ncarrier_Relax may be a total number of inter-frequency carriers configured for mobility measurements only and the number of inter-frequency carriers configured for both mobility measurement and idle mode CA/DC measurements. The parameter Ncarrier_Non_relax=0.

If the wireless device is configured with eDRX_IDLE cycle then the requirements in Table 10-2 and Table 10-3 are applicable for eDRX cycle up to 10.24 s in FR1 and FR2, respectively.

If the wireless device is configured with eDRX_IDLE cycle greater than 10.24 s in FR1 and FR2, then the requirements in Table 10-4 and Table 10-5 respectively may apply provided eDRX cycle is ≤[163.84] sec and evaluation/measurement time with relaxation on one carrier may be not greater than single PTW window length.

When Srxlev>SnonIntraSearchP and Squal>SnonIntraSearchQ and regardless of whether the wireless device is configured with highPriorityMeasRelax or not, the wireless device may search for inter-frequency layers of higher priority at least every Thigher_priority_search.

TABLE 10-1
T_{detect, NR}_{_{—}}_{Inter}_{_{—}}_{Relax,} T_{measure, NR}_{_{—}}_{Inter}_{_{—}}_{Relax} and T_{evaluate, NR}_{_{—}}_{Inter}_{_{—}}_{Relax}

| DRX | | | | T_{detect, NR}_{_{—}}_{Inter} | T_{measure, NR}_{_{—}}_{Inter} | T_{evaluate, NR}_{_{—}}_{Inter} |
|---|---|---|---|---|---|---|
| cycle | | | | [s] (number | [s] (number | [s] (number |
| length | Scaling Factor (N1) | | | of DRX | of DRX | of DRX |
| [s] | FR1 | FR2-1^{Note1} | FR2-2 ^{Note2} | cycles) | cycles) | cycles) |
| 0.32 | 1 | 8 | 12 | 11.52 × N1 × | 1.28 × N1 × | 5.12 × N1 × |
| | | | | K1 × 1.5 | K1 × 1.5 | K1 × 1.5 |
| | | | | (36 × N1 × | (4 × N1 × | (16 × N1 × |
| | | | | K1 × 1.5) | K1 × 1.5) | K1 × 1.5) |
| 0.64 | | 5 | 8 | 17.92 × N1 × | 1.28 × N1 × | 5.12 × N1 × |
| | | | | K1 (28 × | K1 (2 × | K1 (8 × |
| | | | | N1 × K1) | N1 × K1) | N1 × K1) |
| 1.28 | | 4 | 6 | 32 × N1 × | 1.28 × N1 × | 6.4 × N1 × |
| | | | | K1 (25 × | K1 (1 × | K1 (5 × |
| | | | | N1 × K1) | N1 × K1) | N1 × K1) |
| 2.56 | | 3 | 5 | 58.88 × N1 × | 2.56 × N1 × | 7.68 × N1 × |
| | | | | K1 (23 × | K1 (1 × | K1 (3 × |
| | | | | N1 × K1) | N1 × K1) | N1 × K1) |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.
Note 3:
K1 = 3 is the measurement relaxation factor applicable for UE fulfilling the cellEdgeEvaluation [2] criterion.

TABLE 10-2
T_{detect, NR}_{_{—}}_{Inter}_{_{—}}_{Relax}, T_{measure, NR}_{_{—}}_{Inter}_{_{—}}_{Relax} and T_{evaluate, NR}_{_{—}}_{Inter}_{_{—}}_{Relax}
for UE configured with eDRX_IDLE cycle (Frequency range FR1)
for eDRX_IDLE cycle up to 10.24 s

| DRX_IDLE | T_{detect, NR}_{_{—}}_{Inter}_{_{—}}_{Relax} | | T_{measure, NR}_{_{—}}_{Inter}_{_{—}}_{Relax} | | T_{evaluate, NR}_{_{—}}_{Inter}_{_{—}}_{Relax} |
|---|---|---|---|---|---|
| cycle length | [s] (number of | | [s] (number of | | [s] (number of |
| [s] | eDRX IDLE cycles) | | eDRX IDLE cycles) | | eDRX IDLE cycles) |
| 2.56 | 58.88 × K1 | (23 × K1) | 2.56 × K1 | (1 × K1) | 7.68 × N1 × K1 |
| | | | | | (3 × N1 × K1) |
| 5.12 | 117.76 × K1 | (23 × K1) | 5.12 × K1 | (1 × K1) | 10.24 × N1 × K1 |
| | | | | | (2 × N1 × K1) |
| 10.24 | 235.52 × K1 | (23 × K1) | 10.24 × K1 | (1 × K1) | 20.48 × N1 × K1 |
| | | | | | (2 × N1 × K1) |

Note 1:
Applies for UE of all supporting FR1 power classes.
Note 2:
K1 = 3 is the measurement relaxation factor applicable for UE fulfilling the cellEdgeEvaluation [2] criterion.

TABLE 10-3
T_{detect, NR}_{_{—}}_{Inter}_{_{—}}_{Relax}, T_{measure, NR}_{_{—}}_{Inter}_{_{—}}_{Relax} and T_{evaluate, NR}_{_{—}}_{Inter}_{_{—}}_{Relax}
for UE configured with eDRX_IDLE cycle (Frequency range FR2)
for eDRX_IDLE cycle up to 10.24 s

| DRX_IDLE | T_{detect, NR}_{_{—}}_{Inter}_{_{—}}_{Relax} | T_{measure, NR}_{_{—}}_{Inter}_{_{—}}_{Relax} | T_{evaluate, NR}_{_{—}}_{Inter}_{_{—}}_{Relax} |
|---|---|---|---|
| cycle length | [s] (number of | [s] (number of | [s] (number of |
| [s] | eDRX IDLE cycles) | eDRX IDLE cycles) | eDRX IDLE cycles) |
| 2.56 | 58.88 × N1 × K1 | 2.56 × N1 × K1 | 7.68 × N1 × K1 |
| | (23 × N1 × K1) | (1 × N1 × K1) | (3 × N1 × K1) |
| 5.12 | 117.76 × N1 × K1 | 5.12 × N1 × K1 | 10.24 × N1 × K1 |
| | (23 × N1 × K1) | (1 × N1 × K1) | (2 × N1 × K1) |
| 10.24 | 235.52 × N1 × K1 | 10.24 × N1 × K1 | 20.48 × N1 × K1 |
| | (23 × N1 × K1) | (1 × N1 × K1) | (2 × N1 × K1) |

Note 1:
Applies for UE supporting FR2-1 power class 2&3&4. For UE supporting FR2-1 power class 1 or 5, N1 = 8 for all DRX cycle length.
Note 2:
N1 = 3.
Note 3:
K1 = 3 is the measurement relaxation factor applicable for UE fulfilling the cellEdgeEvaluation [2] criterion.

TABLE 10-4
T_{detect, NR}_Inter_Relax, T_{measure, NR}_Inter__{Relax} and T_{evaluate, NR}_Inter__{Relax} for UE configured with eDRX_IDLE cycle
(Frequency range FR1)

| | | PTW | | | |
|---|---|---|---|---|---|
| | | length | | | |
| | | [s] | | T_{measure, NR}_Inter_Relax | T_{evaluate, NR}_Inter_Relax |
| eDRX_ | DRX | (number | | [s] (number of | [s] (number of |
| IDLE | cycle | of | | DRX cycles or | DRX cycles or |
| cycle | length | 1.28 s | T_{detect, NR}_Inter_Relax [s] (number of | eDRX cycles | eDRX cycles |
| length [s] | [s] | periods) | DRX cycles or eDRX cycles ^{Note 3}) | ^{Note 3}) | ^{Note 3}) |
| 20.48 ≤ eDRX_ | 0.32 | ≥[3.84] ([3]) | $eDRX\_cycle \_length \times ⌈ \frac{23}{PTW / DRX\_cycle \_length} ⌉ \times K 1 ( 23 \times K 1 )$ | 0.32 × M2 × K1 (1 × M2 × K1) | 0.64 × M2 × K1 (2 × M2 × K1) |
| IDLE | 0.64 | ≥[3.84] | | 0.64 × K1 (1 × K1) | 1.28 × K1 (2 × K1) |
| cycle | | ([3]) | | | |
| length | 1.28 | ≥[7.68] | | 1.28 × K1 (1 × K1) | 2.56 × K1 (2 × K1) |
| ≤[163.84] | | ([6]) | | | |
| | 2.56 | ≥[15.36] | | 2.56 × K1 (1 × K1) | 5.12 × K1 (2 × K1) |
| | | ([12]) | | | |

^{Note 1}:
The number of DRX cycles in this table is given for the DRX cycles within PTWs.
^{Note 2}:
The eDRX_IDLE cycle lengths are as specified in Section 10.5.5.32 of TS 24.008 [34].
^{Note 3}:
$The lower bound of PTW length is derived based on ⌈ \frac{Tevaluate , NR\_Intra * DRX\_cycle}{1.28} ⌉ * 1.28 .$ ^{Note 4}:
M2 = 1.5 if SMTC periodicity of measured intra-frequency cell > 20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_intra is expected.
^{Note 5}:
K1 = 3 is the measurement relaxation factor applicable for UE fulfilling the cellEdgeEvaluation [2] criterion.

TABLE 10-5
T_{detect, NR}_Inter_Relax, T_{measure, NR}_Inter_Relax and T_{evaluate, NR}_Inter__{Relax} for UE configured with eDRX_IDLE cycle
(Frequency range FR2)

| | | PTW | | | T_{measure, NR}_Inter_ | T_{evaluate, NR}_Inter_ |
|---|---|---|---|---|---|---|
| eDRX_ | | length | | | _{Relax} | _{Relax} |
| IDLE | DRX | [s] | Scaling | | [s] (number | [s] (number of |
| cycle | cycle | (number | Factor | T_{detect, NR}_Inter_Relax [s] | of DRX cycles | DRX cycles or |
| length | length | of 1.28 s | (N1) | (number of DRX cycles | or eDRX cycles | eDRX cycles |
| [s] | [s] | periods) | ^{Note1} | or eDRX cycles ^{Note 3}) | ^{Note 3}) | ^{Note 3}) |
| 20.48 ≤ eDRX_ | 0.32 | ≥15.36 (12) | 8 | $K 1 \times eDRX\_cycle \_length \times ⌈ \frac{23 \times N 1}{PTW / DRX\_cycle \_length} ⌉ ( 23 \times N 1 \times K 1 )$ | 0.32 × N1 × K1 (1 × N1 × K1) | 0.64 × N1 × K1 (2 × N1 × K1) |
| IDLE | 0.64 | ≥19.2 | 5 | | 0.64 × N1 × K1 | 1.28 × N1 × K1 |
| cycle | | (15) | | | (1 × N1 × K1) | (2 × N1 × K1) |
| length | 1.28 | ≥30.72 | 4 | | 1.28 × N1 × K1 | 2.56 × N1 × K1 |
| ≤[163.84] | | (24) | | | (1 × N1 × K1) | (2 × N1 × K1) |
| | 2.56 | 40.96 | 3 | | 20.48 | 40.96 |
| | | (32) | | | | |

^{Note1}:
Applies for UE supporting FR2-1 power class 2 & 3 & 4. For UE supporting FR2-1 power class 1 or 5, N1 = 8 for all DRX cycle length.
^{Note 2}:
The number of DRX cycles in this table is given for the DRX cycles within PTWs.
^{Note 3}:
The eDRX_IDLE cycle lengths are as specified in Section 10.5.5.32 of TS 24.008 [34].
^{Note 4}:
$The lower bound of PTW length is derived based on ⌈ \frac{Tevaluate , NR\_Intra * DRX\_cycle}{1.28} ⌉ * 1.28 .$ ^{Note 5}:
The measurement may not be performed across PTW’s. In this case the measurement is performed in the next available PTW.
^{Note 6}:
The evaluation may not be performed across PTW’s.
^{Note 7}:
K1 = 3 is the measurement relaxation factor applicable for UE fulfilling the cellEdgeEvaluation criterion [2].

When a T331 timer is not running for early measurements reporting (EMR) on inter-frequency NR carrier, and the wireless device is configured with both a lowMobilityEvaluation criterion and a cellEdgeEvaluation criterion, and the wireless device has also fulfilled both the lowMobilityEvaluation criterion and the cellEdgeEvaluation criterion, the wireless device may perform relaxed measurement based on the low mobility criterion being fulfilled and the not-at-cell edge criterion being fulfilled. While performing the relaxed measurement based on the low mobility criterion being fulfilled and the not-at-cell edge criterion being fulfilled, the wireless device may be not required to meet Tdetect,NR_Inter, Tmeasure,NR_Inter and Tevaluate,NR_Inter as defined in Table 6-1.

When Srxlev≤SnonIntraSearchP or Squal≤SnonIntraSearchQ, the wireless device may search for, measure and evaluate inter-frequency layers of higher, equal or lower priority, compared with a priority of the serving frequency of the wireless device, at least every 1 hour. When Srxlev>SnonIntraSearchP and Squal>SnonIntraSearchQ, the wireless device may search for inter-frequency layers of higher priority, than a priority of the serving frequency of the wireless device, at least every K2*Thigher_priority_search.

For cell re-selection for a wireless device for satellite access, the wireless device may be able to identify one or more intra-frequency cells and perform synchronization signal based reference signal received power (SS-RSRP) and synchronization signal based reference signal received quality (SS-RSRQ) measurements of the identified one or more intra-frequency cells without an explicit intra-frequency neighbor list containing physical layer cell identities.

If Srxlev>SintraSearchP and Squal>SintraSearchQ, and a distance between the wireless device and a serving cell reference location is smaller than distanceThresh, if the distanceThresh is configured and the wireless device has location information, then the wireless device may not perform measurement of intra-frequency.

The UE may be able to evaluate whether a detectable intra-frequency cell meets the reselection criteria, for cell reselection, within Kmulti_SMTC*Tdetect,NR_Intra when that Treselection=0 if the wireless device does not support the feature for enhanced RRM requirements or if the enhancedMeasurementLEO-r17 is not enabled, or within Kmulti_SMTC*Tdetect,NR_Intra_enh if the wireless device supports the feature for enhanced RRM requirements and the enhancedMeasurementLEO-r17 is enabled. An intra frequency cell, for cell reselection for satellite access, may be considered to be detectable based on Table 7.

TABLE 7
Conditions for intra-frequency cell
re-selection in FR1 for satellite access

| | | Minimum SSB_RP | | |
|---|---|---|---|---|
| | | dBm/SCS_{SSB} | | SSB |
| | NR operating band | SCS_{SSB} = | SCS_{SSB} = | Ês/lot |
| Parameter | groups ^{Note1} | 15 kHz | 30 kHz | dB |
| Conditions | NR_FDD_SAB_FR1_A | −124 | −121 | ≥−4 |

^{Note1} :
NR operating band groups for satellite access are defined in clause 3.5.2A.

The wireless device may measure SS-RSRP and SS-RSRQ at least every Kmulti_SMTC*Tmeasure,NR_Intra if the wireless device does not support the feature for enhanced RRM requirements or if the indication of the enhanced measurement is not enabled, or every Kmulti_SMTC*Tmeasure,NR_Intra_enh if the UE supports the feature for enhanced RRM requirements and the indication of the enhanced measurement is enabled, for intra-frequency cells that are identified and measured according to the measurement rules.

The wireless device may filter SS-RSRP and SS-RSRQ measurements of each measured intra-frequency cell using at least two measurements. Within the set of measurements used for the filtering, at least two measurements may be spaced by at least Tmeasure,NR_Intra/2.

Parameter Kmulti_SMTC may be a scaling factor for measurements of multiple SMTCs which correspond to different satellites. If SMTCs do not overlap with each other: Kmulti_SMTC=1, if GEO satellites are measured on the carrier; and

$${K}_{multi \_ SMTC} = ⌈ \frac{{N}_{LEO , i}}{{N}_{LEO , simui}} ⌉ ,$$

if LEO satellites are measured on the carrier. If SMTCs partially overlap with each other: Kmulti_SMTC=NSMTC, overlap, if only GEO satellites are measured on the carrier; and K_{multi_SMTC}=

$${\sum }_{i = 1}^{{N}_{SMTC , overlap}} ⌈ \frac{{N}_{LEO , i}}{{N}_{LEO , simui}} ⌉ ,$$

if only LEO satellites are measured on the carrier. NLEO,i may be a number of LEO satellites to be measured within i-th SMTC. NLEO, simul may be a number of LEO satellites that the wireless device can measure in parallel within an SMTC. NSMTC, overlap may be a number of SMTCs that partially overlap with each other.

The wireless device may not consider an NR neighbor cell in cell reselection if the NR neighbor cell is indicated as not allowed in the measurement control system information of the serving cell.

For an intra-frequency cell that has been already detected, but that has not been reselected to, the filtering may be such that the wireless device may be capable of evaluating that the intra-frequency cell has met reselection criterion, for cell reselection, within Kmulti_SMTC*Tevaluate,NR_Intra if the UE does not support the feature for enhanced RRM requirements defined or if the enhancedMeasurementLEO-r17 is not enabled, or within Kmulti_SMTC*Tevaluate,NR_Intra_enh if the wireless device supports the feature for enhanced RRM requirements and the enhancedMeasurementLEO-r17 is enabled, when Treselection=0 provided that: when rangeToBestCell is not configured, the cell may be at least 3 dB better ranked in FR1 or 4.5 dB better ranked in FR2; when rangeToBestCell is configured, the cell has the highest number of beams above the threshold abs ThreshSS-BlocksConsolidation among all detected cells whose cell-ranking criterion R value is within rangeToBestCell of the cell-ranking criterion R value of the highest ranked cell. If there are multiple such cells, the cell may have the highest rank among them and the cell is at least 3 dB better ranked in FR1 or 4.5 dB better ranked in FR2 if the current serving cell is among them.

When evaluating cells for reselection, the SSB side conditions may apply to both serving and non-serving intra-frequency cells.

If Treselection timer has a nonzero value and the intra-frequency cell is satisfied with the reselection criteria, the wireless device may evaluate this intra-frequency cell for the Treselection time. If this cell remains satisfied with the reselection criteria within this duration, then the wireless device may reselect that cell.

TABLE 4.2C.2.3-1
T_{detect, NR}_{_{—}}_{Intra,} T_{measure, NR}_{_{—}}_{Intra} and T_{evaluate, NR}_{_{—}}_{Intra}

| DRX | Scaling | | | | | |
|---|---|---|---|---|---|---|
| cycle | Factor | T_{detect, NR}_{_{—}}_{Intra} | | T_{measure, NR}_{_{—}}_{Intra} | T_{evaluate, NR}_{_{—}}_{Intra} | |
| length | (N1) | [s] (number of | | [s] (number of | [s] (number of | |
| [s] | FR1 | DRX cycles) | | DRX cycles) | DRX cycles) | |
| 0.32 | 1 | 11.52 × N1 × M2 | | 1.28 × N1 × M2 | 5.12 × N1 × M2 | |
| | | (36 × N1 × M2) | | (4 × N1 × M2) | (16 × N1 × M2) | |
| 0.64 | | 17.92 × N1 | (28 × N1) | 1.28 × N1 (2 × N1) | 5.12 × N1 | (8 × N1) |
| 1.28 | | 32 × N1 | (25 × N1) | 1.28 × N1 (1 × N1) | 6.4 × N1 | (5 × N1) |
| 2.56 | | 58.88 × N1 | (23 × N1) | 2.56 × N1 (1 × N1) | 7.68 × N1 | (3 × N1) |

Note 1:
M2 = 2 if SMTC periodicity of measured intra-frequency cell > 20 ms and 1 < N_{SMTC} ≤ 4 upon more than 1 SMTC configured at the UE; M2 = 1.5 if SMTC periodicity of measured intra-frequency cell > 20 ms and N_{SMTC} = 1 upon 1 SMTC configured at the UE; otherwise M2 = 1. Where, N_{SMTC} is the number of SMTCs configured by SAN If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}_{Intra} is expected.
Note 2:
The UE is not required to meet the requirements for 2.56 s DRX cycle length for earth-moving LEO deployment.

TABLE 4.2C.2.3-2
T_{detect, NR}_{_{—}}_{Intra}_{_{—}}_{enh,} T_{measure, NR}_{_{—}}_{Intra}_{_{—}}ₑₙₕ and T_{evaluate, NR}_{_{—}}_{Intra}_{_{—}}ₑₙₕ

| | T_{detect, NR}_{_{—}}_{Intra}_{_{—}}ₑₙₕ | | T_{measure, NR}_{_{—}}_{Intra}_{_{—}}ₑₙₕ | T_{evaluate, NR}_{_{—}}_{Intra}_{_{—}}ₑₙₕ |
|---|---|---|---|---|
| DRX cycle | [s] (number of | | [s] (number of | [s] (number of |
| length [s] | DRX cycles) | | DRX cycles) | DRX cycles) |
| 0.32 | 2.56 × M2 | | 0.32 × M3 | 0.96 × M4 |
| | (8 × M2) ^{Note 1} | | (1 × M3) ^{Note 1} | (3 × M4) ^{Note 1} |
| 0.64 | 5.12 | (8) | 0.64 (1) | 1.92 (3) |
| 1.28 | 8.96 | (7) | 1.28 (1) | 3.84 (3) |
| 2.56 | 58.88 | (23) | 2.56 (1) | 7.68 (3) |

^{Note 1} :
When SMTC <= 40 ms, M2 = M3 = M4 = 1; and when SMTC > 40 ms, M2 = 2, M3 = M4 = 2.5

A wireless device may be able to identify one or more inter-frequency cells and perform SS-RSRP or SS-RSRQ measurements of the identified inter-frequency cells if carrier frequency information is provided by a serving cell of the wireless device, even if no explicit neighbor list with physical layer cell identities is provided.

If Srxlev>SnonIntraSearchP and Squal>SnonIntraSearchQ, and a distance between the wireless device and a serving cell reference location is smaller than distanceThresh, if distanceThresh is configured, and the wireless device has location information, then the wireless device may search for inter-frequency layers of higher priority at least every Thigher_priority_search.

If Srxlev≤SnonIntraSearchP or Squal≤SnonIntraSearchQ, or a distance between the wireless device and a serving cell reference location is larger than distanceThresh, if distanceThresh is configured, and the wireless device has location information, then the wireless device may search for and measure inter-frequency layers of higher, equal or lower priority in preparation for possible reselection. The requirements may apply provided that the distance exceeds the distanceThresh by a margin of 50 m.

The wireless device may be able to evaluate whether a detectable inter-frequency cell meets the reselection criteria, for a cell reselection, within

$${\sum }_{i = 1}^{{K}_{carrier}} {K}_{multi \_ SMTC , i} * {T}_{detect\_NR \_ Inter}$$

if the wireless device does not support the feature for enhanced RRM requirements or if the enhanced MeasurementLEO-r17 is not enabled, or within

$${\sum }_{i = 1}^{{K}_{carrier}} {K}_{multi \_ SMTC , i} * {T}_{detect\_NR \_ Inter}$$

is the wireless device supports the feature of enhanced RRM requirements defined, and the enhancedMeasurementLEO is enabled, if at least carrier frequency information is provided for inter-frequency neighbor cells by the serving cells when Treselection=0 provided that the reselection criteria is met by a margin of at least [5] dB in FR1 for reselections based on ranking or [6] dB in FR1 for SS-RSRP reselections based on absolute priorities or [4] dB in FR1 for SS-RSRQ reselections based on absolute priorities.

A parameter Kmulti_SMTC,i may a scaling factor for measurement of multiple SMTCs or multiple satellites

If the SMTCs do not overlap with each other: Kₘᵤₗₜᵢ_{_{SMTC}}_{,i}=1, if GEO satellites are measured on the carrier; and

$${K}_{{multi}_{SMTC ,} i} = ⌈ \frac{{N}_{LEO , i}}{{N}_{LEO , simul}} ⌉ ,$$

if LEEO satellites are measured on the carrier. If the SMTCs partially carrier; and overlap with each other: Kₘᵤₗₜᵢ_{_{SMTC}}_{,i}=N_{SMTC,overlap}, if only GEO satellite are measured on the carrier; and

$${K}_{{multi}_{SMTC ,} i} = {\sum }_{i = 1}^{{N}_{SMTC , overlap}} ⌈ \frac{{N}_{LEO , i}}{{N}_{LEO , simul}} ⌉ ,$$

if only LEO satellites are measured on the carrier. NLEO,i may be a number of LEO satellites to be measure within i-th SMTC. NLEO, simul may be a number of LEO satellites that the wireless device can measure in parallel with an SMTC, NSMTC, overlap may be a number of SMTCs that partially overlap with each other.

An inter-frequency cell, for cell reselection for satellite access, may be considered to be detectable according to the conditions based on Table 8.

TABLE 8
Conditions for inter-frequency cell
re-selection in FR1 for satellite access

| | | Minimum SSB_RP | | |
|---|---|---|---|---|
| | | dBm/SCS_{SSB} | | SSB |
| | NR operating band | SCS_{SSB} = | SCS_{SSB} = | Ês/lot |
| Parameter | groups ^{Note1} | 15 kHz | 30 kHz | dB |
| Conditions | NR_FDD_SAB_FR1_A | −124 | −121 | ≥−4 |

^{Note1} :
NR operating band groups for satellite access are defined in clause 3.5.2A.

When one or more higher priority cells are found based on a higher priority search by the wireless device, the one or more higher priority cells may be measured at least every Tmeasure,NR_Inter. If, after detecting a cell based on a higher priority search, it may be determined that reselection has not occurred then the wireless device is not required to continuously measure the detected cells to evaluate the ongoing possibility of reselection. However, a minimum measurement filtering requirements may still be met by the wireless device before the wireless device makes any determination that the wireless device may stop measuring the cell. If the wireless device detects on a NR carrier a cell whose physical identity is indicated as not allowed for that carrier in the measurement control system information of the serving cell, the wireless device may be not required to perform measurements on that cell.

For identified lower or equal priority inter-frequency cells, the wireless device may measure SS-RSRP or SS-RSRQ of the cells at least every

$${\sum }_{i = 1}^{{K}_{carrier}} {K}_{multi \_ SMTC , i} * {T}_{measure , NR \_ Inter}$$

if the wireless device does not support the feature for enhanced RRM requirements defined or if the enhancedMeasurementLEO is not enabled, or every

$${\sum }_{i = 1}^{{K}_{carrier}} {K}_{multi \_ SMTC , i} * {T}_{measure , NR \_ Inter \_ enh}$$

if the wireless device supports the feature for enhanced RRM requirements and the enhancedMeasurementLEO is enabled. If the wireless device detects on a NR carrier a cell whose physical identity is indicated as not allowed for that carrier in the measurement control system information of the serving cell, the wireless device is not required to perform measurements on that cell.t

The wireless device may filter SS-RSRP or SS-RSRQ measurements of each measured higher, lower and equal priority inter-frequency cell using at least two measurements. Within the set of measurements used for the filtering, at least two measurements may be spaced by at least Tmeasure,NR_Inter/2.

The wireless device may not consider a NR neighbor cell in cell reselection if the NR neighbor cell is indicated as not allowed in the measurement control system information of the serving cell.

For an inter-frequency cell that has been already detected, but that has not been reselected to, the filtering may be such that the wireless device may be capable of evaluating that the inter-frequency cell has met reselection criterion, for a cell reselection, within

$${\sum }_{i = 1}^{{K}_{carrier}} {K}_{multi \_ SMTC , i} * {T}_{evaluate , NR \_ Inter}$$

if the UE does not support a capability for enhanced requirements or if a network configuration for enhanced requirements is not enabled, or within

$${\sum }_{i = 1}^{{K}_{carrier}} {K}_{multi \_ SMTC , i} * {T}_{evaluate , NR \_ Inter \_ enh}$$

if the wireless device supports the feature for enhanced RRM requirements and the enhancedMeasurementLEO is enabled, when Treselection=0 as provided that the reselection criteria is met by the condition when performing equal priority reselection and: when rangeToBestCell is not configured, the cell is at least [5] dB better ranked in FR1; and when rangeToBestCell is configured, the cell has the highest number of beams above a threshold absThreshSS-BlocksConsolidation among all detected cells whose cell-ranking criterion R value is within rangeToBestCell of the cell-ranking criterion R value of the highest ranked cell. If there are multiple cells whose R value is within rangeToBestCell of the cell-ranking criterion R value of the highest ranked cell, the cell has highest rank among them.

When evaluating cells for reselection, the SSB side conditions may apply to both serving and inter-frequency cells.

If a Treselection timer has a nonzero value and an inter-frequency cell is satisfied with the reselection criteria, the wireless device may evaluate the inter-frequency cell for the Treselection time. If the cell remains satisfied with the reselection criteria within this duration, then the wireless device may reselect the cell.

The wireless device may be not expected to meet a measurement requirements for an inter-frequency carrier under DRX cycle=320 ms based on: TSMTC_intra=TSMTC_inter=160 ms. TSMTC_intra may be a periodicity of the SMTC configured for the intra-frequency carrier if no identified intra-frequency cell is in the PCI list of smtc2-LP on this intra-frequency carrier; TSMTC_intra is the periodicity of the smtc2-LP configured for the intra-frequency carrier if at least one identified intra-frequency cell is in the PCI list of smtc2-LP on this intra-frequency carrier. During PSS/SSS detection, the periodicity of the SMTC configured for the intra-frequency carrier may be assumed for TSMTC_intra. If the actual SSB transmission periodicity may be greater than the SMTC configured for the intra-frequency carrier, longer Tdetect,NR_intra is expected. TSMTC_inter may be an actual SMTC periodicity used by the inter-frequency cell being identified. During PSS/SSS detection, the periodicity of the SMTC configured for the inter-frequency carrier may be assumed for TSMTC_inter. If the actual SSB transmission periodicity is greater than the SMTC configured for the inter-frequency carrier, longer Tdetect,NR_inter may be expected; SMTC occasions configured for the inter-frequency carrier occur up to 1 ms before the start or up to 1 ms after the end of the SMTC occasions configured for the intra-frequency carrier; and SMTC occasions configured for the intra-frequency carrier and for the inter-frequency carrier occur up to 1 ms before the start or up to 1 ms after the end of the paging occasion.

The wireless device may search every layer of higher priority than a priority of serving frequency of the wireless device at least every Thigher_priority_search=(60*Nlayers) seconds. Nlayers may be a total number of higher priority, than a priority of serving frequency of the wireless device, NR carrier frequencies broadcasted in system information. In the present disclosure, performing enhanced measurement may be referred to as and/or interchangeable with applying enhanced cell reselection requirement.

In the present disclosure, enhanced measurement requirement may be referred to as and/or interchangeable with enhanced cell reselection requirement.

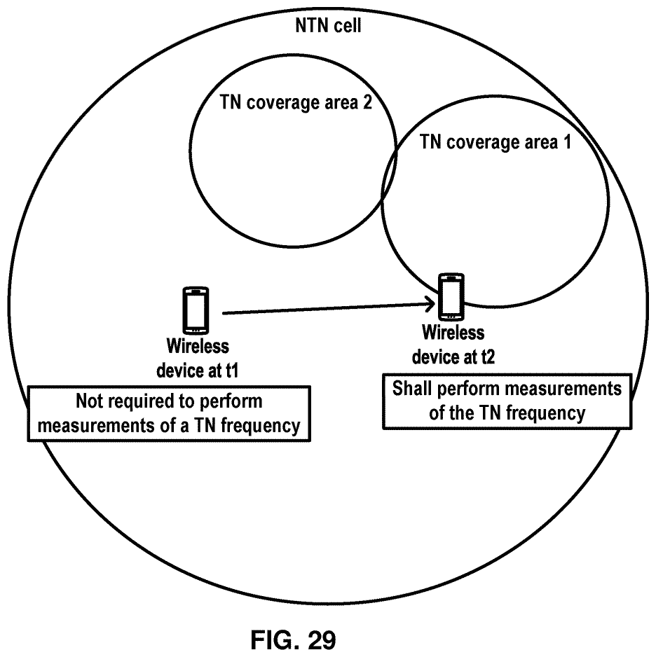

FIG. 29 illustrates an example of a wireless device performing neighbor cell measurements while camping on a non-terrestrial (NTN) cell. A wireless device, in a radio resource control (RRC) idle or inactive state, may receive, from a serving cell, a system information indicating one or more neighbor cells. The system information may comprise at least one of: SIB3, SIB4, or SIB5. The wireless device may perform a cell reselection based on performing measurements on the one or more neighbor cells. For example, based on measurement results (e.g., received signal strength, RSRP, RSRQ) of the one or more neighbor cells, the wireless device performing the cell reselection may (re-) select to a cell, of the one or more neighbor cells, that fulfils the cell reselection criteria. The wireless device may camp on the selected cell.

In an example of FIG. 29, in non-terrestrial network (NTN), an NTN cell coverage may comprise one or more terrestrial network (TN) coverage areas. A base station comprising the NTN cell may transmit, to a wireless device, a system information comprising TN coverage area information indicating one or more TN coverage areas. Each TN coverage area of the one or more TN coverage areas may be defined and/or indicated by a cell center and a radius. The TN coverage area information may comprise a first parameter indicating the cell center and a second parameter indicating the radius. The system information may indicate that each TN coverage area of the one or more TN coverage areas may be associated with one or more frequencies. The one or more frequencies may be in SIB4 and/or SIB5. The base station may transmit the SIB4 and/or the SIB5 to the wireless device.

In an example of FIG. 29, based on the TN coverage area information of a TN coverage area, the wireless device may determine whether the wireless device is in a TN coverage area of the one or more TN coverage areas. For example, the wireless device may determine that the wireless device is in the TN coverage area if a distance between a location of the wireless device and a cell center of the TN coverage area is lower than a radius of the TN coverage area. For example, the wireless device may determine that the wireless device is in the TN coverage area if the location of the wireless device is within the TN coverage area. For example, the wireless device may determine that the wireless device is in the TN coverage area if the wireless device detects a cell of a frequency that is associated with the TN coverage area. For example, the wireless device may determine the detection of the cell of the frequency based on measurement results (e.g., received signal strength, RSRP, RSRQ). The wireless device may determine the detection of the cell based on a signal power received from the cell, being higher than a threshold. Based on a frequency, of the detected cell, being associated with the TN coverage area, the wireless device may determine that the wireless device is in the TN coverage area.

In an example of FIG. 29, a wireless device may camp on the NTN cell comprising one or more TN coverage areas (e.g., TN coverage area 1, TN coverage area 2). The wireless device may not be in any of the one or more TN coverage areas. For example, at time point t1, the wireless device may not be in the one or more TN coverage areas. The wireless device not being in TN coverage area may comprise: the wireless device being in NTN-only area; and the wireless device not being in any TN coverage area of the one or more TN coverage areas. While the wireless device is not in TN coverage area, the wireless device may perform measurement for cell reselection but not perform cell reselection to a TN cell during the cell reselection procedure. The TN cell may be associated with a TN coverage area of the one or more TN coverage areas. Based on not being in TN coverage area, the wireless device performing measurements of the TN frequencies/cells associated with a TN coverage area of the one or more TN coverage areas may not be necessary. While the wireless device is not in TN coverage area, the wireless device may not be required to perform TN cell measurements.

In an example of FIG. 29, a wireless device may camp on an NTN cell comprising one or more TN coverage areas (e.g., TN coverage area 1, TN coverage area 2) and the wireless device may be in a TN coverage area of the one or more TN coverage areas. Based on being in the TN coverage area, the wireless device may perform measurements of a frequency/cell that is associated with the TN coverage area. For example, if the wireless device is in the TN coverage area 1 that the NTN cell is comprising, the wireless device may be required to perform measurements of a TN frequency of the TN coverage area 1. The TN frequency may be associated with the TN coverage area 1. Based on performing the measurements of the TN frequency, the wireless device may perform cell reselection to a TN cell of the TN frequency.

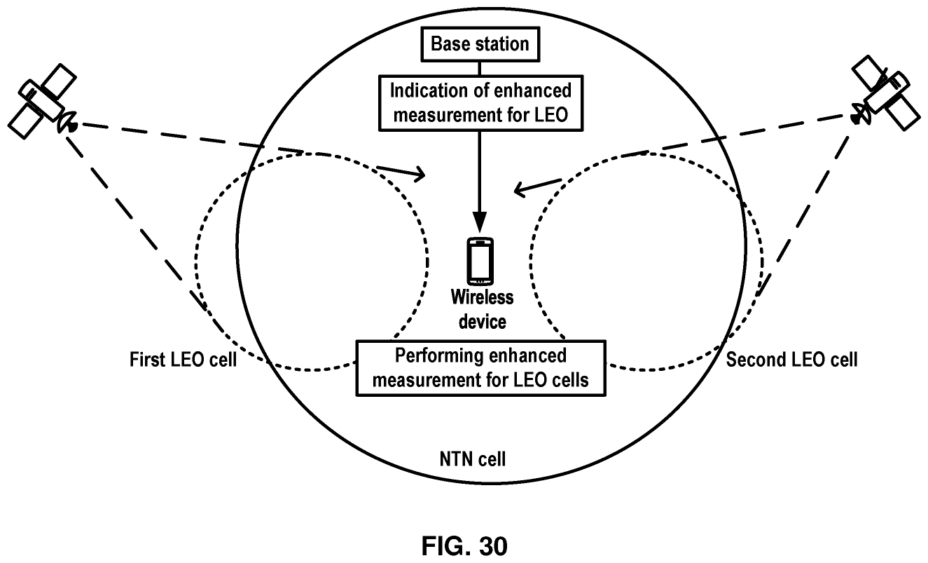

FIG. 30 illustrates an example of a wireless device performing an enhanced measurement for non-terrestrial network (NTN) low earth orbit (LEO). A wireless device, in a radio resource control (RRC) idle or inactive state, may receive, from a serving cell, a system information comprising an indication of an enhanced cell reselection requirements for NTN LEO while the wireless device is in RRC idle or inactive state. Based on receiving the indication being enabled, the wireless device may apply enhanced cell reselection requirements while performing measurement for LEO cells. The LEO cell may be an NTN cell that is served by a LEO satellite. The wireless device may determine whether the NTN cell is the LEO cell based on the LEO satellite ephemeris information. Based on applying the enhanced cell reselection requirements, the wireless device may apply an enhanced measurement period for performing measurements of LEO cells for cell reselection. The enhanced measurement period may be shorter than a normal measurement period. The enhanced measurement period may be T_{measure,NR_Inter_enh}. The normal measurement period may be T_{measure,NR_Inter}. Based on performing the measurement of LEO cells based on applying the enhanced cell reselection requirements: the wireless device may measure a LEO cell with shorter periodicity; the wireless device may evaluate whether the LEO cell meets the cell reselection criteria with shorter periodicity; and the wireless device may be able to guarantee the measurement accuracy of the LEO cell measurements.

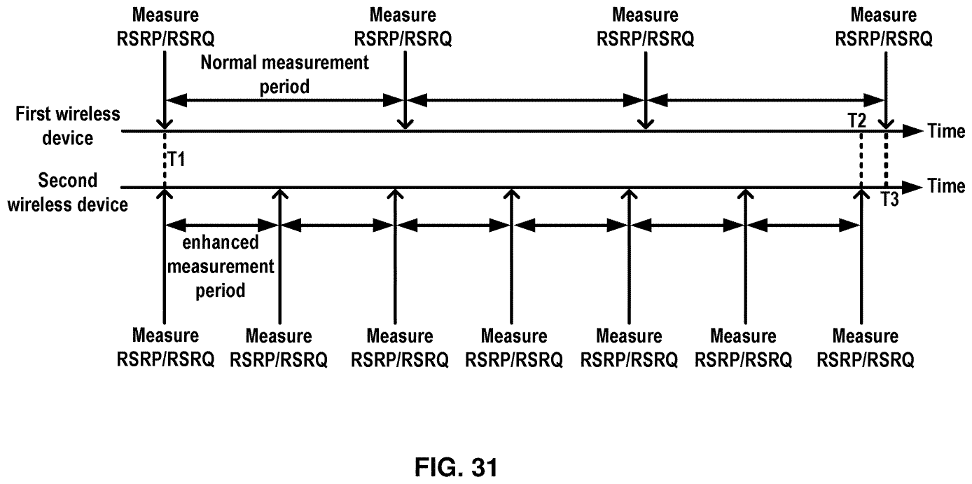

FIG. 31 illustrates an example of a first wireless device performing a normal measurement and a second wireless device performing an enhanced measurement. The first wireless device may perform the normal measurement, based on applying a normal measurement requirement, of a cell if the wireless device does not apply the enhanced cell reselection requirement and does not perform the relaxed measurement. The second wireless device may perform the enhanced measurement, based on applying an enhanced measurement requirement, of the cell if an indication of the enhanced cell reselection requirement, received from the base station, is enabled.

In an example of FIG. 31, the first wireless device may apply the normal measurement requirement, for the normal measurement, using a normal measurement period. The first wireless device may measure RSRP and/or RSRQ of the cell at time point T1. After T1, the wireless device may be required to measure RSRP and/or RSRQ of the cell at least every normal measurement period. For example, after T1, the wireless device may be required to measure RSRP and/or RSRQ of the cell before a time point that is T1 plus the normal measurement period.

In an example of FIG. 31, the second wireless device may apply the enhanced measurement requirement, for the enhanced measurement, using an enhanced measurement period. The second wireless device may measure RSRP and/or RSRQ of the cell at time point T1. After T1, the wireless device may be required to measure RSRP and/or RSRQ of the cell at least every enhanced measurement period. For example, after T1, the wireless device may be required to measure RSRP and/or RSRQ of the cell before a time point that is T1 plus the enhanced measurement period.

In an example of FIG. 31, based on applying the enhanced measurement requirements, the second wireless device may measure the RSRP and/or RSRQ of the cell more times than the first wireless device measuring, based on applying the normal measurement requirement, the RSRP and/or RSRQ of the cell. For example, the first wireless device may measure the RSRP and/or RSRQ of the cell 4 times during a first time period, from T1 to T3. The second wireless device may measure the RSRP and/or RSRQ of the cell 7 times during a second time period, from T1 to T2. The second time period is shorter than the first time period.

In an example, a wireless device performing a measurement based on applying an enhanced measurement requirements may measure the RSRP and/or RSRQ of a cell more frequently than the wireless device performing the measurement based on applying a normal measurement requirements. The wireless device performing the measurement based on applying the enhanced measurement requirements may cause more power consumption of the wireless device than the wireless device performing the measurement based on applying the normal measurement requirements.

A wireless device may perform measurements of a cell. Performing, by the wireless device, the measurements of the cell may be based on a requirement for the measurements of the cell. For example, a wireless device may be required to perform measurements of a cell (e.g., based on a condition). The wireless device may perform the measurements of the cell based on the requirement. The cell may be a TN cell or NTN cell. The NTN cell may comprise a GEO cell and a LEO cell. The condition may indicate whether the wireless device is in a TN coverage area. For example, a wireless device may be required to perform measurements of a TN cell based on the wireless device being in a TN coverage area. The wireless device may perform measurement of the TN cell. For example, the wireless device may perform measurements of the TN cell based on the requirement of the wireless device being required to perform the measurement of the TN cell.

In present disclosure, measurement applying enhanced measurement requirements may be referred to as and/or interchangeable with enhanced measurement and/or like.

In an example of FIG. 31, the first wireless device may perform a relaxed measurement and a second wireless device may perform a normal measurement. The first wireless device may perform the relaxed measurement for a cell based on a first condition for performing the relaxed measurement being fulfilled. The second wireless device may perform the normal measurement based on: the configuration for performing the relaxed measurement not being configured for the wireless device; or the configuration for performing the relaxed measurement being configured for the wireless device and the first condition not being fulfilled.

In an example of FIG. 31, the first wireless device may apply relaxed measurement requirement, for the relaxed measurement, using a relaxed measurement period. The first wireless device may measure RSRP and/or RSRQ of the cell at time point T1. After T1, the wireless device may be required to measure RSRP and/or RSRQ of the cell at least every relaxed measurement period. For example, after T1, the wireless device may be required to measure RSRP and/or RSRQ of the cell before a time point that is T1 plus the relaxed measurement period.

In an example of FIG. 31, the second wireless device may apply a normal measurement requirement, for the normal measurement, using a normal measurement period. The second wireless device may measure RSRP and/or RSRQ of the cell at time point T1. After T1, the wireless device may be required to measure RSRP and/or RSRQ of the cell at least every normal measurement period. For example, after T1, the wireless device may be required to measure RSRP and/or RSRQ of the cell before a time point that is T1 plus the normal measurement period.

In an example of FIG. 31, based on applying the relaxed measurement requirements, the first wireless device may measure the RSRP and/or RSRQ of the cell less times than the second wireless device measuring, based on applying the normal measurement requirement, the RSRP and/or RSRQ of the cell. For example, the first wireless device may measure the RSRP and/or RSRQ of the cell 4 times during a first time period, from T1 to T3. The second wireless device may measure the RSRP and/or RSRQ of the cell 7 times during a second time period, from T1 to T2. The first time period is longer than the second time period.

In an example, a wireless device performing a relaxed measurement based on applying a relaxed measurement requirements may measure the RSRP and/or RSRQ of a cell less frequently than the wireless device performing the measurement based on applying a normal measurement requirements. The wireless device performing the measurement based on applying the relaxed measurement requirements may cause less power consumption of the wireless device than the wireless device performing the measurement based on applying the normal measurement requirements. The wireless device may perform the relaxed measurement based on a first condition for performing the relaxed measurement being fulfilled. The first condition being fulfilled may indicate: that the wireless device is near cell center of a serving cell of the wireless device; that the wireless device is not at cell edge of the serving cell of the wireless device; and/or the wireless device is with low mobility.

A wireless device may perform measurements of a cell. Performing, by the wireless device, the measurements of the cell may be based on a requirement for the measurements of the cell. For example, a wireless device may be required to perform measurements of a cell (e.g., based on a second condition). The wireless device may perform the measurements of the cell based on the requirement. The cell may be a TN cell or NTN cell. The NTN cell may comprise a GEO cell and a LEO cell. The second condition may indicate whether the wireless device is in a TN coverage area. For example, a wireless device may be required to perform measurements of a TN cell based on the wireless device being in a TN coverage area. The wireless device may perform measurement of the TN cell. For example, the wireless device may perform measurements of the TN cell based on the requirement of the wireless device being required to perform the measurement of the TN cell.

In present disclosure, measurement applying relaxed measurement requirements may be referred to as and/or interchangeable with relaxed measurements and/or like. For example, a wireless device may apply the relaxed measurement requirements. Based on applying the relaxed measurement requirement, the wireless device may perform the relaxed measurement.

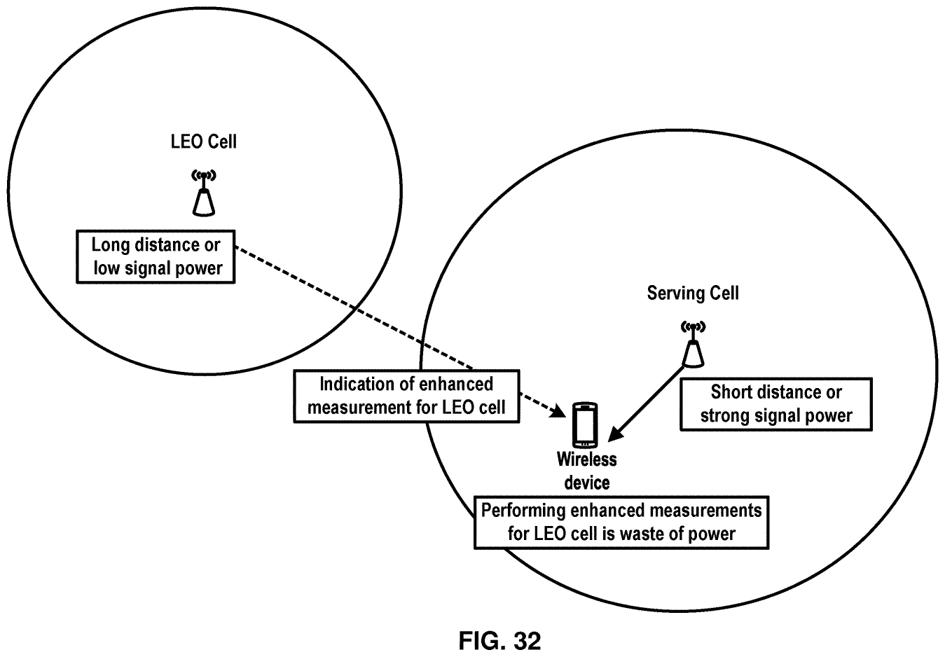

FIG. 32 illustrates an example of a wireless device performing enhanced measurement of LEO cell. A wireless device may perform measurement of a neighbor cell for, for example, cell reselection. A base station (e.g., a serving cell of the base station) may transmit information indicating the measurement of the neighbor cell. For example, a wireless device may receive from a serving cell an indication of enhanced measurement requirement for LEO cell. The wireless device may apply the enhanced measurement requirement based on the indication. The wireless device may perform enhanced measurement, of LEO cell, for cell reselection.

In an example of FIG. 32, the wireless device may be under some circumstances. The wireless device performing the enhanced measurement may be unnecessary. For example, the wireless device may be located in area far from the neighbor cell, the LEO cell. A received signal power from the neighbor cell, the LEO cell, may be low. The wireless device in the area may not have a chance to select the LEO cell for cell reselection. For example, the wireless device may be located in a center area of the serving cell. A received signal power from the serving cell may be high. The wireless device in the area may not have a chance to select one of neighboring cell for cell reselection. For example, the wireless device may move at low mobility or not move. The wireless device with low mobility may not have a chance to select one of neighboring cell for cell reselection. Performing, by the wireless device, the enhanced measurement under some circumstances may be unnecessary. It causes waste of power of the wireless device and interruption to measure other cells (e.g., the serving cell or TN cells).

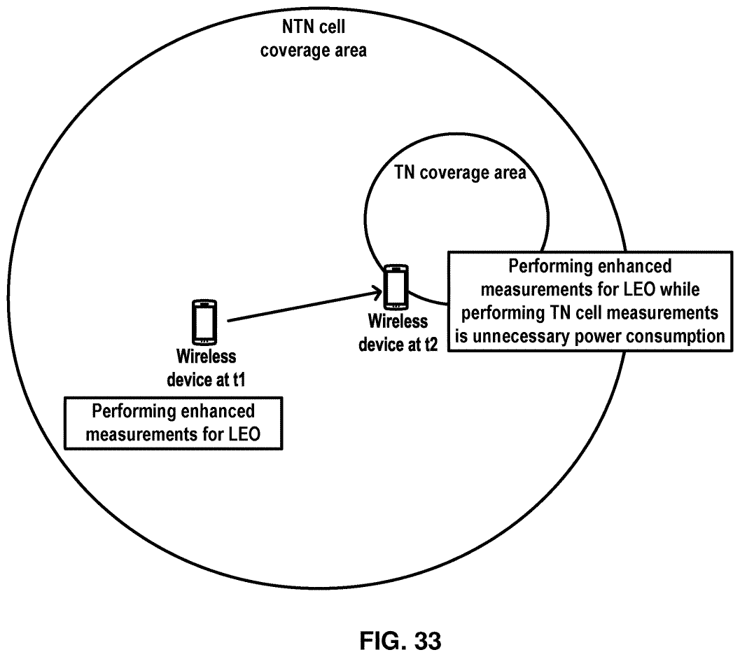

FIG. 33 illustrates an example of a wireless device performing neighbor cell measurements while entering a TN coverage area. The wireless device, in a radio resource control (RRC) idle or inactive state, may camp on an NTN cell. The wireless device may receive, from the NTN cell, one or more system information blocks (SIBs) indicating: an indication of an enhanced measurement; a coverage area; and one or more neighbor cells. For example, SIB3, SIB4, and/or SIB5 may comprise the one or more neighbor cells. The one or more neighbor cells may comprise: one or more LEO cells; and one or more TN cells associated with the TN coverage area.

In an example of FIG. 33, at time point t1, the wireless device may not be in the TN coverage area that the NTN cell is comprising. The wireless device may perform measurements of the one or more neighbor cells for a cell reselection. Based on not being in TN coverage area, the wireless device may not perform measurements of the one or more TN cells. Based on the indication of the enhanced measurement being enabled, the wireless device may perform measurements of the one or more LEO cells based on applying the enhanced measurement requirements.

In an example of FIG. 33, the wireless device may be in the TN coverage area. Based on being in the TN coverage area, the wireless device may perform measurements of the one or more TN cells associated with the TN coverage area. According to existing technologies, based on the indication of the enhanced measurement being enabled, the wireless device may apply the enhanced measurement requirements for the measurements of the one or more LEO cells while the wireless device is in the TN coverage area. The wireless device in the TN coverage area may camp on a TN cell of the TN coverage area based on performing the measurements of the one or more TN cells. The wireless device may consider that the one or more TN cells have higher priority for the cell reselection than the one or more LEO cells when the wireless device is in the TN coverage area. The wireless device, in the TN coverage area and performing measurements of the one or more TN cells, applying the enhanced measurement requirements for the measurements of one or more LEO cells may be unnecessary power consumption. Applying the enhanced measurement requirement for the measurement of the one or more LEO cells may cause more power consumption of the wireless device than applying the normal measurement requirement for the measurement of the one or more LEO cells.

A wireless device may perform a measurement of a neighbor cell for a cell reselection. A base station (e.g., a serving cell) may transmit information indicating the measurement of the neighbor cell. For example, a wireless device may receive, from a serving cell, an indication of an enhanced measurement requirement for LEO cell. The wireless device may apply the enhanced measurement requirement based on the indication. The wireless device may perform enhanced measurement, of LEO cell, for cell reselection. The wireless device performing the enhanced measurement may not have a chance to reselect the LEO cell when the wireless device is under some circumstances. For example, the circumstances may be associated with a location of the wireless device; or a signal strength from a serving cell or the LEO cell; speed of the wireless device; a type of the serving cell or the LEO cell (e.g., earth moving cell, (quasi-) earth fixed cell). Performing, by the wireless device under the circumstances, the measurement, based on applying the enhanced measurement requirement, for cell reselection may be unnecessary. It causes waste of power of the wireless device and interruption to measure other cells (e.g., the serving cell or TN cells).

The implementation of the existing technologies may result in unnecessary power consumption of a wireless device when the wireless device is in a TN coverage area and an enhanced measurement requirement is enabled. For example, a wireless device may receive, from a serving cell, a system information indicating one or more neighbor cells. Based on the system information, the wireless device may perform measurements of the one or more neighbor cells. The serving cell may be an NTN cell. The system information may further indicate a list of the TN coverage areas of the one or more TN cells. Coverage areas of the one or more TN cells may be located in a coverage of the NTN cell. The one or more neighbor cells may comprise: one or more LEO cells; and one or more TN cells, the system information may indicate an enhanced measurement requirements for measurement of the one or more LEO cells. In existing technologies, the wireless device receiving the system information may perform measurement of the one or more LEO cells by applying the enhanced measurement requirements while the wireless device camps on the serving cell (e.g., the NTN cell) transmitting the system information. The wireless device may initiate or perform measurements of the one or more TN cells when the wireless device is in one of the one or more TN coverage areas. In existing technologies, for cell reselection, the wireless device and/or a network may prioritize a TN cell over a LEO cell.

Performing the measurements of the one or more LEO cells, applying the enhanced measurement requirements may cause more power consumption than performing the measurements applying normal measurement requirements. The measurement of the one or more LEO cells, applying the enhanced measurement requirements may be unnecessary while the wireless device is in a TN coverage area of the list of the TN coverage areas.

Example embodiments enable a wireless device receiving an indication of an enhanced measurement requirement to determine, based on one or more conditions, whether to apply the enhanced measurement requirement, for a measurement, for one or more LEO cells, for cell reselection. The one or more conditions may be associated with at least one of: a cell coverage area; a location of a wireless device; or a received signal power from a serving cell; a received signal strength from a LEO cell; a mobility (or speed) of a wireless device; or a type of the LEO cell (e.g., earth moving cell, (quasi-)earth fixed cell. For example, a wireless device may determine to apply the enhanced measurement requirement, for the measurement, based on the one or more conditions being fulfilled. A wireless device may determine not to apply the enhanced measurement requirement, for the measurement, based on the one or more conditions not being fulfilled. Based on applying the enhanced measurement requirement, the wireless device may perform enhanced measurement for the measurement of LEO cell for, for example, cell reselection. Based on not applying the enhanced measurement requirement, the wireless device may not perform enhanced measurement for the measurement of LEO cell for cell reselection. For example, the wireless device not performing the enhanced measurement may perform normal measurement or relaxed measurement for the measurement, of LEO cell, for cell reselection. It avoids waste of power consumption of the wireless device due to the unnecessary enhance measurement and interruption on measurement of other cells (e.g., the serving cell or TN cells or GEO cell).

In example embodiments, the one or more conditions may be associated with a TN coverage area. For example, a wireless device receiving an indication of enhanced measurement requirement may determine whether to apply an enhanced measurement requirement, for a measurement, for one or more LEO cells based on the wireless device being in a TN coverage area. For example, a wireless device, in an RRC idle or inactive state, may determine whether to apply an enhanced measurement requirement based on whether the wireless device is in a TN coverage area of a list of TN coverage areas. The wireless device may receive, via a non-terrestrial network (NTN) cell, one or more system information blocks (SIBs) indicating: an indication of the enhanced measurement requirement, for a measurement, for one or more low earth orbit (LEO) cells while the wireless device is in the RRC idle or inactive state; and the list of TN coverage areas. Each TN coverage area of the list of TN coverage areas may be associated with one or more TN frequencies. The one or more SIBs may indicate the one or more TN frequencies.

In example embodiments, a wireless device receiving an indication of an enhanced measurement requirement may determine to apply the enhanced measurement requirement based on the wireless device not being in the TN coverage area. The wireless device may not perform measurements of one or more TN cells associated with the TN coverage area while the wireless device is not in the TN coverage area. The wireless device may determine not to apply the enhanced measurement requirement based on the wireless device being in the TN coverage area. The wireless device may perform measurements of the one or more TN cells associated with the TN coverage area while the wireless device is in the TN coverage area. For example, it prevents the wireless device to apply the enhance measurement requirement, for the measurement, for the one or more LEO cells while the wireless device is in the TN coverage area and/or performing measurements of one or more TN cells. It reduces unnecessary power consumption to perform measurements, applying the enhancement measurement, of the one or more LEO cell.

In example embodiments, a wireless device, in a radio resource control (RRC) idle or inactive state, receiving an indication of enhanced measurement requirement may determine whether to apply an enhanced measurement requirement, for a measurement, for one or more LEO cells based whether the wireless device is in a TN coverage area. The wireless device may apply the enhanced measurement requirement, for the measurement, for the one or more LEO cells based on the wireless device not being in the TN coverage area. The wireless device may not apply the enhanced measurement requirement, for the measurement, for one or more LEO cells based on the wireless device being in the TN coverage area. The wireless device may perform measurements of one or more TN cells of a TN frequency that is associated with the TN coverage area while the wireless device is in the TN coverage area. Based on performing the measurement applying the enhanced measurement requirement, the wireless device may select a cell to perform cell reselection. The wireless device may camp on the cell. The wireless device may transmit an uplink packet to the cell. Based on performing the measurement not applying the enhanced measurement requirement, the wireless device may select a cell to perform cell reselection. The wireless device may camp on the cell. The wireless device may transmit an uplink packet to the cell.

In example embodiments, a wireless device, in an RRC idle or inactive state, receiving an indication of enhanced measurement requirement may determine whether to apply an enhanced measurement requirement based on whether the wireless device is in a TN coverage area of a list of TN coverage areas. The wireless device may receive, via a non-terrestrial network (NTN) cell, one or more system information blocks (SIBs) indicating: an indication of the enhanced measurement requirement, for a measurement, for one or more low earth orbit (LEO) cells while the wireless device is in the RRC idle or inactive state; and the list of TN coverage areas. Each TN coverage area of the list of TN coverage areas may be associated with one or more TN frequencies. The one or more SIBs may indicate the one or more TN frequencies. The wireless device may apply the enhanced measurement requirement, for the measurement, for the one or more LEO cells based on: the wireless device not being in the TN coverage area; and the indication of the enhanced measurement requirement being enabled. The wireless device may not apply the enhanced measurement requirement, for the measurement, for one or more LEO cells based on the wireless device being in the TN coverage area while the wireless device camps on the NTN cell and performs the measurements of the one or more LEO cells. Based on performing the measurement applying the enhanced measurement requirement, the wireless device may select a cell to perform cell reselection. The wireless device may camp on the cell. The wireless device may transmit an uplink packet to the cell. Based on performing the measurement not applying the enhanced measurement requirement, the wireless device may select a cell to perform cell reselection. The wireless device may camp on the cell. The wireless device may transmit an uplink packet to the cell.

In an example embodiment, the one or more conditions may be associated with a mobility (or speed) of a wireless device. For example, a wireless device receiving an indication of enhanced measurement requirement may determine whether to apply an enhanced measurement requirements, for a measurement, for one or more LEO cells based on a mobility state of the wireless device. For example, the wireless device may determine to apply the enhanced measurement requirements based on: the wireless device being in a high mobility state; the wireless device being in a normal mobility state; the wireless device not being in a low mobility state; or the wireless device not being in/with a low mobility. The wireless device may determine to not apply the enhanced measurement requirements based on: the wireless device being the TN coverage area; and the wireless device not being in a high mobility state. Determination of the mobility state of the wireless device may be based on: a variation of a location of the wireless device; a variation of a signal strength (e.g., RSRP, RSRQ) of a cell measured by the wireless device; or a number of cell reselections during a time period (e.g., TCRmax). For example, the mobility state of the wireless device may be high mobility state based on: the variation of the location of the wireless device being higher than a threshold; the variation of the signal strength of the cell measured by the wireless device being higher than a threshold; or the number of cell reselections during the time period being higher than a threshold (e.g., NCR_H). Based on performing the measurement not applying the enhanced measurement requirement, the wireless device may select a cell to perform cell reselection. The wireless device may camp on the cell. The wireless device may transmit an uplink packet to the cell.

In an example embodiment, the one or more conditions may be associated with a type of a neighbor cell. a wireless device receiving an indication of enhanced measurement requirement may determine whether to apply an enhanced measurement requirements, for a measurement, for one or more LEO cells based on a type of the one or more LEO cells. For example, the wireless device may determine not to apply the enhanced measurement requirements for the one or more LEO cells based on the one or more LEO cells being earth moving cell. For example, the wireless device may determine to perform relaxed measurement for the one or more LEO cells based on the one or more LEO cells being earth moving cell. For example, the wireless device may determine not to apply the enhanced measurement requirements for the one or more LEO cells based on the one or more LEO cells being (quasi-)earth fixed cell. For example, the wireless device may determine to perform relaxed measurement for the one or more LEO cells based on the one or more LEO cells being (quasi-)earth fixed cell. Based on performing the measurement not applying the enhanced measurement requirement, the wireless device may select a cell to perform cell reselection. The wireless device may camp on the cell. The wireless device may transmit an uplink packet to the cell. Based on performing the relaxed measurement, the wireless device may select a cell to perform cell reselection. The wireless device may camp on the cell. The wireless device may transmit an uplink packet to the cell.

In an example embodiment, the one or more conditions may be associated with a time period after entering a TN coverage area. For example, a wireless device receiving an indication of enhanced measurement requirement may determine whether to apply an enhanced measurement requirement, for a measurement, for one or more LEO cells based on an elapsed time after the wireless device entering a TN coverage area. For example, the wireless device may determine not to apply the enhanced measurement requirement based on the wireless device being in the TN coverage area. The wireless device may determine to apply the enhanced measurement requirement based on the wireless device not camping on a TN cell more than a time period after entering the TN coverage area. Based on performing the measurement applying the enhanced measurement requirement, the wireless device may select a cell to perform cell reselection. The wireless device may camp on the cell. The wireless device may transmit an uplink packet to the cell. Based on performing the measurement not applying the enhanced measurement requirement, the wireless device may select a cell to perform cell reselection. The wireless device may camp on the cell. The wireless device may transmit an uplink packet to the cell.

In an example embodiment, the one or more conditions may be associated with a received signal strength of a cell. For example, a wireless device receiving an indication of enhanced measurement requirement may determine whether to apply an enhanced measurement requirement, for a measurement, for one or more LEO cells based on a received signal strength of a cell. The cell may be a serving cell of the wireless device or an LEO cell. The wireless device may determine not to apply the enhanced measurement requirement, for the measurement, for the one or more LEO cells based on the received signal strength of the serving cell being higher than a threshold. The wireless device may determine to apply the enhanced measurement requirement, for the measurement, for the one or more LEO cells based on the received signal strength of the serving cell being lower than a threshold. The wireless device may determine to apply the enhanced measurement requirement, for the measurement, for the one or more LEO cells based on the received signal strength of the LEO cell being higher than a threshold.

The wireless device may perform the measurements on the one or more LEO cells. The wireless device may apply the enhanced measurement requirement, for the measurement, for the one or more LEO cells based on: the wireless device not being in the TN coverage area; and the indication of the enhanced measurement requirement being enabled. The wireless device may not apply the enhanced measurement requirement, for the measurement, for one or more LEO cells based on the wireless device being in the TN coverage area while the wireless device camps on the NTN cell and performs the measurements of the one or more LEO cells. The wireless device may select a cell to perform a cell reselection based on performing the measurements on the one or more LEO cells. Based on performing the cell reselection to the cell, the wireless device may camp on the cell. The cell may be a TN cell. The wireless device may transmit an uplink packet to the cell.

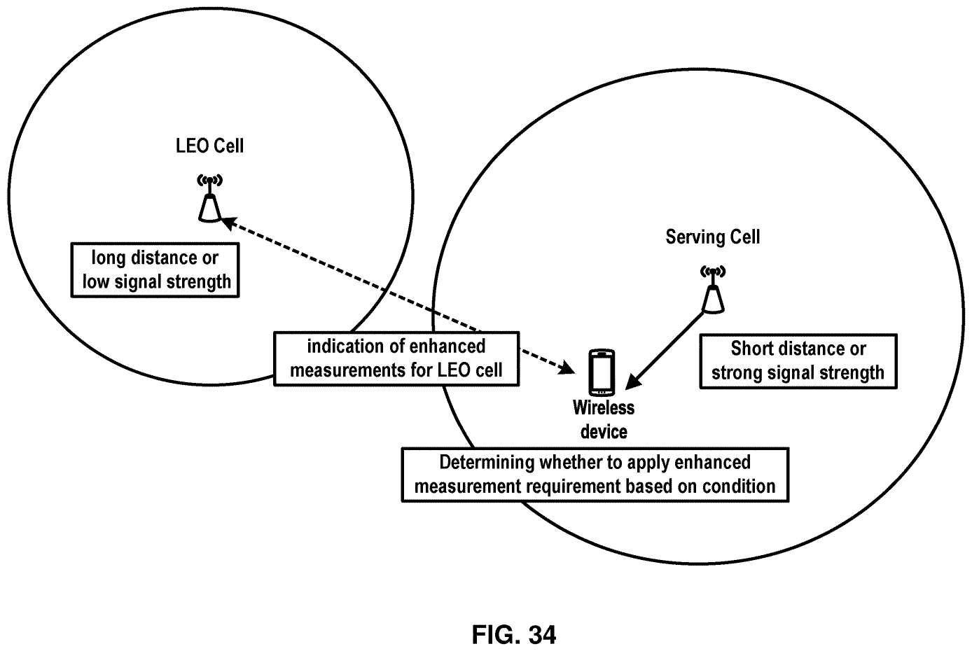

FIG. 34 illustrates an example embodiment of a wireless device determining whether to apply an enhanced measurement requirements based on one or more conditions. A wireless device may perform measurement of a neighbor cell for cell reselection. A base station (e.g., a serving cell) may transmit information indicating the measurement of the neighbor cell. For example, a wireless device may receive, from a serving cell, an indication of enhanced measurement for LEO cell. The wireless device receiving the indication may determine whether to apply an enhanced measurement requirement based on one or more conditions. The one or more condition may be associated with at least one of: a cell coverage area; a location of a wireless device; a received signal power from a serving cell; or a received signal power from a cell; a mobility (or speed) of a wireless device; a type of the LEO cell (e.g., earth moving cell, (quasi-)earth fixed cell). For example, the cell coverage area may be a TN coverage area. The wireless device receiving the indication may determine not to apply the enhanced measurement requirement based on the wireless device being in the TN coverage area. The wireless device receiving the indication may determine to apply the enhanced measurement requirement based on the wireless device not being in the TN coverage area.

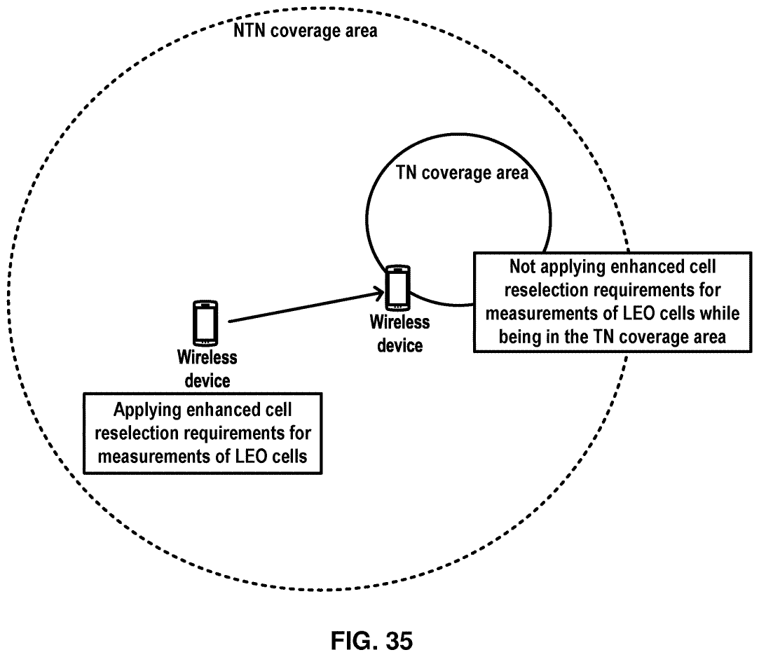

FIG. 35 illustrates an example embodiment of a wireless device determining whether to apply an enhanced measurement requirements based on whether the wireless device is in a TN coverage area. The wireless device, in a radio resource control (RRC) idle or inactive state, may apply an enhanced measurement requirements, for a measurement, for one or more LEO cells based on: an indication of the enhanced measurement requirements being enabled; and the wireless device not being in the TN coverage area. While the wireless device is in the TN coverage area, the wireless device may determine not to apply the enhanced measurement requirements, for the measurement, for the one or more LEO cells based on the wireless device being in the TN coverage area. Determining that the wireless device is in the TN coverage area may be based on: a distance between a location of the wireless device and a cell center of the TN coverage area being lower than a radius of the TN coverage area; the location of the wireless device being within the coverage of the TN coverage area; or the wireless device detecting one or more cells associated with the TN coverage area. The wireless device detecting a cell may comprise that wireless device.

In an example of FIG. 35, a wireless device may determine whether to perform a relaxed measurements based on whether the wireless device is in a TN coverage area. The wireless device, in a radio resource control (RRC) idle or inactive state, may perform a relaxed measurements for one or more TN cells based on: a first condition to perform the relaxed measurements being fulfilled; and the wireless device not being in the TN coverage area. While the wireless device is in the TN coverage area and the first condition is fulfilled, the wireless device may determine not to perform the relaxed measurements for the one or more TN cells based on the wireless device being in the TN coverage area. Determining that the wireless device is in the TN coverage area may be based on: a distance between a location of the wireless device and a cell center of the TN coverage area being lower than a radius of the TN coverage area; the location of the wireless device being within the coverage of the TN coverage area; or the wireless device detecting one or more cells associated with the TN coverage area.

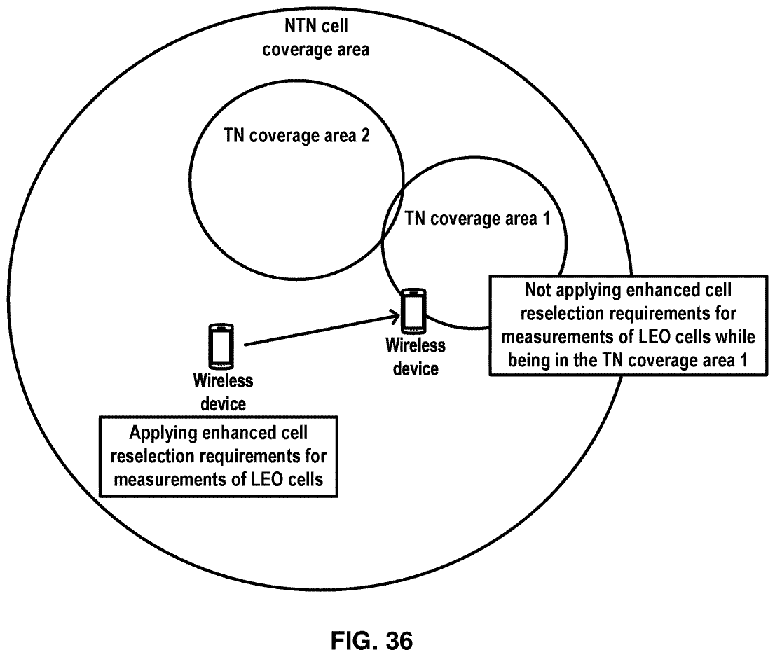

FIG. 36 illustrates an example embodiment of a wireless device determining whether to apply an enhanced measurement requirements based on whether the wireless device is in a TN coverage area of a list of TN coverage areas. The wireless device, in a radio resource control (RRC) idle or inactive state, may receive, via an NTN cell, one or more system information blocks (SIBs) indicating: an indication of an enhanced measurement requirements; and the list of TN coverage areas. Each TN coverage area of the list of TN coverage areas may be associated with one or more TN frequencies. The one or more SIBs may indicate the one or more TN frequencies. For example, SIB4 and/or SIB5 may indicate the one or more TN frequencies. The one or more SIBs may indicate the one or more LEO cells. The one or more SIBs may indicate each TN coverage area of the list of TN coverage areas. Each of the list of TN coverage areas may be defined based on a cell center and a radius.

In an example of FIG. 36, while the wireless device camps on the NTN cell in the RRC idle or inactive state and performs the measurements, the wireless device may determine not to apply the enhanced measurement requirements, for the measurement, for the one or more LEO cells. For example, when the wireless device is in TN coverage area 1 which is one of the list of TN coverage areas: the wireless device may perform measurements on one or more cells associated with the TN coverage area 1; and the wireless device may determine not to apply the enhanced measurement requirements for the measurements of the one or more LEO cells. The wireless device may determine to apply the enhanced measurement requirements for the measurement of the one or more LEO cells based on the wireless device not being in any TN coverage area of the list of TN coverage areas. Based on performing the measurement of the one or more LEO cells, the wireless device may select a cell to perform a cell reselection. The cell may be a TN cell. The wireless device may camp on the cell based on performing the cell reselection to the cell. The wireless device may transmit an uplink packet to the cell.

In an example embodiment, the wireless device may determine not to apply the enhanced measurement requirement based on the wireless device being in the TN coverage area regardless of whether the indication of the enhanced measurements requirement is enabled or not.

In an example of FIG. 36, a wireless device may determine whether to perform a relaxed measurements based on whether the wireless device is in a TN coverage area of a list of TN coverage areas. The wireless device, in a radio resource control (RRC) idle or inactive state, may receive, via an NTN cell, one or more system information blocks (SIBs) indicating: a configuration indicating a first condition to perform relaxed measurements; and the list of TN coverage areas. Each TN coverage area of the list of TN coverage areas may be associated with one or more TN frequencies. The one or more SIBs may indicate the one or more TN frequencies. For example, SIB4 and/or SIB5 may indicate the one or more TN frequencies. The one or more SIBs may indicate the one or more LEO cells. The one or more SIBs may indicate the one or more TN cells. The one or more SIBs may indicate each TN coverage area of the list of TN coverage areas. Each of the list of TN coverage areas may be defined based on a cell center and a radius.

In an example of FIG. 36, while the wireless device camps on the NTN cell in the RRC idle or inactive state, performs the measurements, and the first condition is fulfilled the wireless device may determine not to perform the relaxed measurements for the one or more TN cells. For example, when the wireless device is in TN coverage area 1 which is one of the list of TN coverage areas: the wireless device may perform measurements on one or more cells associated with the TN coverage area 1; and the wireless device may determine not to perform the relaxed measurements for the one or more TN cells. The wireless device may determine to perform the relaxed measurements for the one or more TN cells based on the wireless device not being in any TN coverage area of the list of TN coverage areas. Based on performing the measurement of the one or more LEO cells, the wireless device may select a cell to perform a cell reselection. The cell may be a TN cell. The wireless device may camp on the cell based on performing the cell reselection to the cell. The wireless device may transmit an uplink packet to the cell.

In an example embodiment, the wireless device may determine not to perform the relaxed measurements based on the wireless device being in the TN coverage area regardless of whether the first condition is fulfilled or not.

In an example, a wireless device may determine that the wireless device is in a TN coverage area based on at least one of: a received signal strength of a TN cell or a location of the wireless device. For example, a wireless device may determine the wireless device being in a TN coverage area based on: distance between a location of the wireless device and a center of the TN coverage area being lower than a radius of the TN coverage area; the location of the wireless device being within the TN coverage area; or detecting a cell of a TN frequency that is associated with the TN coverage area. For example, the wireless device may determine the detection of the cell of the frequency based on measurement results (e.g., received signal strength, RSRP, RSRQ). The wireless device may determine the detection of the cell based on a signal power received from the cell, being higher than a threshold. Based on a frequency, of the detected cell, being associated with the TN coverage area, the wireless device may determine that the wireless device is in the TN coverage area.

In example, a wireless device may determine that the wireless device is not in a TN coverage area based on at least one of: a received signal power of a TN cell or a location of the wireless device. For example, a wireless device is not in a TN coverage area based on: distance between a location of the wireless device and a center of the TN coverage area being higher than a radius of the TN coverage area; the location of the wireless device not being within the TN coverage area; the location of the wireless device being out of the TN coverage area; or the wireless device not detecting a cell of a TN frequency that is associated with the TN coverage area for a time period. For example, the wireless device may determine not detecting the cell of the frequency based on measurement results (e.g., received signal strength, RSRP, RSRQ). The wireless device may determine not detecting the cell based on a signal power received from the cell, being lower than a threshold. Based on a frequency, of the not detected cell, being associated with the TN coverage area, the wireless device may determine that the wireless device is not in the TN coverage area.

In example, a first condition, to perform a relaxed measurements, may comprise a low mobility condition and/or a not-at-cell edge condition. The condition may be a criterion. A wireless device receiving a system information indicating the first condition may perform the relaxed measurements based on the first condition being fulfilled. The first condition is fulfilled based on at least one of the low mobility condition or the not-at-cell edge condition being fulfilled. The first condition is not fulfilled based on both the low mobility condition and the not-at-cell edge condition being fulfilled.

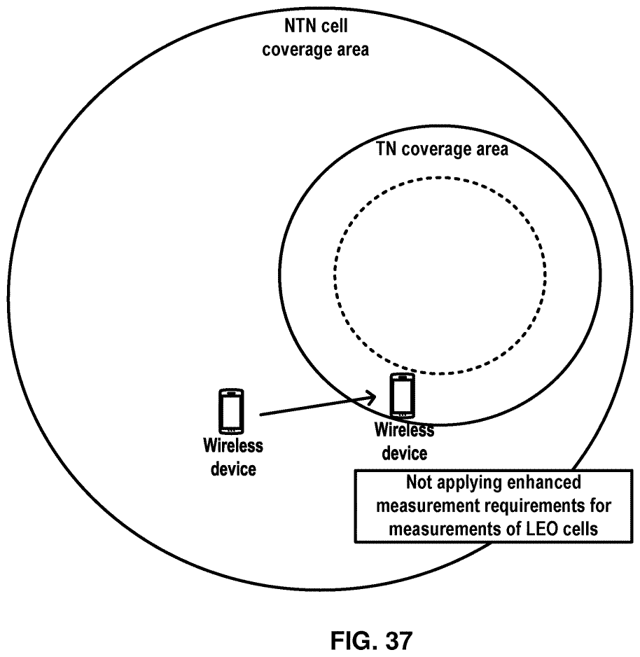

FIG. 37 illustrates an example embodiment of a wireless device determining whether to apply an enhanced measurement requirements based on a serving cell of the wireless device. A wireless device, in an RRC idle or inactive state, may receive, via a non-terrestrial network (NTN) cell, one or more system information blocks (SIBs) indicating: an indication of the enhanced measurement requirement, for a measurement, for one or more low earth orbit (LEO) cells while the wireless device is in the RRC idle or inactive state; and a TN coverage area. The TN coverage area may be associated with one or more TN frequencies. The one or more SIBs may indicate the one or more TN frequencies. The wireless device may enter the TN coverage area. The wireless device may determine not to apply the enhanced measurement requirement, for the measurement, for the one or more LEO cells while the wireless device camps on the NTN cell and is in the TN coverage area.

In an example of FIG. 37, the wireless device may perform cell reselection to a TN cell, of one or more TN cells, of a frequency associated with the TN coverage area based on performing measurements of the one or more TN cells. The wireless device may camp on the TN cell based on performing cell reselection to the TN cell. Based on camping on the TN cell, the wireless device may determine whether to apply the enhanced measurement requirement, for the measurement, for the one or more LEO cells based on the indication, received from the NTN cell, of the enhanced measurement requirement being enabled. For example, the wireless device may determine not to apply the enhanced measurement requirement, for measurement, for the one or more LEO cells based on the wireless device camping on the TN cell.

In an example of FIG. 37, the wireless device may determine whether to perform a relaxed measurements based on a serving cell of the wireless device. A wireless device, in an RRC idle or inactive state, may receive, via a non-terrestrial network (NTN) cell, one or more system information blocks (SIBs) indicating: a configuration indicating a first condition to perform relaxed measurements while the wireless device is in the RRC idle or inactive state; and a TN coverage area. The TN coverage area may be associated with one or more TN frequencies. The one or more SIBs may indicate the one or more TN frequencies. The wireless device may enter the TN coverage area. The wireless device may determine not to perform the relaxed measurements for the one or more TN cells while the wireless device camps on the NTN cell and is in the TN coverage area even if the first condition is fulfilled.

In an example of FIG. 37, the wireless device may perform cell reselection to a TN cell, of one or more TN cells, of a frequency associated with the TN coverage area based on performing measurements of the one or more TN cells. The wireless device may camp on the TN cell based on performing cell reselection to the TN cell. Based on camping on the TN cell, the wireless device may determine whether to perform the relaxed measurements for the one or more TN cells while the first condition is fulfilled. For example, while the first condition is fulfilled, the wireless device may determine not to perform the relaxed measurements for the one or more TN cells based on the wireless device camping on the TN cell.

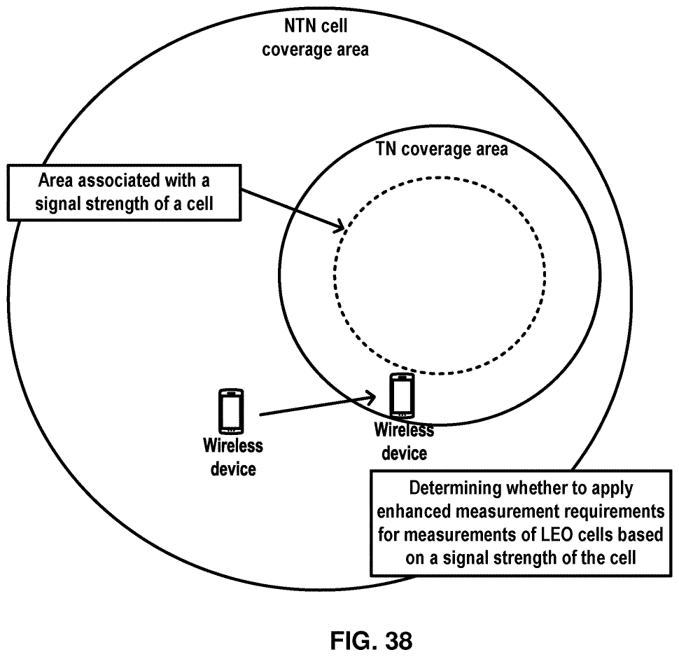

FIG. 38 illustrates an example embodiment of a wireless device determining whether to apply an enhanced measurement requirement, for a measurement, for one or more LEO cells based on a signal strength, measured by the wireless device, of a cell. The wireless device, in an RRC idle or inactive state, may receive, via a serving cell, one or more system information blocks (SIBs) indicating: an indication of the enhanced measurement requirement, for a measurement, for one or more low earth orbit (LEO) cells while the wireless device is in the RRC idle or inactive state; a TN coverage area; and a threshold associated with the signal strength. The TN coverage area may be associated with one or more TN frequencies. The cell may be the serving cell. The one or more SIBs may indicate the one or more TN frequencies. The wireless device may determine whether to apply the enhanced measurement requirement, for the measurement, for the one or more LEO cells based on the signal strength, measured by the wireless device, of the cell. For example, the wireless device may determine not to apply the enhanced measurement requirements, for measurement, for the one or more LEO cells based on the signal strength of the cell being higher than the threshold. For example, the wireless device may determine to apply the enhanced measurement requirements, for measurement, for the one or more LEO cells based on the signal strength of the cell being lower than the threshold. The wireless device may determine that the wireless device is within an area based on the signal strength of the cell being higher than the threshold. The cell may be NTN cell or TN cell. Based on performing the measurement applying the enhanced measurement requirement, the wireless device may select a cell to perform cell reselection. The wireless device may camp on the cell. The wireless device may transmit an uplink packet to the cell. Based on performing the measurement not applying the enhanced measurement requirement, the wireless device may select a cell to perform cell reselection. The wireless device may camp on the cell. The wireless device may transmit an uplink packet to the cell.

In an example of FIG. 38, a wireless device may determine whether to perform a relaxed measurement for one or more TN cells based on a signal strength, measured by the wireless device, of a cell. The wireless device, in an RRC idle or inactive state, may receive, via a serving cell, one or more system information blocks (SIBs) indicating: a configuration indicating a first condition to perform relaxed measurements while the wireless device is in the RRC idle or inactive state; a TN coverage area; and a threshold associated with the signal strength. The TN coverage area may be associated with one or more TN frequencies. The cell may be the serving cell. The one or more SIBs may indicate the one or more TN frequencies. The wireless device may determine whether to perform the relaxed measurements for the one or more TN cells based on the signal strength, measured by the wireless device, of the cell. For example, the wireless device may determine not to perform the relaxed measurements for the one or more TN cells based on the signal strength of the cell being lower than the threshold. For example, the wireless device may determine to perform the relaxed measurement for the one or more TN cells based on the signal strength of the cell being higher than the threshold. The wireless device may determine that the wireless device is within an area based on the signal strength of the cell being higher than the threshold. The cell may be NTN cell or TN cell. Based on performing the relaxed measurements, the wireless device may select a cell to perform cell reselection. The wireless device may camp on the cell. The wireless device may transmit an uplink packet to the cell. Based on not performing the relaxed measurements, the wireless device may select a cell to perform cell reselection. The wireless device may camp on the cell. The wireless device may transmit an uplink packet to the cell.

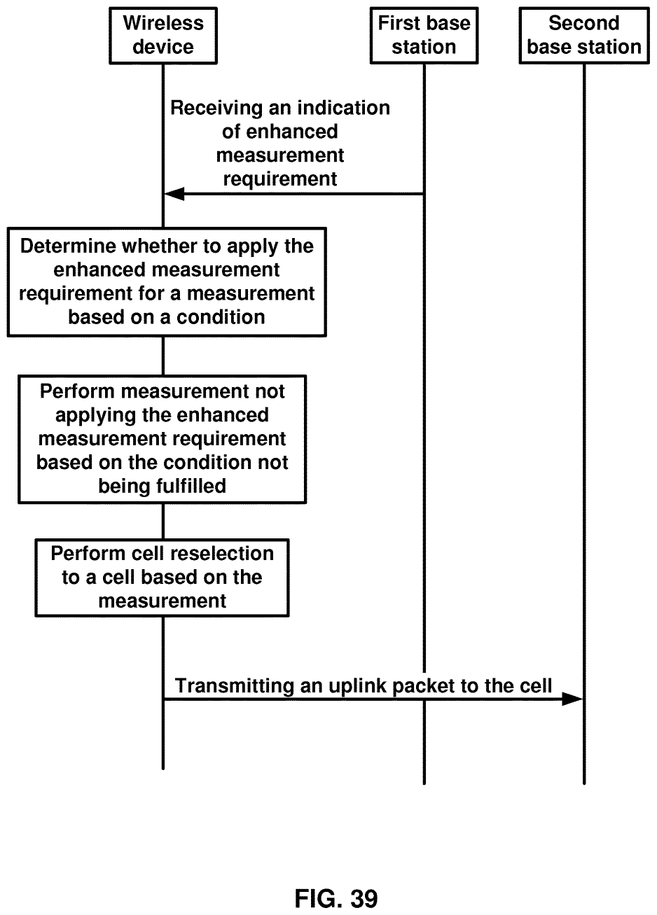

FIG. 39 illustrates an example embodiment of a wireless device determining whether to apply an enhanced measurement requirement for a measurement based on a condition. The condition may be associated with at least one of: a cell coverage area; a location of a wireless device; or a received signal power from a serving cell; a received signal strength from a LEO cell; a mobility (or speed) of a wireless device; or a type of the LEO cell (e.g., earth moving cell, (quasi-)earth fixed cell. The wireless device may receive an indication of the enhanced measurement requirement from a first base station (e.g., an NTN cell). Based on receiving the indication, the wireless device may determine whether to apply the enhanced measurement requirement for a measurement based on the condition. For example, the wireless device may apply the enhanced measurement requirement for the measurement based on the condition being fulfilled. For example, the wireless device may not apply the enhanced measurement requirement for the measurement based on the condition not being fulfilled. The wireless device may perform the measurement not applying the enhanced measurement requirement based on the condition not being fulfilled. Not applying the enhanced measurement requirement may comprise applying a normal measurement. The wireless device may select a cell, of a second base station, to perform a cell reselection based on the measurement results (e.g., RSRP or RSRQ of a cell that the wireless device measured). Based on performing the cell reselection to the cell, the wireless device may camp on the cell. The wireless device may transmit an uplink packet to the cell.

In an example of FIG. 39, the wireless device may determine whether to perform a relaxed measurements based on a second condition. The second condition may be associated with at least one of: a cell coverage area; a location of a wireless device; or a received signal power from a serving cell; a received signal strength from a LEO cell; or a mobility (or speed) of a wireless device. The wireless device may receive a configuration indicating a first condition to perform relaxed measurements from a first base station (e.g., an NTN cell). Based on receiving the configuration, the wireless device may determine whether the first condition is fulfilled. While the first condition is fulfilled, the wireless device may determine whether to perform the relaxed measurements based on the second condition. For example, while the first condition is fulfilled, the wireless device may perform the relaxed measurements based on the second condition being fulfilled. For example, while the first condition is fulfilled, the wireless device may not perform the relaxed measurements based on the condition not being fulfilled. For example, while the first condition is fulfilled, the wireless device may perform a normal measurements based on the condition not being fulfilled. The wireless device may not perform the relaxed measurements based on the second condition not being fulfilled. Not performing the relaxed measurement requirement may comprise performing a normal measurement. The wireless device may select a cell, of a second base station, to perform a cell reselection based on the measurement results (e.g., RSRP or RSRQ of a cell that the wireless device measured). Based on performing the cell reselection to the cell, the wireless device may camp on the cell. The wireless device may transmit an uplink packet to the cell.

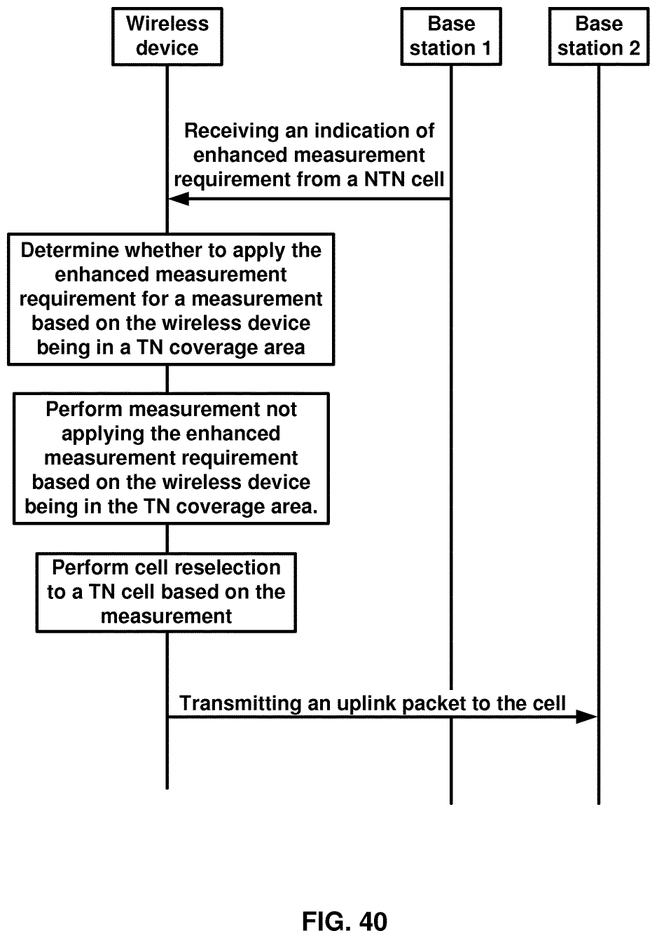

FIG. 40 illustrates an example embodiment of a wireless device determining whether to apply an enhanced measurement requirement, for a measurement, for one or more LEO cells based on the wireless device being in a TN coverage area. The wireless device may receive, from an NTN cell of first base station, a system information indicating an indication of the enhanced measurement requirement and a TN coverage area. Based on receiving the indication, the wireless device may determine whether to apply the enhanced measurement requirement for a measurement based on the wireless device being in the TN coverage area. For example, the wireless device may apply the enhanced measurement requirement for the measurement based on the wireless device not being in the TN coverage area. For example, the wireless device may not apply the enhanced measurement requirement for the measurement based on the wireless device being in the TN coverage area. The wireless device may perform the measurement not applying the enhanced measurement requirement based on the wireless device being in the TN coverage area while the wireless device camps on the NTN cell and performs measurement of the one or more LEO cells. Not applying the enhanced measurement requirement may comprise applying a normal measurement or performing a relaxed measurement. The wireless device may select a TN cell, of a second base station, to perform a cell reselection based on the measurement results (e.g., RSRP or RSRQ of a cell that the wireless device measured). Based on performing the cell reselection to the cell, the wireless device may camp on the cell. The wireless device may transmit an uplink packet to the cell.

In an example, the one or more conditions being fulfilled may comprise at least one of: at least one, of the one or more conditions, being, fulfilled; a number, of the one or more conditions, being fulfilled. The number may be a total number of the one or more conditions or a number less than the total number, the base station (e.g., the serving cell) may transmit to a wireless device a message (e.g., SIB) indicating the number.

For example, the wireless device may determine a condition, of the one or more conditions, being fulfilled based on the wireless device not being in a TN coverage area. The wireless device may determine the condition, of the one or more conditions, not being fulfilled based on the wireless device being in a TN coverage area.

For example, the wireless device may determine a condition, of the one or more conditions, being fulfilled based on a distance between a location of the wireless device and a center of a TN coverage area being higher than a threshold. The wireless device may determine the condition, of the one or more conditions, not being fulfilled based on a distance between a location of the wireless device and a center of a TN coverage area being lower than a threshold.

For example, the wireless device may determine a condition, of the one or more conditions, being fulfilled based on a signal strength of a serving cell of the wireless device being lower than a threshold. The wireless device may determine the condition, of the one or more conditions, not being fulfilled based on a signal strength of a serving cell of the wireless device being higher than a threshold.

For example, the wireless device may determine a condition, of the one or more conditions, being fulfilled based on a signal strength of a neighbor cell, a LEO cell, of the wireless device being higher than a threshold. The wireless device may determine the condition, of the one or more conditions, not being fulfilled based on a signal strength of a neighbor cell, a LEO cell, being lower than a threshold.

For example, the wireless device may determine a condition, of the one or more conditions, being fulfilled based on a mobility of the wireless device being high mobility or high mobility state. The wireless device may determine the condition, of the one or more conditions, not being fulfilled based on a mobility of the wireless device not being a high mobility or high mobility state.

For example, the wireless device may determine a condition, of the one or more conditions, being fulfilled based on a type of a LEO cell not being earth moving cell. The wireless device may determine the condition, of the one or more conditions, not being fulfilled based on a type of a LEO cell being earth moving cell.

For example, the wireless device may determine a condition, of the one or more conditions, being fulfilled based on a type of a LEO cell being earth moving cell. The wireless device may determine the condition, of the one or more conditions, not being fulfilled based on a type of a LEO cell not being earth moving cell.

For example, the wireless device may determine a condition, of the one or more conditions, being fulfilled based on a type of a LEO cell not being (quasi-)earth fixed cell. The wireless device may determine the condition, of the one or more conditions, not being fulfilled based on a type of a LEO cell being (quasi-)earth fixed cell.

For example, the wireless device may determine a condition, of the one or more conditions, being fulfilled based on a type of a LEO cell being (quasi-)earth fixed cell. The wireless device may determine the condition, of the one or more conditions, not being fulfilled based on a type of a LEO cell not being (quasi-)earth fixed cell.

In an example of FIG. 40, the wireless device may determine whether to perform a relaxed measurements for one or more TN cells based on the wireless device being in a TN coverage area. The wireless device may receive, from an NTN cell of first base station, a system information indicating a configuration indicating a first condition to perform relaxed measurements and a TN coverage area. Based on receiving the configuration, the wireless device may determine whether the first condition is fulfilled. While the first condition is fulfilled, the wireless device may determine whether to perform the relaxed measurements based on the wireless device being in the TN coverage area. For example, the wireless device may perform the relaxed measurements based on the wireless device not being in the TN coverage area. For example, the wireless device may not perform the relaxed measurements based on the wireless device being in the TN coverage area. When the first condition is fulfilled, the wireless device may not perform the relaxed measurement based on the wireless device being in the TN coverage area while the wireless device camps on the NTN cell and performs measurement of the one or more LEO cells. Not performing the relaxed measurement may comprise performing a normal measurement. The wireless device may select a TN cell, of a second base station, to perform a cell reselection based on the measurement results (e.g., RSRP or RSRQ of a cell that the wireless device measured). Based on performing the cell reselection to the cell, the wireless device may camp on the cell. The wireless device may transmit an uplink packet to the cell.

For example, the wireless device may determine a second condition being fulfilled based on the wireless device not being in a TN coverage area. The wireless device may determine that the second condition is not being fulfilled based on the wireless device being in a TN coverage area.

For example, the wireless device may determine a second condition being fulfilled based on a distance between a location of the wireless device and a center of a TN coverage area being higher than a threshold. The wireless device may determine the second condition not being fulfilled based on a distance between a location of the wireless device and a center of a TN coverage area being lower than a threshold.

For example, the wireless device may determine a second condition being fulfilled based on a signal strength of a serving cell of the wireless device being higher than a threshold. The wireless device may determine the second condition not being fulfilled based on a signal strength of a serving cell of the wireless device not being higher than a threshold.

For example, the wireless device may determine a second condition being fulfilled based on a signal strength of a neighbor cell, a LEO cell, of the wireless device being lower than a threshold. The wireless device may determine the second condition not being fulfilled based on a signal strength of a neighbor cell, a LEO cell, being higher than a threshold.

For example, the wireless device may determine a second condition being fulfilled based on a mobility of the wireless device being high mobility nor high mobility state. The wireless device may determine the second condition not being fulfilled based on a mobility of the wireless device being a high mobility or high mobility state.

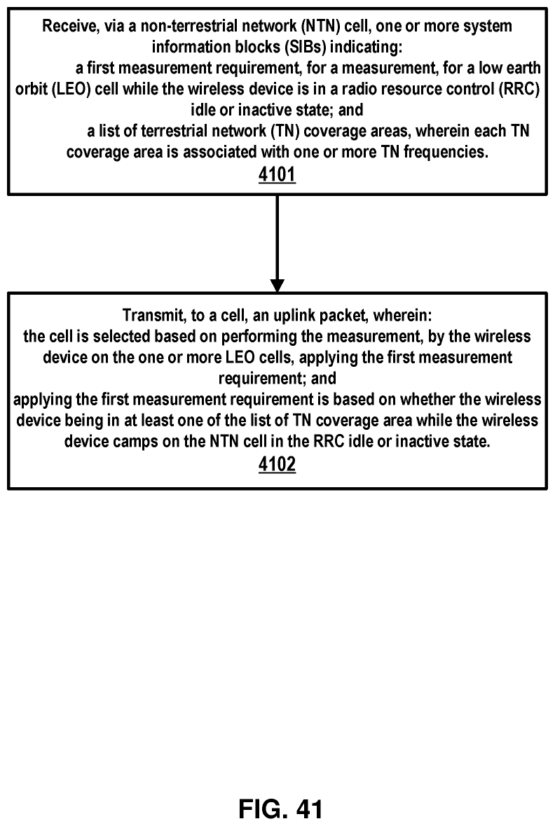

FIG. 41 illustrates an example flow chart of performing a procedure as per an aspect of an embodiment of the present disclosure. At 4101, according to example embodiment(s) (e.g., referring to FIG. 39. and FIG. 40) in the present disclosure, a wireless device may receive, via a non-terrestrial network (NTN) cell, one or more system information blocks (SIBs) indicating: a first measurement requirement, for a measurement, for a low earth orbit (LEO) cell while the wireless device is in a radio resource control (RRC) idle or inactive state; and a list of terrestrial network (TN) coverage areas, wherein each TN coverage area is associated with one or more TN frequencies. At t102, the wireless device may transmit, to a cell, an uplink packet, wherein: the cell is selected based on performing the measurement, by the wireless device on the one or more LEO cells, applying the first measurement requirement; and applying the first measurement requirement is based on whether the wireless device being in at least one of the list of TN coverage area while the wireless device camps on the NTN cell in the RRC idle or inactive state.

In an example of FIG. 41, at 4101, according to example embodiment(s) (e.g., referring to FIG. 39. and FIG. 40) in the present disclosure, a wireless device may receive, via a non-terrestrial network (NTN) cell, one or more system information blocks (SIBs) comprising: a configuration indicating a first condition to perform first measurements, by the wireless device, for a neighbor cell while the wireless device is in a radio resource control (RRC) idle or inactive state; and a list of terrestrial network (TN) coverage areas, wherein each TN coverage area is associated with one or more TN frequencies. At t102, the wireless device may transmit, to a cell, an uplink packet, wherein the cell is selected based on performing the first measurements, by the wireless device on one or more cells of the neighbor cell, based on: whether the wireless device is in at least one TN coverage area of the list of TN coverage areas while the wireless device camps on the NTN cell in the RRC idle or inactive state; and the first condition being fulfilled.

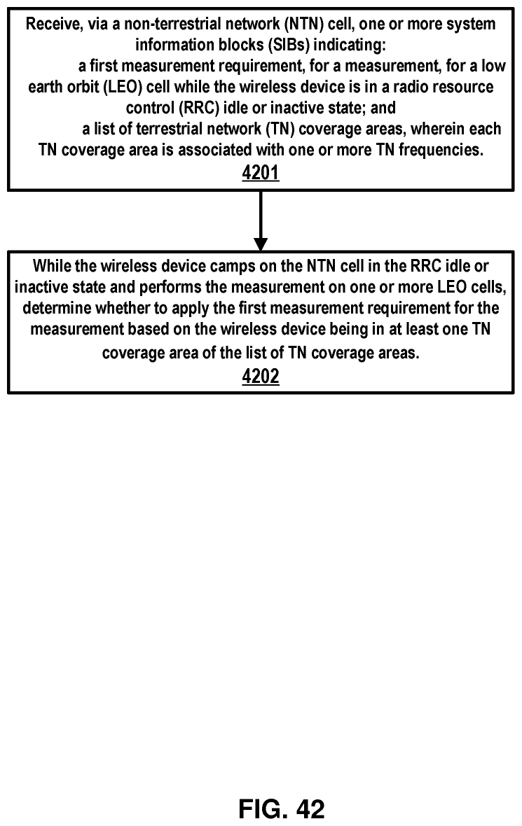

FIG. 42 illustrates an example flow chart of performing a procedure as per an aspect of an embodiment of the present disclosure. At 4201, according to example embodiment(s) (e.g., referring to FIG. 39. and FIG. 40) in the present disclosure, a wireless device may receive, via a non-terrestrial network (NTN) cell, one or more system information blocks (SIBs) indicating: a first measurement requirement, for a measurement, for a low earth orbit (LEO) cell while the wireless device is in a radio resource control (RRC) idle or inactive state; and a list of terrestrial network (TN) coverage areas, wherein each TN coverage area is associated with one or more TN frequencies. At 4202, while the wireless device camps on the NTN cell in the RRC idle or inactive state and performs the measurement on one or more LEO cells, the wireless device may determine whether to apply the first measurement requirement for the measurement based on the wireless device being in at least one TN coverage area of the list of TN coverage areas.

In an example of FIG. 42, at 4201, according to example embodiment(s) (e.g., referring to FIG. 39. and FIG. 40) in the present disclosure, a wireless device may receive, via a non-terrestrial network (NTN) cell, one or more system information blocks (SIBs) comprising: a configuration indicating a first condition to perform first measurements, by the wireless device, for a neighbor cell while the wireless device is in a radio resource control (RRC) idle or inactive state; and a list of terrestrial network (TN) coverage areas, wherein each TN coverage area is associated with one or more TN frequencies. At 4202, while the wireless device camps on the NTN cell in the RRC idle or inactive state, determine whether to perform the first measurements on a first cell, of the neighbor cell, based on: the wireless device being in at least one TN coverage area of the list of TN coverage areas; and the first condition being fulfilled.

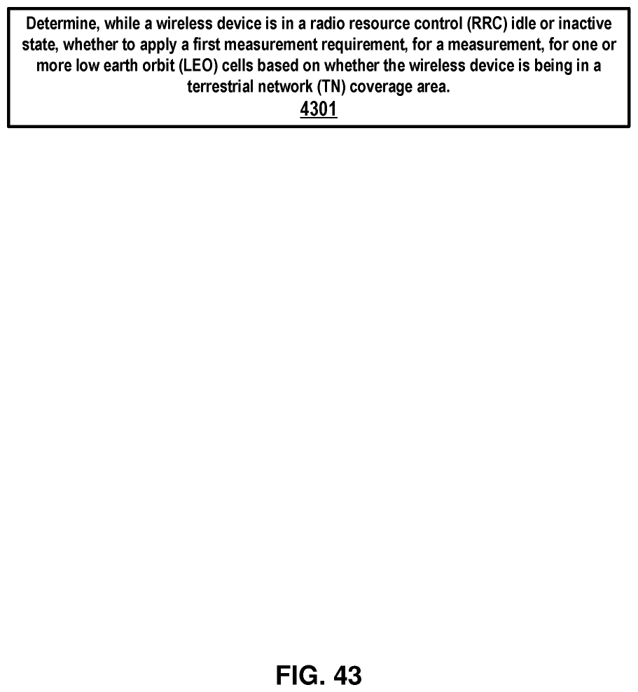

FIG. 43 illustrates an example flow chart of performing a procedure as per an aspect of an embodiment of the present disclosure. At 4301, according to example embodiment(s) (e.g., referring to FIG. 39. and FIG. 40) in the present disclosure, a wireless device may determine, while a wireless device is in a radio resource control (RRC) idle or inactive state, whether to apply a first measurement requirement, for a measurement, for one or more low earth orbit (LEO) cells based on whether the wireless device is being in a terrestrial network (TN) coverage area.

In an example of FIG. 43, at 4301, according to example embodiment(s) (e.g., referring to FIG. 39. and FIG. 40) in the present disclosure, a wireless device may, while a wireless device is in a radio resource control (RRC) idle or inactive state, determine, in response to first condition to perform a first measurement being fulfilled, whether to perform the first measurements for a cell of a neighbor cell based on the wireless device is in a terrestrial network (TN) coverage area.

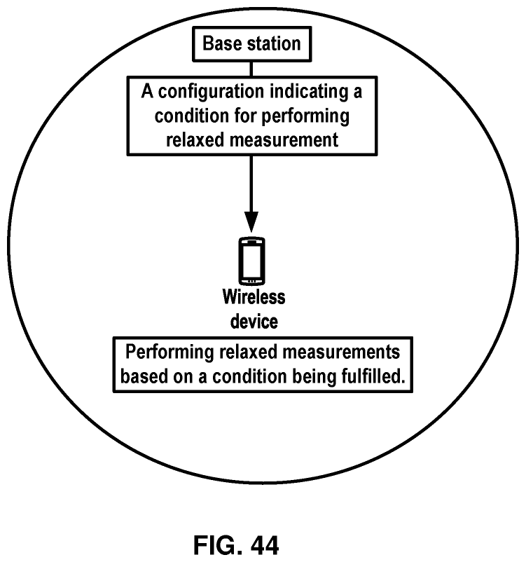

FIG. 44 illustrates an example of a wireless device performing a relaxed measurement based on a first condition. The wireless device may receive, from a base station, a configuration indicating a first condition for performing relaxed measurement. The first condition may comprise a low mobility criterion and a not-at-cell edge criterion. The first condition may be fulfilled based on at least one of the low mobility criterion or the not-at-cell edge criterion being fulfilled. The wireless device may perform relaxed measurement for one or more neighbor cells. The wireless device may perform a cell reselection based on the relaxed measurement.

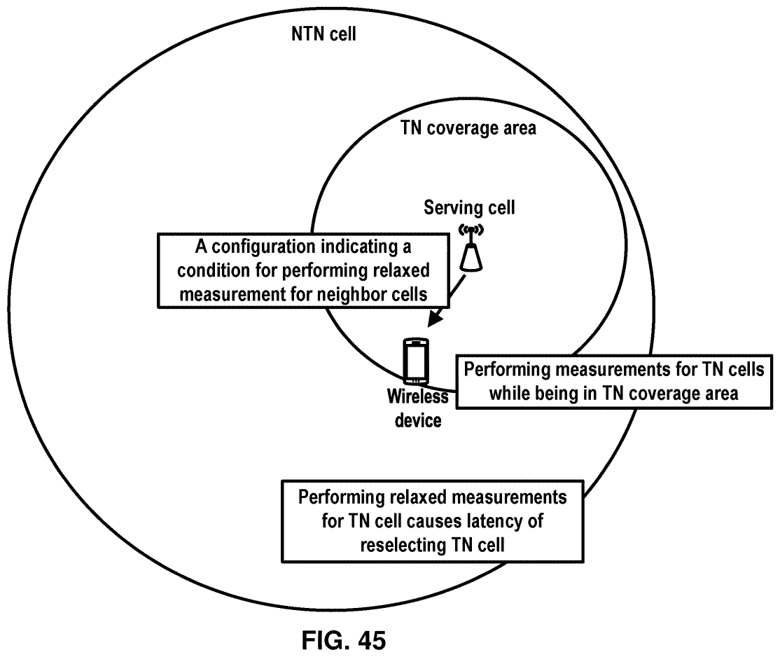

FIG. 45 illustrates an example of a wireless device performing relaxed measurements of a terrestrial network (TN) cell. A wireless device may perform measurement of a neighbor cell for, for example, cell reselection. A base station (e.g., a serving cell of the base station) may transmit information indicating the measurement of the neighbor cell. For example, the information may comprise a configuration indicating a first condition for performing the relaxed measurements. A wireless device may receive, from a serving cell, the configuration indicating the first condition for performing the relaxed measurements. The wireless device may perform the relaxed measurements based on the first condition being fulfilled. The wireless device may perform relaxed measurements for TN cells for cell reselection.

In an example of FIG. 45, the wireless device may be under some circumstances. performing, by the wireless device under some circumstances, the relaxed measurement may be unnecessary. For example, the wireless device, camping on an NTN cell and performing relaxed measurements for a neighbor cell, may enter a TN coverage area (e.g., be in the TN coverage area). The neighbor cell may comprise one or more TN cells and one or more NTN cells. The wireless device in the TN coverage area may initiate/perform measurements for a cell of a TN frequency associated with the TN coverage area. The cell of the TN frequency may have higher priority than the one or more NTN cells, of the neighbor cell, for a cell reselection by the wireless device. For example, the wireless device may select the cell to perform cell reselection (e.g., if a signal strength of the cell and an NTN cell is same). After entering the TN coverage area (e.g., being in the TN coverage area), the wireless device may perform the relaxed measurements for the cell based on a first condition for performing the relaxed measurements being fulfilled. The wireless device performing the relaxed measurement under some circumstances may measure a TN cell less frequently. The wireless device may reselect an NTN cell and then reselect the TN cell later. It causes unnecessary cell reselection from the NTN cell to the TN cell. When the wireless device establishes a connection with the NTN cell after reselecting the NTN cell, the wireless device may need to perform a handover to the TN cell from the NTN cell. It causes unnecessary signal overheads for the handover from the NTN cell to the TN cell.

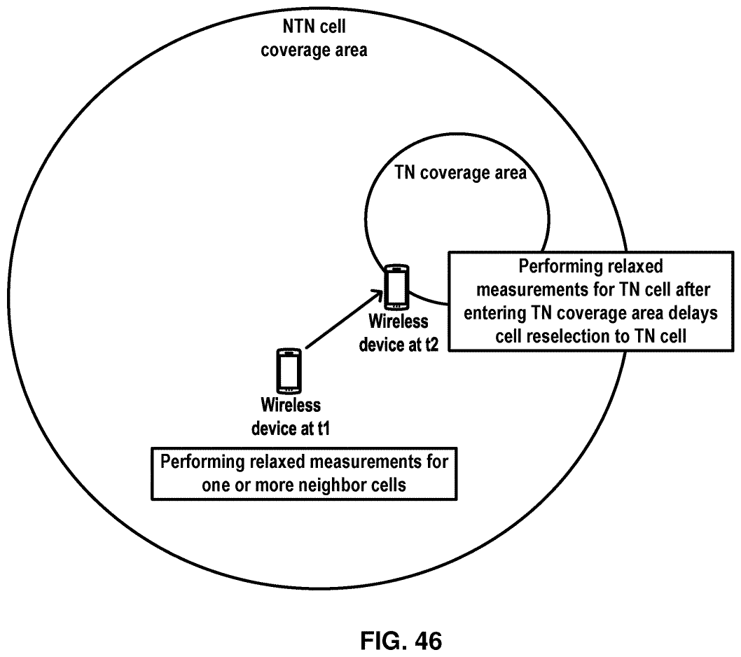

FIG. 46 illustrates an example of a wireless device performing relaxed measurements for one or more neighbor cells while entering a TN coverage area. The wireless device, in a radio resource control (RRC) idle or inactive state, may camp on an NTN cell. The wireless device may receive, from the NTN cell, one or more system information blocks (SIBs) indicating: a configuration indicating a first condition to perform relaxed measurements; a coverage area; and/or the one or more neighbor cells. For example, SIB3, SIB4, and/or SIB5 may comprise the one or more neighbor cells. The one or more neighbor cells may comprise: one or more NTN cells; and/or one or more TN cells associated with the TN coverage area.

In an example of FIG. 46, at time point t1, the wireless device may not be in the TN coverage area of the NTN cell's coverage. The wireless device may perform relaxed measurements for the one or more neighbor cells for a cell reselection. Based on the first condition to perform relaxed measurements being fulfilled, the wireless device may perform relaxed measurements for the one or more neighbor cells based on applying a relaxed measurement requirements. Based on not being in the TN coverage area, the wireless device may not perform measurements of the one or more TN cells.

In an example of FIG. 46, the wireless device may be in the TN coverage area. Based on being in the TN coverage area, the wireless device may perform measurements of the one or more TN cells associated with the TN coverage area. According to existing technologies, based on the first condition to perform the relaxed measurement being fulfilled, the wireless device may perform the relaxed measurements for the one or more TN cells while the wireless device is in the TN coverage area. The wireless device in the TN coverage area may have a chance to select a TN cell of the TN coverage area based on performing the measurements of the one or more TN cells. The wireless device may consider that the one or more TN cells have higher priority for the cell reselection than the one or more NTN cells, the wireless device in the TN coverage area may not have a chance to select one of the one or more NTN cells. For example, the wireless device in the TN coverage area may consider that the one or more TN cells have higher priority for the cell reselection than the one or more NTN cells. While the wireless device in the TN coverage area performs measurements of the one or more TN cells, performing, by the wireless device, the relaxed measurement for the one or more TN cells may be unnecessary. Performing, by the wireless device, the relaxed measurement for the one or more TN cells may cause latency to select, via cell reselection, one of the one or more TN cells.

A wireless device may perform a measurement of a neighbor cell for, for example, cell reselection. A base station (e.g., a serving cell of the base station) may transmit information indicating the measurement of one or more neighbor cells. For example, the information may comprise a configuration indicating a first condition for performing the relaxed measurements. A wireless device may receive, from the serving cell (e.g., of the base station), the configuration indicating the first condition to perform relaxed measurements for the one or more neighbor cells. The wireless device may perform the relaxed measurements based on the first condition being fulfilled. For example, based on the first condition being fulfilled, the wireless device may apply relaxed measurement requirements for cell reselection of the one or more neighbor cells. Based on applying the relaxed measurement requirements, the wireless device may perform the relaxed measurements for cell reselection of the one or more neighbor cells. When the wireless device is under some circumstances, the wireless device may be likely to (re) select a TN cell. The wireless device performing the relaxed measurement under some circumstances may measure a TN cell less frequently. The wireless device may reselect an NTN cell and then reselect the TN cell later. It causes unnecessary cell reselection from the NTN cell to the TN cell. When the wireless device establishes a connection with the NTN cell after reselecting the NTN cell, the wireless device may need to perform a handover to the TN cell from the NTN cell. It causes unnecessary signal overheads for the handover from the NTN cell to the TN cell.

The implementation of the existing technologies may result in delay of performing cell reselection to a TN cell when the wireless device is in a TN coverage area while a first condition to perform relaxed measurements is fulfilled. For example, a wireless device may receive, from a serving cell, a system information indicating one or more neighbor cells. Based on the system information, the wireless device may perform measurements of the one or more neighbor cells. The serving cell may be an NTN cell. The system information may further indicate a list of the TN coverage areas of the one or more TN cells. Coverage areas of the one or more TN cells may be located in a coverage of the NTN cell. The one or more neighbor cells may comprise one or more NTN cells and one or more TN cells. The system information may indicate a configuration indicating a first condition to perform relaxed measurements for the one or more neighbor cells. In existing technologies, the wireless device receiving the system information may perform relaxed measurements for the one or more TN cells based on the first condition to perform the relaxed measurements being fulfilled by applying a relaxed measurement requirements while the wireless device camps on the serving cell (e.g., the NTN cell) transmitting the system information. The wireless device may initiate/perform or perform measurements of the one or more TN cells when the wireless device is in one of the one or more TN coverage areas. In existing technologies, for cell reselection, the wireless device and/or a network may prioritize a TN cell over an NTN cell. Performing the relaxed measurements for the one or more TN cells may cause delay of performing cell reselection to one of the one or more TN cells. The relaxed measurement for the one or more NTN cells may be unnecessary while the wireless device is in a TN coverage area of the list of the TN coverage areas.

Example embodiments enable a wireless device receiving a configuration indicating a condition to perform relaxed measurements to determine, based on a second condition, whether to perform the relaxed measurement for one or more TN cells, for cell reselection. The second condition may be associated with at least one of: a cell coverage area; a location of a wireless device; or a received signal power from a serving cell; a received signal strength from a LEO cell; or a mobility (or speed) of a wireless device. For example, a wireless device may determine to perform the relaxed measurement for one or more cells based on the second condition being fulfilled. A wireless device may determine not to perform the relaxed measurement for the one or more cells based on the second condition not being fulfilled. The one or more cells may be one or more TN cells. The wireless device may perform a cell reselection based on performing the relaxed measurements. The wireless device may perform a cell reselection based on performing the relaxed measurements. For example, the wireless device not performing the relaxed measurement may perform normal measurement for cell reselection. It avoids delay of cell reselection of the wireless device due to the unnecessary relaxed measurements.

In example embodiments, the second condition may be associated with a TN coverage area. For example, a wireless device receiving a configuration indicating a first condition to perform relaxed measurements may determine whether to perform the relaxed measurements for one or more TN cells based on the wireless device being in a TN coverage area. For example, a wireless device, in an RRC idle or inactive state, may determine whether to perform a relaxed measurement based on whether the wireless device is in a TN coverage area of a list of TN coverage areas. The wireless device may receive, via a non-terrestrial network (NTN) cell, one or more system information blocks (SIBs) indicating: a configuration indicating a first condition to perform relaxed measurements for one or more terrestrial network (TN) while the wireless device is in the RRC idle or inactive state; and the list of TN coverage areas. Each TN coverage area of the list of TN coverage areas may be associated with one or more TN frequencies. The one or more SIBs may indicate the one or more TN frequencies.

In example embodiments, a wireless device receiving a configuration indicating a first condition to perform relaxed measurements may determine to perform the relaxed measurements based on the wireless device not being in the TN coverage area. The wireless device may not perform measurements of one or more TN cells associated with the TN coverage area while the wireless device is not in the TN coverage area. The wireless device may determine not to perform the relaxed measurement based on the wireless device being in the TN coverage area. The wireless device may perform measurements of the one or more TN cells associated with the TN coverage area while the wireless device is in the TN coverage area. For example, it prevents the wireless device to perform the relaxed measurements for the one or more TN cells while the wireless device is in the TN coverage area and/or performing measurements of one or more TN cells. It reduces delay or latency of perform cell reselection to one of the one or more TN cells.

In example embodiments, a wireless device, in a radio resource control (RRC) idle or inactive state, receiving a configuration indicating a first condition to perform relaxed measurements may determine whether to perform the relaxed measurements for one or more neighbor cells based whether the wireless device is in a TN coverage area. The wireless device may perform the relaxed measurements for the one or more TN cells based on the wireless device not being in the TN coverage area. The wireless device may not perform the relaxed measurements for one or more TN cells based on the wireless device being in the TN coverage area. The wireless device may perform measurements of one or more TN cells of a TN frequency that is associated with the TN coverage area while the wireless device is in the TN coverage area. Based on performing the relaxed measurements, the wireless device may select a cell to perform cell reselection. The wireless device may camp on the cell. The wireless device may transmit an uplink packet to the cell. Based on not performing the relaxed measurement, the wireless device may select a cell to perform cell reselection. The wireless device may camp on the cell. The wireless device may transmit an uplink packet to the cell.

In example embodiments, a wireless device, in an RRC idle or inactive state, receiving a configuration indicating a first condition to perform relaxed measurements may determine whether to perform the relaxed measurements based on whether the wireless device is in a TN coverage area of a list of TN coverage areas. The wireless device may receive, via a non-terrestrial network (NTN) cell, one or more system information blocks (SIBs) indicating: a configuration indicating a first condition to perform relaxed measurements while the wireless device is in the RRC idle or inactive state; and the list of TN coverage areas. Each TN coverage area of the list of TN coverage areas may be associated with one or more TN frequencies. The one or more SIBs may indicate the one or more TN frequencies. While the first condition is being fulfilled, the wireless device may perform the relaxed measurements for the one or more TN cells based on the wireless device not being in the TN coverage area. While the first condition being fulfilled, the wireless device may not perform the relaxed measurements for one or more TN cells based on the wireless device being in the TN coverage area. Based on performing the relaxed measurements, the wireless device may select a cell to perform cell reselection. The wireless device may camp on the cell. The wireless device may transmit an uplink packet to the cell. Based on not performing the relaxed measurement, the wireless device may select a cell to perform cell reselection. The wireless device may camp on the cell. The wireless device may transmit an uplink packet to the cell.

In an example embodiment, the second condition may be associated with a mobility (or speed) of a wireless device. For example, a wireless device receiving a configuration indicating a first condition to perform relaxed measurements may determine whether to perform the relaxed measurements for one or more TN cells based on a mobility state of the wireless device. For example, the wireless device may determine not to perform the relaxed measurements based on: the wireless device being in a high mobility state; the wireless device being in a normal mobility state; the wireless device not being in a low mobility state; or the wireless device not being in/with a low mobility. The wireless device may determine to perform the relaxed measurements based on: the wireless device being in the TN coverage area; and the wireless device not being in a high mobility state. Determination of the mobility state of the wireless device may be based on: a variation of a location of the wireless device; a variation of a signal strength (e.g., RSRP, RSRQ) of a cell measured by the wireless device; or a number of cell reselections during a time period (e.g., TCRmax). For example, the mobility state of the wireless device may be high mobility state based on: the variation of the location of the wireless device being higher than a threshold; the variation of the signal strength of the cell measured by the wireless device being higher than a threshold; or the number of cell reselections during the time period being higher than a threshold (e.g., NCR_H). Based on not performing the relaxed measurements, the wireless device may select a cell to perform cell reselection. The wireless device may camp on the cell. The wireless device may transmit an uplink packet to the cell.

In an example embodiment, the one or more conditions may be associated with a time period after entering a TN coverage area. For example, a wireless device receiving a configuration indicating a first condition to perform relaxed measurements may determine whether to perform the relaxed measurements for one or more TN cells based on an elapsed time after the wireless device entering a TN coverage area. For example, the wireless device may determine not to perform the relaxed measurements based on the wireless device being in the TN coverage area. The wireless device may determine to perform the relaxed measurements based on the wireless device not camping on a TN cell more than a time period after entering the TN coverage area. Based on performing the relaxed measurements, the wireless device may select a cell to perform cell reselection. The wireless device may camp on the cell. The wireless device may transmit an uplink packet to the cell. Based on not performing the relaxed measurement, the wireless device may select a cell to perform cell reselection. The wireless device may camp on the cell. The wireless device may transmit an uplink packet to the cell.

In an example embodiment, the second condition may be associated with a received signal strength of a cell. For example, a wireless device receiving a configuration indicating a first condition to perform relaxed measurements may determine whether to perform the relaxed measurements for one or more TN cells based on a received signal strength of a cell. The cell may be a serving cell of the wireless device or a TN cell. The wireless device may determine not to perform the relaxed measurements for the one or more TN cells based on the received signal strength of the serving cell being lower than a threshold. The wireless device may determine to perform the relaxed measurements for the one or more TN cells based on the received signal strength of the serving cell being higher than a threshold. The wireless device may determine to perform the relaxed measurements for the one or more TN cells based on the received signal strength of the LEO cell being higher than a threshold.

The wireless device may perform the measurements on the one or more TN cells. The wireless device may perform the relaxed measurements for the one or more TN cells based on: the wireless device not being in the TN coverage area; and the first condition to perform the relaxed measurements being fulfilled. The wireless device may not perform the relaxed measurements for one or more TN cells based on the wireless device being in the TN coverage area while the wireless device camps on the NTN cell and performs the measurements of the one or more TN cells. The wireless device may select a cell to perform a cell reselection based on performing the measurements on the one or more TN cells. Based on performing the cell reselection to the cell, the wireless device may camp on the cell. The cell may be a TN cell. The wireless device may transmit an uplink packet to the cell.

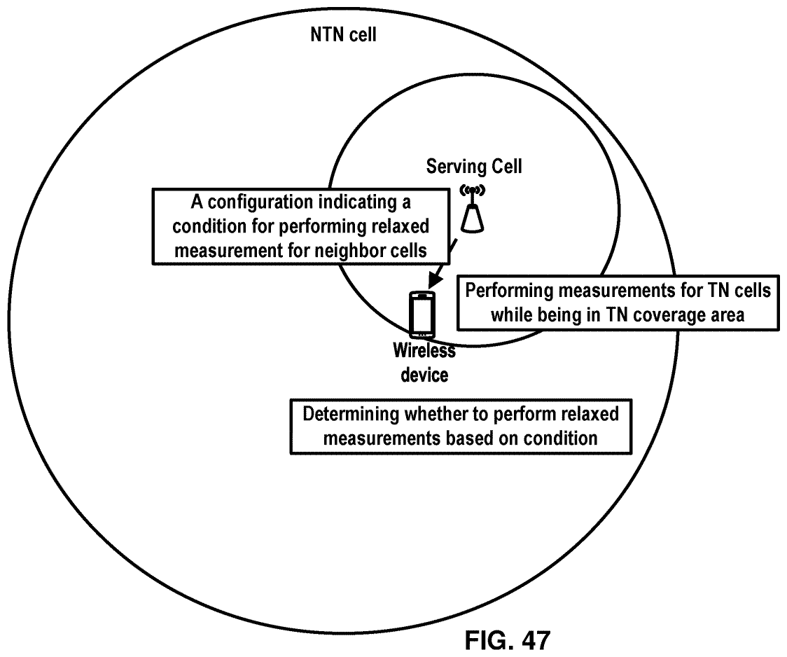

FIG. 47 illustrates an example embodiment of a wireless device determining whether to perform a relaxed measurements based on a second condition. A wireless device may perform measurement of a neighbor cell for, for example, cell reselection. A base station (e.g., a serving cell) may transmit information indicating the measurement of the neighbor cell. For example, a wireless device may receive, from a serving cell, a configuration indicating a first condition to perform relaxed measurements. The wireless device receiving the configuration may determine whether to perform the relaxed measurements based on a second condition. The second condition may be associated with at least one of: a cell coverage area; a location of a wireless device; a received signal power from a serving cell; or a received signal power from a cell; or a mobility (or speed) of a wireless device. For example, the cell coverage area may be a TN coverage area. The wireless device receiving the configuration may determine not to perform the relaxed measurements based on the wireless device being in the TN coverage area. The wireless device receiving the configuration may determine to perform the relaxed measurements based on the wireless device not being in the TN coverage area.

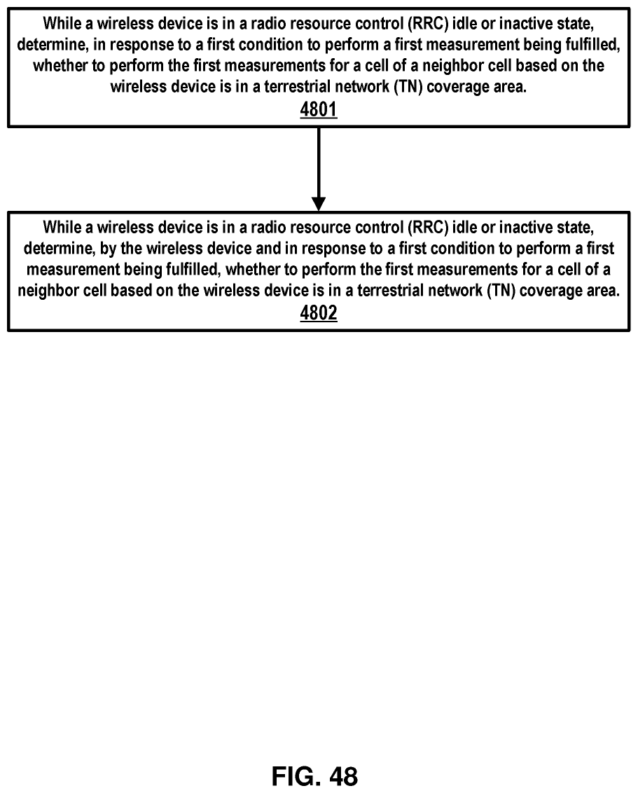

FIG. 48 illustrates an example flow chart of performing a procedure as per an aspect of an embodiment of the present disclosure. At 4801, according to example embodiment(s) (e.g., referring to FIG. 39. and FIG. 40) in the present disclosure, a wireless device may, while a wireless device is in a radio resource control (RRC) idle or inactive state, determine, in response to a first condition to perform a first measurement being fulfilled, whether to perform the first measurements for a cell of a neighbor cell based on the wireless device is in a terrestrial network (TN) coverage area. At 4802, the wireless device may, while a wireless device is in a radio resource control (RRC) idle or inactive state, determine, by the wireless device and in response to a first condition to perform a first measurement being fulfilled, whether to perform the first measurements for a cell of a neighbor cell based on the wireless device is in a terrestrial network (TN) coverage area.

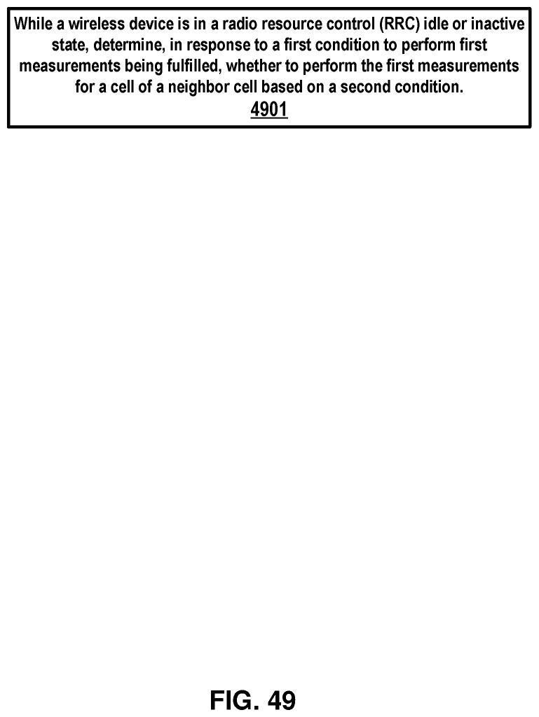

FIG. 49 illustrates an example flow chart of performing a procedure as per an aspect of an embodiment of the present disclosure. At 4901, according to example embodiment(s) (e.g., referring to FIG. 39. and FIG. 40) in the present disclosure, a wireless device may, while a wireless device is in a radio resource control (RRC) idle or inactive state, determine, in response to a first condition to perform first measurements being fulfilled, whether to perform the first measurements for a cell of a neighbor cell based on a second condition.

In an example of FIG. 34, FIG. 35, FIG. 36, FIG. 37 and/or FIG. 38, a wireless device may receive, via a non-terrestrial network (NTN) cell, one or more system information blocks (SIBs) indicating: a first measurement requirement, for a measurement, for a low earth orbit (LEO) cell while the wireless device is in a radio resource control (RRC) idle or inactive state; and a list of terrestrial network (TN) coverage areas. Each TN coverage area may be associated with one or more TN frequencies. The wireless device may transmit, to a cell, an uplink packet. The cell may be selected based on performing the measurement, by the wireless device on the one or more LEO cells, applying the first measurement requirement. The wireless device may apply the first measurement requirement is based on whether the wireless device being in at least one of the list of TN coverage areas while the wireless device camps on the NTN cell in the RRC idle or inactive state.

In an example of FIG. 34, FIG. 35, FIG. 36, FIG. 37 and/or FIG. 38, a wireless device may receive, via a non-terrestrial network (NTN) cell, one or more system information blocks (SIBs) indicating: a first measurement requirement, for a measurement, for a low earth orbit (LEO) cell while the wireless device is in a radio resource control (RRC) idle or inactive state; and a list of terrestrial network (TN) coverage areas, wherein each TN coverage area is associated with one or more TN frequencies. While the wireless device camps on the NTN cell in the RRC idle or inactive state and performs the measurement on one or more LEO cells, determining whether to apply the first measurement requirement for the measurement based on the wireless device being in at least one TN coverage area of the list of TN coverage areas.

In an example of FIG. 34, FIG. 35, FIG. 36, FIG. 37 and/or FIG. 38, the wireless device may apply the first measurement requirement for the measurement based on the wireless device being in at least one TN coverage area of the list of TN coverage areas. The wireless device may not apply the first measurement requirement for the measurement based on the wireless device being in at least one TN coverage area of the list of TN coverage areas. The wireless device may perform a cell reselection to a cell based on performing the measurement on the one or more LEO cells, the wireless device may transmit an uplink packet to the cell.

In an example of FIG. 34, FIG. 35, FIG. 36, FIG. 37 and/or FIG. 38, while a wireless device is in a radio resource control (RRC) idle or inactive state, the wireless device may determine whether to apply a first measurement requirement, for a measurement, for one or more low earth orbit (LEO) cells based on the wireless device being in a terrestrial network (TN) coverage area.

In an example of FIG. 34, FIG. 35, FIG. 36, FIG. 37 and/or FIG. 38, the wireless device may receive, via a non-terrestrial network (NTN) cell, one or more system information blocks (SIBs) indicating: the first measurement requirement, for the measurement, for the one or more LEO cells while the wireless device is in the RRC idle or inactive state; and a list of TN coverage areas. The list of TN coverage areas may comprise the TN coverage area. Each TN coverage area of the list of TN coverage areas may be associated with one or more TN frequencies.

In an example of FIG. 34, FIG. 35, FIG. 36, FIG. 37 and/or FIG. 38, the wireless device may determine whether to apply the first measurement requirement comprises determining whether to apply a first measurement requirement while the wireless device camps on the NTN cell in the RRC idle or inactive state and performs the measurement on one or more LEO cells.

In an example of FIG. 34, FIG. 35, FIG. 36, FIG. 37 and/or FIG. 38, the wireless device may determine, based on the list of TN coverage areas, whether the wireless device is in the TN coverage area.

In an example of FIG. 34, FIG. 35, FIG. 36, FIG. 37 and/or FIG. 38, determining of the wireless device being in the TN coverage area may be based on: a distance between a location of the wireless device and a reference location of the TN coverage area being lower than a distance threshold associated with the TN coverage area; the location of the wireless device being within the TN coverage area; and/or the wireless device detecting a cell associated with the TN coverage area.

In an example of FIG. 34, FIG. 35, FIG. 36, FIG. 37 and/or FIG. 38, the wireless device may not apply, based on the wireless device being in the TN coverage area, the first measurement requirement, for the measurement, for one or more LEO cells, the wireless device may apply, based on the wireless device not being in the TN coverage area, the first measurement requirement, for the measurement, for one or more LEO cells. not applying the first measurement requirement for the measurement may comprise: applying a second measurement requirement for the measurement;

and/or applying a third measurement requirement for the measurement. applying the first measurement requirement for the measurement may comprise: not applying the second measurement requirement for the measurement; and/or not applying the third measurement requirement for the measurement.

In an example of FIG. 34, FIG. 35, FIG. 36, FIG. 37 and/or FIG. 38, based on applying the first measurement requirement, for the measurement, for one or more LEO cells, the wireless device may evaluate whether a cell, of the one or more LEO cells, meets a reselection criteria, for a cell reselection, within a first evaluation time period; and/or measure a signal strength of a cell, of the one or more LEO cells, per a first time period.

In an example of FIG. 34, FIG. 35, FIG. 36, FIG. 37 and/or FIG. 38, the first measurement requirement may indicate: that the wireless device evaluates whether a cell, of the one or more LEO cells, meets a reselection criteria, for a cell reselection, within a first evaluation time period; and/or that the wireless device measures the signal strength of a cell, of the one or more LEO cells, per a first time period.

In an example of FIG. 34, FIG. 35, FIG. 36, FIG. 37 and/or FIG. 38, based on applying the second measurement requirement, for the measurement, for one or more LEO cells, the wireless device may evaluate whether a cell, of the one or more LEO cells, meets a reselection criteria, for a cell reselection, within a second evaluation time period; and/or measure the signal strength of a cell, of the one or more LEO cells, per a second time period.

In an example of FIG. 34, FIG. 35, FIG. 36, FIG. 37 and/or FIG. 38, the second measurement requirement may indicate: that the wireless device evaluates whether a cell, of the one or more LEO cells, meets a reselection criteria, for a cell reselection, within a second evaluation time period; and/or that the wireless device measures the signal strength of a cell, of the one or more LEO cells, per a second time period.

In an example of FIG. 34, FIG. 35, FIG. 36, FIG. 37 and/or FIG. 38, based on applying the third measurement requirement, for the measurement, for one or more LEO cells, the wireless device may evaluate whether a cell, of the one or more LEO cells, meets a reselection criteria, for a cell reselection, within a third evaluation time period; and/or measure the signal strength of a cell, of the one or more LEO cells, per a third time period.

In an example of FIG. 34, FIG. 35, FIG. 36, FIG. 37 and/or FIG. 38, the third measurement requirement may indicate: that the wireless device evaluates whether a cell, of the one or more LEO cells, meets a reselection criteria, for a cell reselection, within a third evaluation time period; and/or that the wireless device measures the signal strength of a cell, of the one or more LEO cells, per a third time period.

In an example of FIG. 34, FIG. 35, FIG. 36, FIG. 37 and/or FIG. 38, applying the third measurement requirement may comprise a relaxation of the second measurement requirement. performing the measurement applying the third measurement requirement may be performing a relaxed measurement.

In an example of FIG. 34, FIG. 35, FIG. 36, FIG. 37 and/or FIG. 38, the signal strength may comprise: synchronization signal based reference signal received power (SS-RSRP); and/or synchronization signal based reference signal received quality (SS-RSRQ).

In an example of FIG. 34, FIG. 35, FIG. 36, FIG. 37 and/or FIG. 38, the first evaluation time period may be shorter than the second evaluation time period, the first time period may be shorter than the second time period. The third evaluation time period may be longer than the second evaluation time period, the third time period may be longer than the second time period.

In an example of FIG. 34, FIG. 35, FIG. 36, FIG. 37 and/or FIG. 38, the first measurement requirement may be an enhanced measurement requirement. The second measurement requirement may be a normal measurement requirement. The third measurement requirement may be a relaxed measurement requirement.

In an example of FIG. 34, FIG. 35, FIG. 36, FIG. 37 and/or FIG. 38, a wireless device may receive, via a non-terrestrial network (NTN) cell, one or more system information blocks comprising: an indication of measurements, by the wireless device, on a low earth orbit (LEO) cell while the wireless device is in a radio resource control (RRC) idle or inactive state; and a list of terrestrial network (TN) coverage areas. Each TN coverage area may be associated with one or more TN frequencies. The wireless device may determine to perform the measurements on one or more LEO cells, while the wireless device is camping on the NTN cell in the RRC idle or inactive state, based on whether the wireless device is in a TN coverage area of the list of TN coverage areas.

In an example of FIG. 35, FIG. 36, FIG. 37, FIG. 38, and/or FIG. 47, a wireless device may receive, via a non-terrestrial network (NTN) cell, one or more system information blocks (SIBs) comprising: a configuration indicating a first condition to perform first measurements, by the wireless device, for a neighbor cell while the wireless device is in a radio resource control (RRC) idle or inactive state; and a list of terrestrial network (TN) coverage areas. Each TN coverage area is associated with one or more TN frequencies. The wireless device may transmit, to a cell, an uplink packet, wherein the cell is selected based on performing the first measurements, by the wireless device on one or more cells of the neighbor cell, based on: whether the wireless device is in at least one TN coverage area of the list of TN coverage areas while the wireless device camps on the NTN cell in the RRC idle or inactive state; and the first condition being fulfilled.

In an example of FIG. 35, FIG. 36, FIG. 37, FIG. 38, and/or FIG. 47, first measurements, a wireless device may receive, via a non-terrestrial network (NTN) cell, one or more system information blocks (SIBs) comprising: a configuration indicating a first condition to perform first measurements, by the wireless device, for a neighbor cell while the wireless device is in a radio resource control (RRC) idle or inactive state; and a list of terrestrial network (TN) coverage areas. Each TN coverage area may be associated with one or more TN frequencies. while the wireless device camps on the NTN cell in the RRC idle or inactive state, the wireless device may determine whether to perform the first measurements on a first cell, of the neighbor cell, based on: the wireless device being in at least one TN coverage area of the list of TN coverage areas; and the first condition being fulfilled.

In an example of FIG. 35, FIG. 36, FIG. 37, FIG. 38, and/or FIG. 47, first measurements, while a wireless device is in a radio resource control (RRC) idle or inactive state, the wireless device may determining whether to perform first measurements for a cell of a neighbor cell based on: the wireless device is in a terrestrial network (TN) coverage area; and a first condition, to perform the first measurements, is fulfilled.

In an example of FIG. 34, FIG. 35, FIG. 36, FIG. 37 and/or FIG. 38 first measurements, the wireless device may receive, via a non-terrestrial network (NTN) cell, one or more system information blocks (SIBs) comprising: a configuration indicating the first condition to perform the first measurements for the cell of the neighbor cell while the wireless device is in a radio resource control (RRC) idle or inactive state; and a list of TN coverage areas. The list of TN coverage areas may comprise the TN coverage area. Each TN coverage area of the list of TN coverage areas may be associated with one or more TN frequencies. Determining whether to perform the first measurements may comprise determining whether to perform the first measurements while the wireless device camps on the NTN cell in the RRC idle or inactive state and/or perform the measurement on the neighbor cell.

In an example of FIG. 35, FIG. 36, FIG. 37, FIG. 38, and/or FIG. 47, first measurements, the wireless device may determine, based on the list of TN coverage areas, whether the wireless device is in the TN coverage area. Determining of the wireless device being in the TN coverage area may be based on: a distance between a location of the wireless device and a reference location of the TN coverage area being lower than a distance threshold associated with the TN coverage area; the location of the wireless device being within the TN coverage area; and/or the wireless device detecting a cell associated with the TN coverage area.

In an example of FIG. 35, FIG. 36, FIG. 37, FIG. 38, and/or FIG. 47, first measurements, the wireless device may not perform the first measurements for the cell of the neighbor cell based on: the wireless device being in the TN coverage area; and/or the first condition not being fulfilled. The wireless device may perform the first measurements for the cell of the neighbor cell based on: the wireless device not being in the TN coverage area; and the first condition not being fulfilled.

In an example of FIG. 35, FIG. 36, FIG. 37, FIG. 38, and/or FIG. 47, first measurements, not performing the first measurements may comprise performing a second measurement. Performing the first measurements may comprise not performing the second measurement.

In an example of FIG. 35, FIG. 36, FIG. 37, FIG. 38, and/or FIG. 47, first measurements, based on performing the first measurements for the cell of the neighbor cell, the wireless device may evaluate whether the meets a reselection criteria, for a cell reselection, within a first evaluation time period.

In an example of FIG. 35, FIG. 36, FIG. 37, FIG. 38, and/or FIG. 47, first measurements, based on performing the second measurement for the cell of the neighbor cell, the wireless device may evaluate whether the cell meets a reselection criteria, for a cell reselection, within a second evaluation time period; and/or measure the signal strength of the cell per a time period.

In an example of FIG. 35, FIG. 36, FIG. 37, FIG. 38, and/or FIG. 47, first measurements, the first measurements may be a relaxed measurement, the second measurement may be a normal measurement. Performing the first measurements may comprise a relaxation of the second measurement.

In an example of FIG. 35, FIG. 36, FIG. 37, FIG. 38, and/or FIG. 47, first measurements, the signal strength may comprise: synchronization signal based reference signal received power (SS-RSRP); and/or synchronization signal based reference signal received quality (SS-RSRQ).

In an example of FIG. 35, FIG. 36, FIG. 37, FIG. 38, and/or FIG. 47, 38 first measurements, the first evaluation time period may be shorter than the second evaluation time period, the first time period may be shorter than the second time period.

In an example of FIG. 35, FIG. 36, FIG. 37, FIG. 38, and/or FIG. 47, first measurements, the first condition may comprise at least one of: a low mobility condition, for the wireless device with low mobility; or a not-at-cell edge condition, for the wireless device not being at cell edge.

In an example of FIG. 35, FIG. 36, FIG. 37, FIG. 38, and/or FIG. 47, first measurements, the first condition being fulfilled may comprise at least one of: the low mobility condition being fulfilled; or the not-at-cell edge condition being fulfilled.

In an example of FIG. 35, FIG. 36, FIG. 37, FIG. 38, and/or FIG. 47, first measurements, the low mobility condition being fulfilled may be based on a difference between a reference cell selection value, of a serving cell of the wireless device, and a current cell selection value, of the serving cell of the wireless device, being lower than a first threshold.

In an example of FIG. 35, FIG. 36, FIG. 37, FIG. 38, and/or FIG. 47, first measurements, the not-at-cell edge condition being fulfilled may be based on a cell selection value, of a serving cell of the wireless device, higher than a second threshold.

In an example of FIG. 35, FIG. 36, FIG. 37, FIG. 38, and/or FIG. 47, first measurements, while a wireless device is in a radio resource control (RRC) idle or inactive state, the wireless device may determine, in response to a first condition to perform first measurements being fulfilled, whether to perform the first measurements for a cell of a neighbor cell based on a second condition.

In an example of FIG. 35, FIG. 36, FIG. 37, FIG. 38, and/or FIG. 47, first measurements, determining whether to perform the first measurements for the cell of the neighbor cell based on the second condition may comprise: determining to perform the first measurements for the cell of the neighbor cell based on the second condition being fulfilled; and determining not to perform the first measurements for the cell of the neighbor cell based on the second condition not being fulfilled.

In an example of FIG. 35, FIG. 36, FIG. 37, FIG. 38, and/or FIG. 47, first measurements, the second condition may be associated with at least one of: a cell coverage area; a location of the wireless device; a mobility of the wireless device; or a signal strength of the cell, the cell coverage area may be a terrestrial network (TN) coverage area.

In an example of FIG. 35, FIG. 36, FIG. 37, FIG. 38, and/or FIG. 47, first measurements, the second condition being fulfilled may comprise at least one of: a distance between the location of the wireless device and a center of the cell coverage area being higher than a threshold; the location of the wireless device not being in the cell coverage area; the mobility of the wireless device not being high mobility; the mobility of the wireless device being low mobility; or a signal strength of the cell being higher than a threshold.

In an example of FIG. 35, FIG. 36, FIG. 37, FIG. 38, and/or FIG. 47, 38 first measurements, the second condition not being fulfilled may comprise at least one of: a distance between the location of the wireless device and a center of the cell coverage area being lower than a threshold; the location of the wireless device being in the cell coverage area; the mobility of the wireless device being high mobility; the mobility of the wireless device not being low mobility; or a signal strength of the cell being lower than a threshold.

Clause 1. A method comprising: receiving, by a wireless device via a non-terrestrial network (NTN) cell, one or more system information blocks (SIBs) indicating: a first measurement requirement, for a measurement, for a non-geosynchronous orbit (NGSO) cell while the wireless device is in a radio resource control (RRC) idle state or an RRC inactive state; and a list of terrestrial network (TN) coverage areas, wherein each TN coverage area is associated with one or more TN frequencies; and transmitting, to the NGSO cell, an uplink packet, wherein: the NGSO cell is selected based on performing the measurement, by the wireless device on the one or more NGSO cells, applying the first measurement requirement; and applying the first measurement requirement is based on whether the wireless device being in at least one of the list of TN coverage area while the wireless device camps on the NTN cell in the RRC idle state or the RRC inactive state.

Clause 2. A method comprising: transmitting, by a wireless device, an uplink packet using one or more measurements for a first cell based on: a first measurement requirement; and whether the wireless device is in a terrestrial network (TN) coverage area.

Clause 3. The method of clause 2, wherein the first cell is: a non-terrestrial networks (NTN) cell; a low earth orbit (LEO) cell; or a non-geosynchronous orbit (NGSO) cell.

Clause 4. The method of any one of clauses 2 to 3, further comprising determining, by the wireless device, to transmit the uplink packet to the first cell based on the one or more measurements for the first cell.

Clause 5. The method of any one of clauses 2 to 4, wherein the wireless device is camped on a non-terrestrial network (NTN) cell in a radio resource control (RRC) idle state or an RRC inactive state while the first measurement requirement is applied.

Clause 6. The method of any one of clauses 2 to 5, further comprising: receiving, by the wireless device from an NTN cell, one or more system information blocks (SIBs) indicating at least one of: the first measurement requirement for the first cell; and the TN coverage area.

Clause 7. The method of clause 6, wherein the SIBs further indicate at least one of: a list of TN coverage areas comprising the TN coverage area; and one or more TN frequencies for each of a plurality of TN coverage areas in the list of TN coverage areas.

Clause 8. The method of any one of clauses 2 to 7, further comprising determining, by the wireless device and based on the TN coverage area, whether the wireless device is in the TN coverage area.

Clause 9. The method of any one of clauses 2 to 8, wherein being in the TN coverage area is based on at least one of: a distance between a location of the wireless device and a reference location of the TN coverage area being lower than a distance threshold associated with the TN coverage area; the location of the wireless device being within the TN coverage area; and the wireless device detecting a cell associated with the TN coverage area.

Clause 10. The method of any one of clauses 2 to 9, further comprising not applying, by the wireless device, the first measurement requirement for the one or more measurements of the first cell based on the wireless device being in the TN coverage area.

Clause 11. The method of any one of clauses 2 to 10, further comprising performing, by the wireless device, a cell reselection to the first cell based on the one or more measurements on the first cell.

Clause 12. The method of any one of clauses 2 to 11, wherein the first measurement requirement is an enhanced measurement requirement.

Clause 13. The method of any one of clauses 2 to 12, further comprising applying, by the wireless device, the first measurement requirement for measuring the first cell based on the wireless device not being in the TN coverage area.

Clause 14. The method of clause 13, further comprising determining, by the wireless device and based on the first measurement requirement, whether the first cell meets a reselection criteria, for a cell reselection, within a first evaluation time period.

Clause 15. The method of any one of clauses 13 to 14, further comprising measuring, by the wireless device and based on the first measurement requirement, a signal strength of the first cell in a first time period.

Clause 16. The method of clause 13, wherein applying the first measurement requirement for the one or more measurements comprises at least one of: not applying a second measurement requirement for the one or more measurements; and not applying a third measurement requirement for the one or more measurements.

Clause 17. The method of any one of clauses 2 to 16, further comprising not applying, by the wireless device, the first measurement requirement for measuring the first cell based on the wireless device being in the TN coverage area.

Clause 18. The method of clause 17, wherein not applying the first measurement requirement comprises: determining, by the wireless device, whether the first cell meets a reselection criteria, for a cell reselection, with a second evaluation time period; and measuring, by the wireless device, one or more signal strengths of the first cell in a second time period.

Clause 19. The method of clause 18, wherein: the first evaluation time period is shorter than the second evaluation time period; and the first time period is shorter than the second time period.

Clause 20. The method of any one of clauses 17 to 19, wherein not applying the first measurement requirement for the one or more measurements comprises at least one of: applying a second measurement requirement for the one or more measurements; and applying a third measurement requirement for the one or more measurements.

Clause 21. The method of clause 20, further comprising, based on applying the second measurement requirement, at least one of: determining, by the wireless device, whether the first cell meets a reselection criteria, for a cell reselection, within a second evaluation time period; and measuring, by the wireless device, a signal strength of the first cell in a second time period.

Clause 22. The method of any one of clauses 20 to 21, further comprising, based on applying the third measurement requirement, at least one of: determining, by the wireless device, whether the first cell meets a reselection criteria, for a cell reselection, within a third evaluation time period; and measuring, by the wireless device, a signal strength of the first cell in a third time period.

Clause 23. The method of clause 22, wherein: the third evaluation time period is no shorter than the second evaluation time period; and the third time period is no shorter than the second time period.

Clause 24. The method of any one of clauses 20 to 23, wherein: the second measurement requirement is a normal measurement requirement; and the third measurement requirement is a relaxed measurement requirement.

Clause 25. The method of any one of clauses 18 to 24, wherein not applying the first measurement requirement comprises: a relaxation of the second measurement requirement; or performing a relaxed measurement.

Clause 26. The method of any one of clauses 15 to 25, wherein the signal strength comprises at least one of: synchronization signal based reference signal received power (SS-RSRP); and synchronization signal based reference signal received quality (SS-RSRQ).

Clause 27. The method of any one of clauses 2 to 26, wherein the measuring a signal strength of the first cell is while the wireless device camps on an NTN cell in an RRC idle state or an RRC inactive state.

Clause 28. The method of any one of clauses 2 to 27, wherein the first cell is a TN cell of a neighbor cell.

Clause 29. The method of any one of clauses 2 to 28, wherein the first measurement requirement is a first condition.

Clause 30. The method of any one of clauses 2 to 29, wherein the one or more measurements for the first cell are determined based on whether the wireless device is in the TN coverage area in response to the first measurement requirement being satisfied.

Clause 31. The method of any one of clauses 2 to 30, further comprising not performing a first measurement of the one or more measurements of the first cell based on: the wireless device being in the TN coverage area; or the first measuring requirement not being fulfilled.

Clause 32. The method of any one of clauses 2 to 31, further comprising performing the first measurement for the first cell based on: the wireless device not being in the TN coverage area; and the first measuring requirement being fulfilled.

Clause 33. The method of any one of clauses 2 to 32, further comprising performing a second measurement of the one or more measurements for the cell in response to not performing the first measurement of the first cell.

Clause 34. The method of clause 33, further comprising, based on the performing the first measurement for the first cell, not performing the second measurement of the first cell.

Clause 35. The method of any one of clauses 33 to 34, further comprising, based on performing the first measurements for the first cell of a neighbor cell, evaluating whether the first cell meets a reselection criteria, for a cell reselection, within a first evaluation time period.

Clause 36. The method of any one of clauses 33 to 35, further comprising, based on performing the second measurement for the first cell, at least one of: evaluating whether the first cell meets a reselection criteria, for a cell reselection, within a second evaluation time period; and measuring a signal strength, of the first cell, in a time period.

Clause 37. The method of any one of clauses 33 to 36, wherein: the first measurements is a relaxed measurement; the second measurement is a normal measurement; and performing the first measurements comprises a relaxation of the second measurement.

Clause 38. The method of any one of clauses 36 to 37, wherein: the first evaluation time period is shorter than the second evaluation time period; and the first time period is shorter than the second time period.

Clause 39. The method of any one of clauses 2 to 38, wherein the first measurement requirement is met in response to the wireless device having at least one of: a low mobility condition; or a not-at-cell edge condition.

Clause 40. The method of any one of clauses 2 to 39, wherein the first measurement requirement comprises at least one of: a low mobility condition, for the wireless device with low mobility; or a not-at-cell edge condition, for the wireless device not being at cell edge.

Clause 41. The method of any one of clauses 2 to 40, wherein the first measurement requirement being fulfilled comprises at least one of: a low mobility condition being fulfilled; or a not-at-cell edge condition being fulfilled.

Clause 42. The method of any one of clauses 39 to 41, wherein the low mobility condition being fulfilled is based on a difference between a reference cell selection value, of a serving cell of the wireless device, and a current cell selection value, of the serving cell of the wireless device, being lower than a first threshold.

Clause 43. The method of any one of clauses 39 to 42, wherein the not-at-cell edge condition being fulfilled is based on a cell selection value, of a serving cell of the wireless device, higher than a second threshold.

Clause 44. A method comprising: transmitting, by a wireless device and in response to a first condition to perform a first measurement being fulfilled, an uplink packet using the first measurement for a cell of a neighbor cell, wherein the first measurement is based on the wireless device being in a terrestrial network (TN) coverage area.

Clause 45. A method comprising: determining, by a wireless device, whether to apply a first measurement requirement for a measurement, for one or more non-terrestrial network (NTN) cells based on the wireless device being in a terrestrial network (TN) coverage area.

Clause 46. A method comprising: determining, by a wireless device and in response to a first condition to perform a first measurement being fulfilled, whether to perform first measurements for a cell of a neighbor cell based on the wireless device being in a terrestrial network (TN) cover area.

Clause 47. A method comprising: receiving, by a base station from a wireless device, an uplink packet based on performing one or more measurements of a first cell, wherein the one or more measurements are based on: a first measurement requirement; and whether the wireless device is in a terrestrial network (TN) coverage area.

Clause 48. A method comprising: receiving, by a wireless device via a cell, one or more system information blocks (SIBs) comprising a configuration indicating a first condition to perform first measurements, by the wireless device, for a neighbor cell while the wireless device is in a radio resource control (RRC) idle state or RRC inactive state; and while the wireless device camps on the cell in the RRC idle state or RRC inactive state, determining, in response to the first condition being fulfilled, whether to perform the first measurements on a first cell, of the neighbor cell, based on the wireless device being in a TN coverage area.

Clause 49. An apparatus comprising: one or more processors; and memory storing instructions that, when executed by the one or more processors, cause the apparatus to perform the method of any one of clauses 1 to 48.

Clause 50. A non-transitory computer-readable medium comprising instructions that, when executed by one or more processors of an apparatus, cause the apparatus to perform the method of any one of clauses 1 to 48.

Clause 51. A method comprising: transmitting, by a base station to a wireless device and via a non-terrestrial network (NTN) cell, one or more system information blocks (SIBs) indicating: a first measurement requirement, for a measurement, for a non-geosynchronous orbit (NGSO) cell while the wireless device is in a radio resource control (RRC) idle state or an RRC inactive state; and a list of terrestrial network (TN) coverage areas, wherein each TN coverage area is associated with one or more TN frequencies; and receiving, from the wireless device via the NGSO cell, an uplink packet, wherein: the NGSO cell is selected based on performing the measurement, by the wireless device on the one or more NGSO cells, applying the first measurement requirement; and applying the first measurement requirement is based on whether the wireless device being in at least one of the list of TN coverage area while the wireless device camps on the NTN cell in the RRC idle state or the RRC inactive state.

Clause 52. A method comprising: receiving, by a wireless device via a non-terrestrial network (NTN) cell, one or more system information blocks (SIBs) indicating: a first measurement requirement, for a measurement, for a non-geosynchronous orbit (NGSO) cell while the wireless device is in a radio resource control (RRC) idle or inactive state; and a list of terrestrial network (TN) coverage areas, wherein each TN coverage area is associated with one or more TN frequencies; and transmitting, to a cell, an uplink packet, wherein: the cell is selected based on performing the measurement, by the wireless device on the one or more NGSO cells, applying the first measurement requirement; and applying the first measurement requirement is based on whether the wireless device being in at least one of the list of TN coverage area while the wireless device camps on the NTN cell in the RRC idle or inactive state.

Clause 53. A method comprising: receiving, by a wireless device via a non-terrestrial network (NTN) cell, one or more system information blocks (SIBs) indicating: a first measurement requirement, for a measurement, for a non-geosynchronous orbit (NGSO) cell while the wireless device is in a radio resource control (RRC) idle or inactive state; and a list of terrestrial network (TN) coverage areas, wherein each TN coverage area is associated with one or more TN frequencies; and performing cell reselection, wherein: the cell is selected based on performing the measurement, by the wireless device on the one or more NGSO cells, applying the first measurement requirement; and applying the first measurement requirement is based on whether the wireless device being in at least one of the list of TN coverage area while the wireless device camps on the NTN cell in the RRC idle or inactive state.

Clause 54. A method comprising: receiving, by a wireless device via a non-terrestrial network (NTN) cell, one or more system information blocks (SIBs) indicating: a first measurement requirement, for a measurement, for a low earth orbit (LEO) cell while the wireless device is in a radio resource control (RRC) idle or inactive state; and a list of terrestrial network (TN) coverage areas, wherein each TN coverage area is associated with one or more TN frequencies; and while the wireless device camps on the NTN cell in the RRC idle or inactive state and performs the measurement on one or more LEO cells, determining whether to apply the first measurement requirement for the measurement based on the wireless device being in at least one TN coverage area of the list of TN coverage areas.

Clause 55. The method of clause 54, further comprising: applying the first measurement requirement for the measurement based on the wireless device being in at least one TN coverage area of the list of TN coverage areas; or not applying the first measurement requirement for the measurement based on the wireless device being in at least one TN coverage area of the list of TN coverage areas.

Clause 56. The method of clause 54, further comprising performing a cell reselection to a cell based on performing the measurement on the one or more LEO cells.

Clause 57. The method of clause 56, further comprising transmitting an uplink packet to the cell.

Clause 58. A method comprising: determining, by a wireless device, whether to apply a first measurement requirement, for a measurement, for one or more non-terrestrial network (NTN) cells based on whether the wireless device being in a terrestrial network (TN) coverage area.

Clause 59. The method of clause 58, wherein determining whether to apply the first measurement requirement comprises determining whether to apply a first measurement requirement while the wireless device camps on the NTN cell in the RRC idle or inactive state and performs the measurement on one or more LEO cells.

Clause 60. The method of clause 58, further comprising receiving, by the wireless device via a non-terrestrial network (NTN) cell, one or more system information blocks (SIBs) indicating: the first measurement requirement, for the measurement, for the one or more LEO cells while the wireless device is in the RRC idle or inactive state; and a list of TN coverage areas, wherein: the list of TN coverage areas comprises the TN coverage area; and each TN coverage area of the list of TN coverage areas is associated with one or more TN frequencies.

Clause 61. The method of clause 60, further comprising determining, based on the list of TN coverage areas, whether the wireless device is in the TN coverage area.

Clause 62. The method of clause 61, wherein determining of the wireless device being in the TN coverage area is based on: a distance between a location of the wireless device and a reference location of the TN coverage area being lower than a distance threshold associated with the TN coverage area; the location of the wireless device being within the TN coverage area; and/or the wireless device detecting a cell associated with the TN coverage area.

Clause 63. The method of clause 60, further comprising: not applying, based on the wireless device being in the TN coverage area, the first measurement requirement, for the measurement, for one or more LEO cells; or applying, based on the wireless device not being in the TN coverage area, the first measurement requirement, for the measurement, for one or more LEO cells.

Clause 64. The method of clause 63, wherein not applying the first measurement requirement for the measurement comprises: applying a second measurement requirement for the measurement; and/or applying a third measurement requirement for the measurement.

Clause 65. The method of clause 64, wherein applying the first measurement requirement for the measurement comprises: not applying the second measurement requirement for the measurement; and/or not applying the third measurement requirement for the measurement.

Clause 66. The method of any one of clauses 64 to 65, further comprising, based on applying the first measurement requirement, for the measurement, for one or more LEO cells: evaluating whether a cell, of the one or more LEO cells, meets a reselection criteria, for a cell reselection, within a first evaluation time period; and measuring a signal strength of a cell, of the one or more LEO cells, per a first time period.

Clause 67. The method of any one of clauses 64 to 65, wherein the first measurement requirement indicates: that the wireless device evaluates whether a cell, of the one or more LEO cells, meets a reselection criteria, for a cell reselection, within a first evaluation time period; and that the wireless device measures the signal strength of a cell, of the one or more LEO cells, per a first time period.

Clause 68. The method of any one of clauses 64 to 65, further comprising, based on applying the second measurement requirement, for the measurement, for one or more LEO cells: evaluating whether a cell, of the one or more LEO cells, meets a reselection criteria, for a cell reselection, within a second evaluation time period; and measuring the signal strength of a cell, of the one or more LEO cells, per a second time period.

Clause 69. The method of any one of clauses 64 to 65, wherein the second measurement requirement indicates: that the wireless device evaluates whether a cell, of the one or more LEO cells, meets a reselection criteria, for a cell reselection, within a second evaluation time period; and that the wireless device measures the signal strength of a cell, of the one or more LEO cells, per a second time period.

Clause 70. The method of any one of clauses 64 to 65, further comprising, based on applying the third measurement requirement, for the measurement, for one or more LEO cells: evaluating whether a cell, of the one or more LEO cells, meets a reselection criteria, for a cell reselection, within a third evaluation time period; and measuring the signal strength of a cell, of the one or more LEO cells, per a third time period.

Clause 71. The method of any one of clauses 64 to 65, wherein the third measurement requirement indicates: that the wireless device evaluates whether a cell, of the one or more LEO cells, meets a reselection criteria, for a cell reselection, within a third evaluation time period; and that the wireless device measures the signal strength of a cell, of the one or more LEO cells, per a third time period.

Clause 72. The method of clause 70, wherein: applying the third measurement requirement comprises a relaxation of the second measurement requirement; and/or performing the measurement applying the third measurement requirement is performing a relaxed measurement.

Clause 73. The method of any one of clauses 66 to 72, wherein the signal strength comprises:
synchronization signal based reference signal received power (SS-RSRP); and/or synchronization signal based reference signal received quality (SS-RSRQ).

Clause 74. The method of any one of clauses 66 to 73, wherein: the first evaluation time period is shorter than the second evaluation time period; the first time period is shorter than the second time period; the third evaluation time period is longer than the second evaluation time period; and the third time period is longer than the second time period.

Clause 75. The method of any one of clauses 66 to 74, wherein: the first measurement requirement is an enhanced measurement requirement; the second measurement requirement is a normal measurement requirement; and the third measurement requirement is a relaxed measurement requirement.

Clause 76. A method comprising: receiving, by a wireless device via a non-terrestrial network (NTN) cell, one or more system information blocks comprising: an indication of measurements, by the wireless device, on a low earth orbit (LEO) cell while the wireless device is in a radio resource control (RRC) idle or inactive state; and a list of terrestrial network (TN) coverage areas, wherein each TN coverage area is associated with one or more TN frequencies; determining to perform the measurements on one or more LEO cells, while the wireless device is camping on the NTN cell in the RRC idle or inactive state, based on whether the wireless device is in a TN coverage area of the list of TN coverage areas.

Clause 77. A method comprising: receiving, by a wireless device via a non-terrestrial network (NTN) cell, one or more system information blocks (SIBs) comprising: a configuration indicating a first condition to perform first measurements, by the wireless device, for a neighbor cell while the wireless device is in a radio resource control (RRC) idle or inactive state; and a list of terrestrial network (TN) coverage areas, wherein each TN coverage area is associated with one or more TN frequencies; and transmitting, to a cell, an uplink packet, wherein the cell is selected based on performing the first measurements, by the wireless device on one or more cells of the neighbor cell, based on: whether the wireless device is in at least one TN coverage area of the list of TN coverage areas while the wireless device camps on the NTN cell in the RRC idle or inactive state; and the first condition being fulfilled.

Clause 78. A method comprising: receiving, by a wireless device via a non-terrestrial network (NTN) cell, one or more system information blocks (SIBs) comprising: a configuration indicating a first condition to perform first measurements, by the wireless device, for a neighbor cell while the wireless device is in a radio resource control (RRC) idle or inactive state; and a list of terrestrial network (TN) coverage areas, wherein each TN coverage area is associated with one or more TN frequencies; and while the wireless device camps on the NTN cell in the RRC idle or inactive state, determining whether to perform the first measurements on a first cell, of the neighbor cell, based on: the wireless device being in at least one TN coverage area of the list of TN coverage areas; and the first condition being fulfilled.

Clause 79. A method comprising: while a wireless device is in a radio resource control (RRC) idle or inactive state, determining, by the wireless device and in response to a first condition to perform a first measurement being fulfilled, whether to perform the first measurements for a cell of a neighbor cell based on the wireless device is in a terrestrial network (TN) coverage area.

Clause 80. The method of clause 79, further comprising receiving, by the wireless device via a non-terrestrial network (NTN) cell, one or more system information blocks (SIBs) comprising: a configuration indicating the first condition to perform the first measurements for the cell of the neighbor cell while the wireless device is in a radio resource control (RRC) idle or inactive state; and a list of TN coverage areas, wherein: the list of TN coverage areas comprises the TN coverage area; and each TN coverage area of the list of TN coverage areas is associated with one or more TN frequencies.

Clause 81. The method of clause 79, wherein determining whether to perform the first measurements comprises determining whether to perform the first measurements while the wireless device camps on the NTN cell in the RRC idle or inactive state and performs the measurement on the neighbor cell.

Clause 82. The method of clause 79, further comprising determining, based on the list of TN coverage areas, whether the wireless device is in the TN coverage area.

Clause 83. The method of clause 82, wherein determining of the wireless device being in the TN coverage area is based on: a distance between a location of the wireless device and a reference location of the TN coverage area being lower than a distance threshold associated with the TN coverage area; the location of the wireless device being within the TN coverage area; and/or the wireless device detecting a cell associated with the TN coverage area.

Clause 84. The method of any one of clauses 79 to 83, further comprising: not performing the first measurements for the cell of the neighbor cell based on: the wireless device being in the TN coverage area; or the first condition not being fulfilled; and performing the first measurements for the cell of the neighbor cell based on: the wireless device not being in the TN coverage area; and the first condition not being fulfilled.

Clause 85. The method of clause 84, wherein not performing the first measurements comprises performing a second measurement.

Clause 86. The method of clause 85, wherein performing the first measurements comprises not performing the second measurement.

Clause 87. The method of any one of clauses 84 to 86, further comprising, based on performing the first measurements for the cell of the neighbor cell, evaluating whether the meets a reselection criteria, for a cell reselection, within a first evaluation time period.

Clause 88. The method of any one of clauses 84 to 87, further comprising, based on performing the second measurement for the cell of the neighbor cell: evaluating whether the cell meets a reselection criteria, for a cell reselection, within a second evaluation time period; and measuring the signal strength of the cell per a time period.

Clause 89. The method of any one of clauses 84 to 88, wherein: the first measurements is a relaxed measurement; the second measurement is a normal measurement; and performing the first measurements comprises a relaxation of the second measurement.

Clause 90. The method of clause 89, wherein the signal strength comprises: synchronization signal based reference signal received power (SS-RSRP); and/or synchronization signal based reference signal received quality (SS-RSRQ).

Clause 91. The method of any one of clauses 84 to 90, wherein: the first evaluation time period is shorter than the second evaluation time period; and the first time period is shorter than the second time period.

Clause 92. The method of any one of clauses 80 to 90, wherein the first condition comprises at least one of: a first low mobility condition, for the wireless device with low mobility; or a second not-at-cell edge condition, for the wireless device not being at cell edge.

Clause 93. The method of 92, wherein the first condition being fulfilled comprises at least one of: the first low mobility condition being fulfilled; or the second not-at-cell edge condition being fulfilled.

Clause 94. The method of clause 93, wherein the first low mobility condition being fulfilled is based on a difference between a reference cell selection value, of a serving cell of the wireless device, and a current cell selection value, of the serving cell of the wireless device, being lower than a first threshold.

Clause 95. The method of clause 93, wherein the second not-at-cell edge condition being fulfilled is based on a cell selection value, of a serving cell of the wireless device, higher than a second threshold.

Clause 96. A method comprising: receiving, by a wireless device via a cell, one or more system information blocks (SIBs) comprising a configuration indicating a first condition to perform first measurements, by the wireless device, for a neighbor cell while the wireless device is in a radio resource control (RRC) idle or inactive state; and while the wireless device camps on the cell in the RRC idle or inactive state, determining, in response to the first condition being fulfilled, whether to perform the first measurements on a first cell, of the neighbor cell, based on the wireless device being in a TN coverage area.

Clause 97. A method comprising: while a wireless device is in a radio resource control (RRC) idle or inactive state, determining, by the wireless device and in response to a first condition to perform first measurements being fulfilled, whether to perform the first measurements for a cell of a neighbor cell based on a second condition.

Clause 98. The method of clause 97, wherein determining whether to perform the first measurements for the cell of the neighbor cell based on the second condition comprises: determining to perform the first measurements for the cell of the neighbor cell based on the second condition being fulfilled; and determining not to perform the first measurements for the cell of the neighbor cell based on the second condition not being fulfilled.

Clause 99. The method of clause 98, wherein the second condition is associated with at least one of: a cell coverage area; a location of the wireless device; a mobility of the wireless device; or a signal strength of the cell.

Clause 100. The method of clause 98, wherein the cell coverage area may be a terrestrial network (TN) coverage area.

Clause 101. The method of clause 98, wherein the second condition being fulfilled comprises at least one of: a distance between the location of the wireless device and a center of the cell coverage area being higher than a threshold; the location of the wireless device not being in the cell coverage area; the mobility of the wireless device not being high mobility; the mobility of the wireless device being low mobility; or a signal strength of the cell being higher than a threshold.

Clause 102. The method of clause 98, wherein the second condition not being fulfilled comprises at least one of: a distance between the location of the wireless device and a center of the cell coverage area being lower than a threshold; the location of the wireless device being in the cell coverage area; the mobility of the wireless device being high mobility; the mobility of the wireless device not being low mobility; or a signal strength of the cell being lower than a threshold.

What is claimed is:

1. A method comprising:
determining, by a wireless device, whether to apply a first measurement requirement, for a measurement for one or more non-terrestrial network (NTN) cells, based on the wireless device being in a terrestrial network (TN) coverage area; and
transmitting, by the wireless device, an uplink packet based on one or more measurements of a first cell, wherein the one or more measurements are based on:
the first measurement requirement; and
the wireless device being in the TN coverage area.

2. The method of claim 1, wherein the first cell is:
a non-terrestrial networks (NTN) cell;
a low earth orbit (LEO) cell; or
a non-geosynchronous orbit (NGSO) cell.

3. The method of claim 1, wherein the wireless device is camped on a non-terrestrial network (NTN) cell in a radio resource control (RRC) idle state or an RRC inactive state while the first measurement requirement is applied.

4. The method of claim 1, further comprising:
receiving, by the wireless device from an NTN cell, one or more system information blocks (SIBs) indicating at least one of:
the first measurement requirement for the first cell; and
the TN coverage area.

5. The method of claim 4, wherein the SIBs further indicates at least one of:
a list of TN coverage areas comprising the TN coverage area; and
one or more TN frequencies for each of a plurality of TN coverage areas in the list of TN coverage areas.

6. The method of claim 1, further comprising determining, by the wireless device and based on the TN coverage area, whether the wireless device is in the TN coverage area.

7. The method of claim 1, wherein being in the TN coverage area is based on at least one of:
a distance between a location of the wireless device and a reference location of the TN coverage area being lower than a distance threshold associated with the TN coverage area;
the location of the wireless device being within the TN coverage area; and
the wireless device detecting a cell associated with the TN coverage area.

8. A wireless device comprising:
one or more processors; and
memory storing instructions that, when executed by the one or more processors, cause the wireless device to:
determine whether to apply a first measurement requirement, for a measurement for one or more non-terrestrial network (NTN) cells, based on the wireless device being in a terrestrial network (TN) coverage area; and
transmit an uplink packet based on one or more measurements of a first cell, wherein the one or more measurements are based on:
the first measurement requirement; and
the wireless device being in the TN coverage area.

9. The wireless device of claim 8, wherein the first cell is:
a non-terrestrial networks (NTN) cell;
a low earth orbit (LEO) cell; or
a non-geosynchronous orbit (NGSO) cell.

10. The wireless device of claim 8, wherein the wireless device is camped on a non-terrestrial network (NTN) cell in a radio resource control (RRC) idle state or an RRC inactive state while the first measurement requirement is applied.

11. The wireless device of claim 8, wherein the instructions further cause the wireless device to receive, from an NTN cell, one or more system information blocks (SIBs) indicating at least one of:
the first measurement requirement for the first cell; and
the TN coverage area.

12. The wireless device of claim 11, wherein the SIBs further indicates at least one of:
a list of TN coverage areas comprising the TN coverage area; and
one or more TN frequencies for each of a plurality of TN coverage areas in the list of TN coverage areas.

13. The wireless device of claim 8, wherein the instructions further cause the wireless device to determine, based on the TN coverage area, whether the wireless device is in the TN coverage area.

14. The wireless device of claim 8, wherein being in the TN coverage area is based on at least one of:
a distance between a location of the wireless device and a reference location of the TN coverage area being lower than a distance threshold associated with the TN coverage area;
the location of the wireless device being within the TN coverage area; and
the wireless device detecting a cell associated with the TN coverage area.

15. A non-transitory computer-readable medium comprising instructions that, when executed by one or more processors of a wireless device, cause the wireless device to:
determine whether to apply a first measurement requirement, for a measurement for one or more non-terrestrial network (NTN) cells, based on the wireless device being in a terrestrial network (TN) coverage area; and
transmit an uplink packet based on one or more measurements of a first cell, wherein the one or more measurements are based on:
the first measurement requirement; and
the wireless device being in the TN coverage area.

16. The non-transitory computer-readable medium of claim 15, wherein the first cell is:
a non-terrestrial networks (NTN) cell;
a low earth orbit (LEO) cell; or
a non-geosynchronous orbit (NGSO) cell.

17. The non-transitory computer-readable medium of claim 15, wherein the wireless device is camped on a non-terrestrial network (NTN) cell in a radio resource control (RRC) idle state or an RRC inactive state while the first measurement requirement is applied.

18. The non-transitory computer-readable medium of claim 15, receive, from an NTN cell, one or more system information blocks (SIBs) indicating at least one of:
the first measurement requirement for the first cell; and
the TN coverage area.

19. The non-transitory computer-readable medium of claim 18, wherein the SIBs further indicates at least one of:
a list of TN coverage areas comprising the TN coverage area; and
one or more TN frequencies for each of a plurality of TN coverage areas in the list of TN coverage areas.

20. The non-transitory computer-readable medium of claim 15, wherein the instructions further cause the wireless device to determine, based on the TN coverage area, whether the wireless device is in the TN coverage area.
